(19) United States
(12) Patent Application Publication
(10) Pub. No.: US 2026/0216649 A1
(43) Pub. Date: Jul. 30, 2026

(54) REDUCTION OF NOX AND N2O IN THE EXHAUST GAS OF SHIP MOTORS OPERATED USING NH3

(71) Applicants: THYSSENKRUPP AG, Essen (DE); THYSSENKRUPP UHDE GMBH, Dortmund (DE)

(72) Inventors: Michael GROVES, Gevelsberg (DE); Meinhard SCHWEFER, Meschede (DE); Jens Christopher JENSEN, Warendorf (DE); Paul KERN, Dortmund (DE); Stefan PINNOW, Elsdorf (DE); Rolf SIEFERT, Rheda-Wiedenbrück (DE)

(21) Appl. No.: 19/141,770

(22) PCT Filed: Dec. 22, 2023
(86) PCT No.: PCT/EP2023/087678

§ 371 Date: Jun. 20, 2025

(30) Foreign Application Priority Data
Dec. 23, 2022 (EP) 22216421.2
Mar. 29, 2023 (EP) 23165192.8

(51) Int. Cl. B01D 53/94; B01J 29/072; B63H 21/14; F01N 3/10; F01N 3/28; F02B 43/10

(52) U.S. Cl. CPC B01D 53/9427; B01D 53/9436; B01J 29/072; B63H 21/14; F01N 3/108; F01N 3/2803; F02B 43/10; B01D 2251/102; B01D 2255/20738; B01D 2255/20746; B01D 2255/20761; B01D 2255/50; B01D 2255/9155; B01D 2257/402; B01D 2257/404; B01D 2257/406; B01D 2258/01; F01N 2330/30; F01N 2370/04; F02B 2043/103

(57) ABSTRACT

The invention relates to the reduction of the content of NO_{X} and N₂O in the offgas from an NH₃-driven internal combustion engine. The internal combustion engine is mounted in a ship and serves to move the ship.

The priorities are claimed from European patent application No. 22 216 421.2, filed on Dec. 23, 2022; and from European patent application No. 23 165 192.8, filed on Mar. 29, 2023.

The invention relates to the reduction of the content of NO_{X} and N₂O in the offgas from an NH₃-driven internal combustion engine. The internal combustion engine is mounted in a ship and serves to move the ship.

Ammonia is globally one of the most widely produced and distributed chemicals and is best known for its use as a fertilizer in agriculture. In recent years, there has been increasing interest in the possibility of using it as a high-grade energy source and as a carbon-free fuel in internal combustion engines (H. Kobayashi et al., Proceedings of the Combustion Institute 37 (2019) 109-133; D. Erdemir et al., Int J. Energy Res. 2021, 45, 4827-4834; C. Tornatore et al., Frontiers in Mechanical Engineering, 2022, 8, Article 944291). There has also been discussion of use in aircraft (A. Boretti et al., ACS Energy Lett. 2022, 7, 2557-2564).

Ammonia contains no carbon and has a global transport and storage infrastructure. It can be produced directly from renewable power, water and air, and is therefore currently considered to be intelligent energy source and combustion fuel.

Ammonia has a comparatively low calorific value and a low flame propagation speed, and harbors the risk of flame extinction with the result of incomplete combustion. In addition, the combustion of NH₃ harbors the risk of elevated emissions of nitrogen oxides (in particular NO, NO₂, N₂O), which affects its suitability as a combustion gas. There have been proposals of gaseous ammonia/hydrogen/air mixtures in which a certain hydrogen content is used as combustion accelerator, which would be producible, for example, by catalytic or heat-assisted NH₃ dissociation (Ch. Lhuillier et al., 14th International Conference on Engines & Vehicles, 2019, Capri; S. Mashruk et al., Chemical Engineering Transactions, 89, 2021; S. Mashruk et al., Combustion and Flame 244 (2022) 112299).

Operating limits for ammonia-fuel spark ignition engines have been studied. It was found here that NH₃ emissions in the offgas decrease with increasing engine speed, with the highest values being achieved with a rich mixture. NH₃ emissions can reach up to 1% by volume. NO_{X} emissions consist mainly of NO, and the effect of the engine speed seems to depend on the equivalence ratio. Although NH₃ does not generate a carbon content in the exhaust, it can emit N₂O, one of the strongest greenhouse gases. Both for NO_{X} and N₂O, the highest emission values are observed on the lean side, in that they decrease with increasing equivalence ratio. Finally, even when pure ammonia is combusted under rich conditions, H₂ is produced in the offgas, suggesting local decomposition of the ammonia. The offgas temperatures were likewise monitored and appear to be sufficiently high for the use of catalysts for the selective catalytic reduction (SCR) of NO_{X}, in order to reduce both NH₃ and NO_{X} emissions at least below 2000 rpm (Ch. Mounaïm-Rousselle et al., Energies 2021, 14, 4141).

Y. K. Park, Chemical Engineering Journal, Volume 461, 141958, published Apr. 1, 2023, is a review of the catalytic removal of nitrogen oxides (NO, NO₂, N₂O) from offgas formed when ammonia is used as fuel.

JP 2023 026798A, published Mar. 1, 2023, relates to an offgas processing system of an ammonia engine comprising, as the first catalyst, an oxidation catalyst comprising a catalyst layer containing Pt and zeolite, and, as the second catalyst, a denitration catalyst comprising a catalyst layer containing zeolite that has been ion-exchanged with Cu, Co or Fe ions.

WO 2011/136034 relates to an NH₃-burning internal combustion engine which has an offgas treatment catalyst capable of treating NH₃ and NO_{X} in the offgas, and a flow gas control unit capable of controlling the ratio of NH₃ to NO_{X} in the offgas flowing into the offgas treatment catalyst.

US 2003/0143142 A1 and US 2017/0334722 A1 describe methods of reducing the NO_{X} concentration and the N₂O concentration of the tail gas from nitric acid production.

US 2022/0323905 A1 relates to an emission treatment system for NO_{X} reduction in an offgas stream of an ammonia-powered engine, wherein the emission treatment system a selective catalytic reduction catalyst (SCR catalyst) disposed on a substrate in fluid connection with the offgas stream, a precious metal-containing oxidation catalyst disposed on a substrate, which is disposed either upstream or downstream of the SCR catalyst and is in fluid connection with the offgas stream and the SCR catalyst, and optionally one or more adsorption components disposed on a substrate disposed upstream and/or downstream of the SCR catalyst and in fluid connection with the offgas stream and the SCR catalyst, where the adsorption component is selected from low-temperature NO_{X} adsorbers (LT-NA), low-temperature ammonia adsorbers (LT-AA), low-temperature water vapor adsorbers (LT-WA) and combinations thereof.

CN 114 412 668 A concerns ammonia-fuel engines, in particular an ammonia-hydrogen fusion-type hybrid energy system and an engine.

CN 115 773 169 A concerns an ammonia-fuel marine engine system and an exhaust aftertreatment system therefor. The apparatus comprises a nitrous oxide reactor, a denoxing reactor, an ammonia oxidation catalyst reactor and a discharge system, arranged in succession.

CN 116 877 253 A relates to an apparatus for treating the offgas from a marine engine with a high ammonia-diesel ratio and to a method for treating the offgas from a marine engine with a high ammonia-diesel ratio.

The focal points of research to date have concentrated on the optimization of the combustion of ammonia as such, in particular with regard to energy yield and economic viability, but also with regard to the formation of undesirable nitrogen oxides. However, it can be assumed that it will not be possible to fully suppress the formation of NO_{X} (i.e. NO and NO₂) and of N₂O in the combustion process.

Emissions of NO_{X}, N₂O and possibly of other constituents that may be present in combustion gases (e.g. CO, HCN) should, however, be avoided or at least reduced as far as possible for protection of the environment and the climate. Many industrialized countries have therefore imposed corresponding regulations.

In addition, the combustion of hydrocarbons (CH₄, natural gas, etc.) in the presence of NH₃ gives rise to offgases that can contain hydrogen cyanide (HCN, hydrocyanic acid). Even small amounts of HCN are problematic since it is classified as highly toxic, and correspondingly low limits for emissions of HCN into the environment have to be observed. HCN-contaminated offgases can in principle be purified by various measures. Alkaline scrubbing operations can form and separate off cyanides, but these in turn have to be disposed of as highly toxic compounds. Specific oxidation catalysts based on precious metals can be used to convert HCN to CO₂, H₂O, N₂ and various nitrogen oxides. However, this means not inconsiderable procedural complexity and costs. For instance, the nitrogen oxides formed have to be broken down in a further process step, for example by means of SCR. Also described is passage over specific catalysts, for example based on TiO₂, for hydrolysis of the HCN according to HCN+H₂O→CO+NH₃. In this case too, subsequent further oxidation over corresponding separate oxidation catalysts is then likewise necessary. There is therefore a need for cleaning processes for HCN-contaminated offgases that feature simple and inexpensive modes of operation and low apparatus expenditure. In addition, HCN should, in the process, be converted to nontoxic substances that do not require further treatment.

A further problem is the incomplete combustion of ammonia, which has the effect that the offgases from internal combustion engines driven with ammonia as fuel can contain considerable amounts of uncombusted ammonia (so-called NH₃ slip, NH₃ breakthrough). Acceptable limits for ammonia for release to the atmosphere are comparatively strict. Therefore, in such cases, it is necessary to ensure that ammonia is oxidized to nitrogen before the offgas may be released to the atmosphere. For this purpose, what are called ammonia slip catalysts (ASC) have been developed, which are typically based on precious metals from the platinum group (i.e. Ru, Rh, Pd, Os, Ir, Pt). Such catalysts are not only costly but also less selective (i.e. they can form NO_{X} or N₂O from NH₃) and are susceptible to chlorine and chlorine compounds, which can barely be avoided in shipping in particular. For instance, the air sucked in for the combustion always contains sea salt even to some extent, present in the atmosphere as an aerosol.

There is a need for measures that are suitable for at least partly eliminating
nitrogen oxides (in particular N₂O and NO_{X} (i.e. NO and NO₂)),
any excess NH₃, and
any other environmentally harmful components of the offgases (for example CO or HCN), which are present or may be present in the offgas of NH₃-driven internal combustion engines for combustion-related reasons, in order that the offgas can then be discharged into the ambient air in compliance with all environmental regulations.

The internal combustion engines, preferably reciprocating piston engines, should be usable as marine engines and should therefore be compatible with the special circumstances of shipping.

The special circumstances that should be considered here are those that arise from maximum efficient combustion of NH₃ for driving internal combustion engines. Important parameters are not only the different composition of the offgas, but in particular also the pressure and temperature of the offgas. These parameters may differ considerably from those of other offgases for which measures for elimination of NO_{X} and N₂O have been developed to date

For example, in the industrial production of nitric acid NH₃, oxidation is conducted deliberately up to NO_{X} in order subsequently to obtain nitric acid therefrom by reacting with water in an absorption tower. Special catalysts made from precious metals are used for the oxidation, and the reaction is frequently effected at elevated pressure. The aim of the combustion of NH₃ here is to achieve a maximum yield of NO_{X}, and typical water contents in the offgas are in the range from about 1% to 3% by volume.

By contrast, NH₃ in the case of combustion for driving internal combustion engines, the NH₃ is preferably oxidized only up to the level of N₂, for which there is typically no need for catalysts, and where, for example if the internal combustion engine is a reciprocating piston engine, this reaction usually proceeds at comparatively high pressure, where, in the case of a reciprocating piston engine according to the compression ignition principle, maximum internal cylinder pressures in the range from 20 to 100 bar are typically attained before or during the combustion process. The aim of the combustion is to achieve a minimum yield of NO_{X} and N₂O. Typical water contents in the offgas are well above 3% by volume. For example, the combustion of pure NH₃ in air with a residual oxygen content of 3 mol % affords more than 28 mol % of water. The main aim of the combustion of NH₃ here is the generation of energy. Low levels of nitrogen oxides in the offgas formed in the combustion are advantageous here because in that case only a comparatively small offgas treatment system is required in order to reduce the level of nitrogen oxides in the flue gas and hence comply with the regulatory requirements with regard to permissible emissions or because only in that case can sufficiently low residual concentrations be achieved at all by known methods for nitrogen oxide reduction.

By contrast with conventional offgas treatment systems as used, for instance, in the case of offgases from plants for production of HNO₃, the inventive combustion of NH₃, preferably in the mixture with H₂, provides special features entailing special measures.

On the one hand are the comparatively low pressures of the offgas stream of typically not more than 5 bar, and on the other hand the very high water content is essential. What is meant by “low pressure” is that, in the case of use of conventional catalyst beds based on beds of particulate shaped bodies etc., the pressure drops could possibly be too great. The high water content, because of the hydrothermal load on the catalysts in the offgas treatment system, especially in the case of zeolite material, with simultaneously high temperature can possibly lead to progressive deactivation of the catalysts. The maximum temperature should therefore be limited. Aside from the aging, the chemical reduction of NO_{X} is barely impaired by the high water content, while the breakdown of N₂O by decomposition and/or chemical reduction is significantly impaired by the high water content.

A further difference in the offgases to be treated in accordance with the invention by comparison to the production of HNO₃ is the relatively high NO_{X} content, which can be several thousand ppmv. The NO_{X} content depends on the conditions in the combustion of NH₃, in particular on the NH₃ content, any further combustible gases present (H₂ and/or CH₄ (natural gas)) and the air ratio λ. Because of the high temperatures in the combustion of up to 1000° C. or more, the NO_{X} is also present almost exclusively as NO at first, i.e. with a very high proportion of NO and with a very low proportion of NO₂. As a result of preferred cooling too, because of the slow formation kinetics of NO₂ at high temperatures, only a small proportion of the NO is converted to NO₂. This means that the degree of oxidation (β) of NO_{X}, i.e. the molar proportion of NO₂ in the total NO_{X} (β=n(NO₂)/(n (NO)+n (NO₂)), is small when the offgas enters the offgas treatment system, typically <5% by volume. This in turn means that the desired selective catalytic NO_{X} reduction can actually proceed very poorly or slowly, in accordance with normal SCR that takes place at a slow rate.

These are fundamental differences from the established offgas cleaning in HNO₃ systems in which the N₂O— and NO_{X}-containing tail gas is heated gradually under a positive pressure of usually 4-10 bar after leaving the absorption tower from a “cold” state (the thermodynamic NO_{X} equilibrium is virtually completely to the NO₂ side). For instance, the NO_{X} oxidation level of tail gases in HNO₃ production before entry into a corresponding offgas treatment system is typically between 30% and 70% by volume, i.e. close to the ideal stoichiometric ratio for NO_{X} reduction in very fast SCR.

The high NO_{X} content, combined with a very low NO_{X} oxidation level and high water content with simultaneously low operating pressure (close to atmospheric pressure) thus poses particular challenges in the present case to the effectiveness of the offgas treatment system of the invention. In addition, there is the challenge or need to eliminate N₂O which is likewise present in the offgas and is not reducible by conventional SCR methods based on V₂O₅/TiO₂ catalysts.

The objectives and the resultant reaction products in the combustion of NH₃ therefore sometimes differ considerably from one another.

In conventional plants for production of nitric acid, the offgas frequently has, at comparatively high pressure,
a comparatively low content of NO_{X};
a comparatively high proportion of NO₂;
a comparatively high content of N₂O;
a comparatively low content of water; and
possibly a zero proportion of uncombusted NH₃ (NH₃ slip).

In contrast, in internal combustion engines, the offgas frequently includes, at comparatively low pressure,
a comparatively high content of NO_{X};
a comparatively small proportion of NO₂;
a comparatively low content of N₂O;
a significantly higher content of water;
possibly a not inconsiderable proportion of uncombusted NH₃ (NH₃ slip); and
possibly a non-negligible proportion of HCN, if NH₃ is combusted together with CH₄ (natural gas).

These special circumstances have to be taken into account in the elimination of NO_{X} and N₂O from the offgases, which presents a particular challenge.

Further challenges in the elimination of NO_{X} and N₂O from offgases, by comparison with existing industrial plants, so-called stationary plants, arise from the use of NH₃-powered internal combustion engines in ships. The systems are thus not fixedly installed and operated at one site, but are mobile. However, special requirements are placed on mobile systems, for example with regard to weight, size, safety, stability to shocks, etc. In addition, the mode of operation of internal combustion engines can sometimes change spontaneously, for example when switching from part-load operation to full-load operation, for instance in the case of short-notice acceleration or braking. This too constitutes a particular challenge in the elimination of NO_{X} and N₂O from the offgases.

It is an object of the invention to reduce the content of NO_{X} (i.e. NO and NO₂), N₂O and, if necessary, NH₃, CO and/or HCN in offgases obtained with NH₃-driven internal combustion engines. This should be possible in an economically viable manner and permit optimal utilization of NH₃. Catalysts based on metals from the platinum group should be avoided as far as possible. In addition, the offgas treatment of the invention should be suitable as far as possible for a wide range of combustion-fuel-air ratios, i.e. from very lean (comparatively high N₂O content, comparatively low NO_{X} content, comparatively low NH₃ slip) to close to stoichiometric (comparatively low N₂O content, comparatively high NO_{X} content, comparatively pronounced NH₃ slip). The aim is to achieve the best possible exploitation of fuel under a wide range of conditions, including the use of fuel that has broken through, in an advantageous manner.

This object is achieved by the subject matter of the claims.

The invention relates to an apparatus comprising
(i) an internal combustion engine which is configured to be powered by combustion of NH₃ and which is mounted in a ship and configured to move the ship; and
(ii) an offgas treatment system configured to reduce the content of NO_{X} and N₂O in an offgas produced by combustion from the NH₃ in the internal combustion engine and comprising N₂, H₂O, NO_{X} and N₂O, wherein the offgas treatment system comprises
   an N₂O decomposition catalyst configured to decompose N₂O; and/or an N₂O reduction catalyst configured for chemical reduction of N₂O with reducing agent; and
   an NO_{X} reduction catalyst configured for chemical reduction of NO_{X} with reducing agent.

The invention also relates to a method for reducing the content of NO_{X} and N₂O in the offgas of an NH₃-driven internal combustion engine which is mounted in a ship and serves to move the ship, wherein the method comprises the following steps:
(a) combusting NH₃ (optionally in the mixture with one or more further combustible gases, for example H₂, CH₄, etc.) to drive the internal combustion engine, producing an offgas which comprises N₂, H₂O, NO_{X} and N₂O, with or without HCN, and which leaves the internal combustion engine;
(b) transferring the offgas from the internal combustion engine to an offgas treatment system;
(c) reducing the N₂O content in the offgas by
   (c₁) decomposing N₂O over an N₂O decomposition catalyst and/or
   (c₂) chemically reducing N₂O with reducing agent over an N₂O reduction catalyst; and
(d) reducing the NO_{X} content in the offgas by chemical reduction of NO_{X} with reducing agent over an NO_{X} reduction catalyst.

The sequence of steps (c) and (d) is as desired; all options are included in accordance with the invention, from successively in time in any sequence to simultaneously, or mixed forms thereof.

It has been found that, surprisingly, fuel which has broken through (NH₃ slip) can be used in an advantageous manner in the offgas treatment plant as reducing agent for chemical reduction of NO_{X} and, if necessary, also of N₂O. The amount of NH₃ that may need to be oxidized in order to keep its emissions low is advantageously reduced thereby, which increases the exploitation of fuel.

The offgas treatment system of the invention comprises at least
an N₂O reduction catalyst and/or an N₂O decomposition catalyst; and
an NO_{X} reduction catalyst;

which may be the same or different according to the given functionality or multifunctionality and may be present in common or separate reaction zones (catalyst beds).

In preferred embodiments, the offgas treatment apparatus of the invention comprises
an N₂O reduction catalyst;
an N₂O decomposition catalyst; and
an NO_{X} reduction catalyst;
   which may be the same or different according to the given functionality or multifunctionality and may be present in common or separate reaction zones (catalyst beds).

In preferred embodiments, the offgas treatment system of the invention additionally comprises at least one further catalyst, or one of the aforementioned N₂O reduction, N₂O decomposition or NO_{X} reduction catalysts complies with at least one further functionality selected from
NH₃ oxidation catalyst;
HCN breakdown catalyst; and
CO oxidation catalyst.

The NH₃ oxidation catalyst is preferably used when the proportion of uncombusted NH₃ in the offgas (NH₃ slip) is greater than the demand for NH₃ as reducing agent for NO_{X} and/or N₂O in the offgas treatment system, such that the offgas, after passing through steps (c₁) and/or (c₂) and (d), still contains residual amounts of NH₃ that should not or must not be released to the environment. These residual amounts of NH₃ can then be broken down by oxidation of NH₃ using the downstream NH₃ oxidation catalyst.

The HCN breakdown catalyst is preferably used when the fuel, in addition to NH₃, contains hydrocarbons (CH₄, natural gas, etc.), and the offgas formed in the combustion contains certain amounts of HCN. The resulting HCN can then be broken down (eliminated) with the aid of the HCN breakdown catalyst by hydrolysis of the HCN and oxidation of the hydrolysis products (hydrolyzates) formed in the process, i.e. of NH₃ and CO, with preferably NO_{X} and N₂O present in the offgas.

It has been found that, surprisingly, HCN in water-containing offgases which simultaneously contain NO_{X} and N₂O, each in a molar amount greater than or equal to the molar amount of HCN, can be broken down to N₂, H₂O and CO₂ by passing the offgas over a zeolitic catalyst laden with transition metals, for example a package of catalyst pellets containing an iron-laden zeolitic material of the BEA structure type, at temperatures of 300 to 600° C. (preferably 350 to 550° C.).

By contrast to known processes, complete elimination of HCN, i.e. a conversion to nontoxic substances, can be brought about in this manner in a one-stage process, i.e. in one process step without costly precious metal catalysts. In order to eliminate excess levels of NO_{X} and N₂O, it is additionally possible to add NH₃ for reduction of NO_{X} and N₂O, and optionally CO or hydrocarbons, for example CH₄ or propane, for reduction of N₂O to the HCN-, NO_{X}- and N₂O-containing offgas. The amount of reducing agent in this case should be in accordance with the molar starting amounts of N₂O and NO_{X}, in each case reduced by the molar amount of HCN present in the offgas. If excess amounts of N₂O are present in the offgas and are to be reduced with NH₃ or CO or hydrocarbon, the NO_{X} content should be reduced by means of NH₃ in each case to zero (or close to zero). If CO or hydrocarbons are used as additional reducing agents, any emissions of CO may possibly be eliminated by using an additional CO oxidation catalyst downstream of the zeolite catalyst.

The CO oxidation catalyst is preferably used when (i) hydrocarbons (CH₄, natural gas, etc.) are used as reducing agents for N₂O; and/or (ii) an HCN breakdown catalyst is used to break down HCN, with CO present in the degradation products thereof. Any CO obtained in each case can then be broken down by oxidation to CO₂ with the aid of the downstream CO oxidation catalyst.

If the offgas treatment system of the invention comprises an NH₃ oxidation catalyst, it may be preferable in accordance with the invention to adjust the offgas firstly with a temperature control apparatus within the offgas treatment system to a different temperature than on entry into the offgas treatment system, such that the NH₃ oxidation catalyst can display its effect in an optimized manner. In preferred embodiments, the offgas treatment system of the invention therefore additionally comprises one or more temperature control apparatuses.

For the purposes of the description “and/or” means either “or” or “and”, such that, for example, “A and/or B” has the following three meanings: (i) only A but not B, (ii) only B but not A, and (iii) both A and B.

For the purposes of the description, “NO_{X}” includes nitrogen monoxide (NO) and nitrogen dioxide (NO₂), but not nitrous oxide (N₂O).

Catalysts accelerate certain chemical reactions by lowering their activation energies.

The apparatus of the invention is configured for performance of the method of the invention. All preferred embodiments of the method of the invention that are described by steps (a), (b), (c₁), (c₂) and (d) are analogously also applicable to the apparatus configured in accordance with the invention or to the parts thereof that are configured for performance of these steps. Thus, the internal combustion engine of the invention is configured to perform step (a) and the offgas treatment system of the invention is configured to perform steps (c₁) and/or (c₂) and (d). The offgas treatment plant is additionally configured to treat the offgas produced in the internal combustion engine, in particular to reduce the N₂O content in the offgas and the NO_{X} content in the offgas, such that the apparatus of the invention is additionally configured to perform step (b); the internal combustion engine and the offgas treatment system are configured in such a way, in particular connected to one another in such a way, that the offgas produced in the internal combustion engine is transferred into the offgas treatment system.

Unless explicitly stated otherwise, all figures in ppm are based on volume, i.e. ppmv. Unless explicitly stated otherwise, all percentages are based on volume with regard to gas composition, i.e. % by volume. Unless explicitly stated otherwise, all other percentages are based on weight, i.e. % by weight.

Steps (a) and (b) of the method of the invention are effected successively in alphabetical sequence, followed by steps (c) and (d) in fundamentally any sequence, and the apparatus of the invention is configured correspondingly. Step (c) can accordingly be performed before step (d) or after step (d) or simultaneously with step (d). Also possible are mixed forms of partial simultaneousness. This may be relevant particularly when one and the same catalyst material is capable of catalyzing multiple reactions. Such embodiments are particularly preferred in accordance with the invention. According to the invention, these reactions then possibly take place simultaneously, although the kinetics of the respective reactions may vary, such that a first reaction may have ended earlier or may have reached a higher conversion than a second reaction proceeding in parallel. Consequently, the N₂O decomposition catalyst and/or the N₂O reduction catalyst may be disposed upstream or downstream of the NO_{X} reduction catalyst in flow direction of the offgas, although mixed forms can be achieved in that one and the same catalytically active material catalyzes two or more of these reactions simultaneously.

Step (c₁), i.e. the decomposition of N₂O over an N₂O decomposition catalyst, and step (c₂), i.e. the chemical reduction of N₂O with reducing agent over an N₂O reduction catalyst, are considered separately for the purposes of the description, but both serve the common purpose of reducing the N₂O content in the offgas.

Steps (c₁), (c₂) and (d) can likewise be performed in any sequence, although mixed forms of partial simultaneousness are also possible in this regard.

In preferred embodiments, the method of the invention comprises steps (a), (b), (c₁) and (d); steps (a), (b), (c₂) and (d); or steps (a), (b), (c₁), (c₂) and (d), or the apparatus of the invention is configured correspondingly.

In preferred embodiments, the offgas undergoes the steps of the method of the invention, or passes through the correspondingly configured parts of the apparatus configured in accordance with the invention, in one of the following sequences:

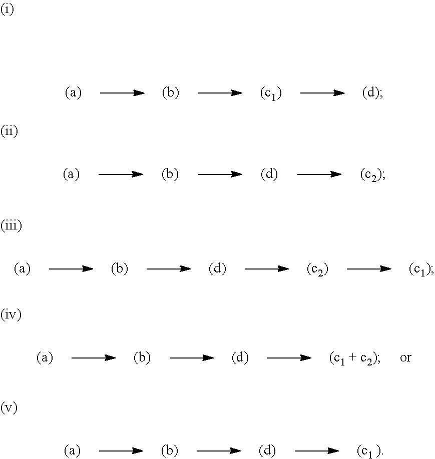

What is meant by (c₁+c₂) is that both step (c₁) and step (c₂) are performed, although the performance of these two steps (c₁) and (c₂) is at least partly simultaneous, i.e. both steps proceed in parallel, or the apparatus of the invention is configured correspondingly.

Between these steps, there may be further steps that are not specified explicitly.

It has been found that, surprisingly, NH₃-operated internal combustion engines can advantageously be operated in a condition which entails a comparatively small extent of NH₃ slip (NH₃ breakthrough) from the internal combustion engine into the offgas. This can be achieved by increasing the air ratio λ, but this is then typically also accompanied by an increase in the concentration of NO_{X} and/or N₂O in the offgas. When pure ammonia is used as fuel, it is expected that the NO_{X} formation, depending on the air ratio λ, has a maximum in the lean range (at about an equivalence ratio=1/1=0.8). If λ is relatively low, the oxygen supply limits the formation of NO_{X}. If λ is relatively high, the combustion temperature limits the formation of NO_{X} and, instead, the N₂O content may increase. As the air ratio increases, the NH₃ slip still occurs, but no longer to such a large extent. In the case of such operation of the internal combustion engines, excess NH₃ can be effectively oxidized through the use of NH₃ oxidation catalysts, preferably of oxidation-active zeolite catalysts. It is thus possible to dispense with precious metal-containing NH₃ oxidation catalysts, in particular NH₃ oxidation catalysts containing metals of the platinum group (i.e. Ru, Rh, Pd, Os, Ir, Pt), which is particularly advantageous on ships. This is because such NH₃ oxidation catalysts are costly, and show low selectivity in the case of a high concentration of NH₃ (i.e. the oxidation of NH₃ also forms secondary NO_{X} and N₂O as well as N₂), and are susceptible to poisoning with chlorine from the marine air.

What is meant by “free of platinum group metals” for the purposes of the description is that essentially no metal of the platinum group (i.e. Ru, Rh, Pd, Os, Ir, Pt) is present. However, analytically detectable minimal traces of platinum group metals are possible.

What is meant by “free of precious metals” for the purposes of the description is that essentially no precious metal is present. However, analytically detectable minimal traces of precious metal are possible.

The inventive exploitation of NH₃ as fuel for internal combustion engines is better and the NH₃ slip is lower when the mixture of air and fuel burns much leaner (or secondary air is fed in), which is associated with higher formation of N₂O and NO_{X}.

The inventive solution makes it possible to operate a (dual-fuel) internal combustion engine on a ship in a manner in which NH₃ slippage (in the quasi-steady-state mode of operation of the ship) can be minimized by using lean combustion characteristics or secondary air.

If oxidation of excess NH₃ is required, it is possible with preference in accordance with the invention for this purpose to use iron- or copper-laden zeolite catalysts with a sufficiently high NH₃ oxidation activity. Thus, the use of precious metal-containing NH₃ oxidation catalysts, in particular on NH₃ oxidation catalysts containing metals of the platinum group, is not required and can be ruled out.

In addition, it has been found that, surprisingly, the catalytic decomposition of N₂O in the offgas of an NH₃-operated internal combustion engine can be utilized in an advantageous manner, especially when the offgas treatment system has two reaction zones arranged in series, each of which independently contains iron- or copper-laden zeolite catalysts, where the two reaction zones are preferably separated from one another by at least one metering/injection system for at least one reducing agent. It has been found that the first reaction zone in a NO_{X}-rich environment, when the NH₃ slip of the internal combustion engine is low, exerts a distinct function as N₂O decomposition catalyst. By contrast, if the NH₃ slip is high, the first reaction zone offers additional catalyst volume for the chemical reduction of N₂O and NO_{X} and the oxidation of NH₃.

In step (a) of the method of the invention, NH₃ is combusted to drive an internal combustion engine which generates heat through combustion processes, or the apparatus of the invention is configured correspondingly. Firing of fuels generates heat, with additional driving of a machine. The expression includes engines for propulsion of ships. In the internal combustion engines, NH₃ is oxidized with O₂ (preferably from the air), with the aim of producing N₂ and H₂O in particular as main products.

Systems in which NH₃ is oxidized with O₂ with the aim of producing nitrogen compounds with higher oxidation numbers (e.g. NO_{X}) as the main products, as is the case, for example, in the production of nitric acid, are not internal combustion engines in the context of the invention.

The combusting of NH₃ means the oxidation of NH₃ with O₂, where this reaction, in accordance with the invention, does not have to be complete, such that the offgas may contain residual uncombusted (unoxidized, unconverted) NH₃ (NH₃ slip, NH₃ breakthrough), or the apparatus of the invention is configured correspondingly. The same applies if NH₃ is combusted not in pure form but together with further combustible gases, in particular H₂ and/or CH₄ (natural gas). The O₂ used for combustion can be used in the form of combustion air, where the combustion air may optionally be enriched with O₂.

Greater amounts of NH₃ slip are not preferred in accordance with the invention because they entail special measures in order to prevent escape of NH₃ above permissible maximum values, in particular the use of NH₃ oxidation catalysts (ammonia slip catalysts, ASC), which are intended to oxidize NH₃ that has broken through with O₂ to give H₂O and N₂.

Preferably in accordance with the invention, NH₃ is combusted in step (a), or the internal combustion engine is configured, such that the offgas has an NH₃ content of at most 35 000 ppmv, preferably at most 30 000 ppmv, more preferably at most 25 000 ppmv, even more preferably at most 20 000 ppmv, most preferably at most 15 000 ppmv, and in particular at most 10 000 ppmv.

Preferably in accordance with the invention, NH₃ is combusted in step (a), or the internal combustion engine is configured, such that the offgas has an NH₃ content of at most 9000 ppmv, preferably at most 8000 ppmv, more preferably at most 7000 ppmv, even more preferably at most 6000 ppmv, most preferably at most 5000 ppmv, and in particular at most 4000 ppmv.

Preferably in accordance with the invention, NH₃ is combusted in step (a), or the internal combustion engine is configured, such that the offgas has an NH₃ content of at most 3500 ppmv, preferably at most 3000 ppmv, more preferably at most 2500 ppmv, even more preferably at most 2000 ppmv, most preferably at most 1500 ppmv, and in particular at most 1000 ppmv.

Suitable methods of reducing the NH₃ slip of internal combustion engines are known to those skilled in the art. In particular, the NH₃ slip can be achieved by increasing the air ratio λ. Although such an increase in the air ratio λ may possibly simultaneously be accompanied by an increase in the content of NO_{X} and/or N₂O in the offgas of the internal combustion engine, this can be accepted in accordance with the invention since, given a favorable ratio of NH₃ to NO_{X} and possibly also to N₂O, NH₃ that has broken through serves as reducing agent for the chemical reduction of NO_{X} and, if necessary, also N₂O, and so all these gases can be decomposed simultaneously in the offgas treatment system and the gas that has left the offgas treatment system contains very small and harmless amounts of NH₃, NO_{X} and N₂O at most.

The internal combustion engine is preferably configured such that the offgas has a molar ratio of NH₃:NO_{X} of at most 5.0; preferably at most 4.5, more preferably at most 4.0, even more preferably at most 3.5, most preferably at most 3.0, and in particular at most 2.5.

The internal combustion engine is preferably configured such that the offgas has a molar ratio of NH₃:NO_{X} of at most 2.3; preferably at most 2.1, more preferably at most 1.9, even more preferably at most 1.7, most preferably at most 1.5, and in particular at most 1.3.

According to the invention, NH₃ is preferably combusted in the mixture with H₂ or fossil fuels, e.g. CH₄, or the apparatus of the invention is configured correspondingly.

In step (a) of the method of the invention, NH₃ is combusted to drive an internal combustion engine, or the apparatus of the invention is configured correspondingly.

“Internal combustion engines” (heat engines) within the context of the invention are in particular combustion engines, preferably piston heat engines with internal combustion, such as reciprocating piston engines or rotary piston engines.

The internal combustion engine preferably comprises a reciprocating piston engine or is a reciprocating piston engine, in each case preferably with compression ignition.

### Step (b)

In step (b) of the method of the invention, the offgas is transferred to an offgas treatment system, i.e. from the internal combustion engine to an offgas treatment system, or the apparatus of the invention is configured correspondingly. In the offgas treatment system of the invention, steps (c) and (d) of the method of the invention are effected, or the apparatus of the invention is configured correspondingly. For this purpose, the offgas treatment system is equipped with the N₂O decomposition catalyst for the decomposition of N₂O in step (c₁) and/or with the N₂O reduction catalyst for the chemical reduction of N₂O with reducing agent in step (c₂), and also with the NO_{X} reduction catalyst for the chemical reduction of NO_{X} with reducing agent in step (d).

If the offgas treatment system of the invention additionally comprises at least one further catalyst, or one of the aforementioned N₂O reduction, N₂O decomposition or NO_{X} reduction catalysts fulfills at least one further functionality, at least one of the following steps (e₁) to (e₄) is preferably additionally effected in the offgas treatment system of the invention:
(e₁) adjusting the offgas temperature in at least one temperature control apparatus which is preferably disposed within the offgas treatment system; preferably upstream of the NH₃ oxidation catalyst in flow direction of the offgas;
(e₂) reducing the NH₃ content in the offgas by oxidation with an oxidizing agent over an NH₃ oxidation catalyst; where the oxidizing agent preferably comprises O₂;
(e₃) reducing the HCN content in the offgas by hydrolysis and oxidation of the hydrolyzates with an oxidizing agent over an HCN breakdown catalyst; where the oxidizing agent preferably comprises NO_{X} and/or N₂O; and
(e₄) reducing the CO content in the offgas by chemical oxidation with an oxidizing agent over a CO oxidation catalyst; where the oxidizing agent preferably comprises O₂.

### Step (c)

In step (c) of the method of the invention, the N₂O content in the offgas is reduced, or the apparatus of the invention is configured correspondingly. This can be effected by decomposition of N₂O over an N₂O decomposition catalyst in step (c₁) and/or chemical reduction of N₂O with reducing agent over an N₂O reduction catalyst as per (c₂).

The decomposition of N₂O forms N₂ and O₂ according to the following empirical reaction:

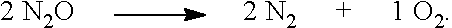

Decomposition of N₂O therefore means breakdown to N₂ and O₂. An “N₂O decomposition catalyst” in the context of the invention catalyzes the decomposition of N₂O. The achievable breakdown of N₂O by catalytic decomposition depends not only on the type, i.e. the chemical nature and physical configuration of the N₂O decomposition catalyst and the pressure and temperature conditions that exist, but also in particular on the chosen space velocity, i.e. the ratio of offgas volume flow rate to catalyst volume. However, the catalytic activity of an N₂O decomposition catalyst need not be restricted exclusively to this reaction. For instance, it is quite possible and indeed preferred in accordance with the invention that the N₂O decomposition catalyst can additionally also catalyze further reactions, for example the chemical reduction of N₂O and/or the chemical reduction of NO_{X}. Whether such further reactions do indeed take place depends on the conditions of the individual case, in particular the type of catalyst, and the kinetics of any processes that take place in parallel, for example on the presence or amount of the reducing agent and the presence or amount of other coreactants.

The chemical reduction of N₂O with reducing agent forms different reaction products depending on the reducing agent.

In the case of the NH₃ reducing agent that is preferred in accordance with the invention, the chemical reduction of N₂O forms N₂ and H₂O in particular, for example as follows:

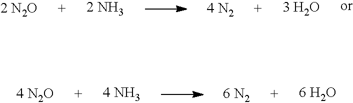

or else in joint reduction with NO as follows:

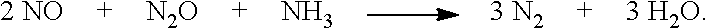

In the case of hydrocarbons, which are likewise preferred in accordance with the invention as reducing agent, the chemical reduction of N₂O forms CO and H₂O in particular, for example as follows:

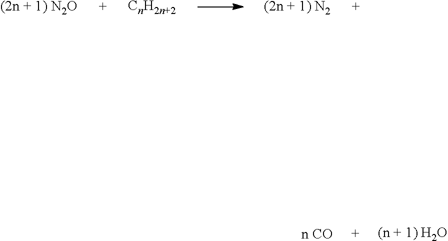

or else CO₂ and H₂O as follows:

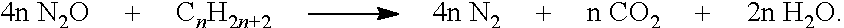

CO is likewise preferred in accordance with the invention as reducing agent. It can react further with N₂O to give CO₂, for example according to:

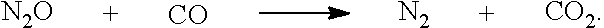

An “N₂O reduction catalyst” in the context of the invention catalyzes the chemical reduction of N₂O with reducing agent. However, the catalytic activity of an N₂O reduction catalyst need not be restricted exclusively to this reaction. For instance, it is quite possible and indeed preferred in accordance with the invention that the N₂O reduction catalyst can additionally also catalyze further reactions, for example the breakdown of N₂O and/or the chemical reduction of NO_{X}. Whether such further reactions do indeed take place depends on the conditions of the individual case, in particular the type of catalyst, and the kinetics of any processes that take place in parallel, for example on the presence or amount of the reducing agent and the presence or amount of other coreactants.

### Step (d)

In step (d) of the method of the invention, the NO_{X} content in the offgas is reduced by chemical reduction of NO_{X} with reducing agent over an NO_{X} reduction catalyst, or the apparatus of the invention is configured correspondingly.

Preference is given here to those NO_{X} reduction catalysts which as far as possible enable the selective catalytic reduction (SCR) of the nitrogen oxides present in the offgas, in particular of NO_{X}, meaning that the NO_{X} reduction catalysts primarily catalyze the oxidation of NH₃ with NO_{X} and do not, or do not secondarily, catalyze the oxidation of NH₃ with any free oxygen (O₂) present in the offgas.

The chemical reduction of NO_{X} with reducing agent forms different reaction products depending on the reducing agent. In the case of the NH₃ reducing agent that is preferred in accordance with the invention, the chemical reduction of NO_{X} forms N₂ and H₂O in particular, depending on the type of NO_{X} reduction catalyst and the ratio of NO to NO₂, for example as follows:

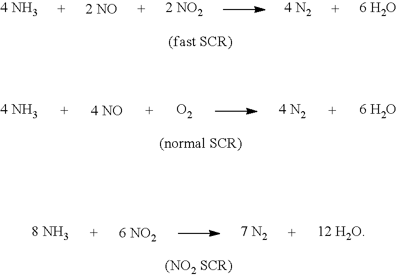

Common selective catalytic reduction is referred to as fast SCR and is generally much faster than normal SCR or NO₂ SCR.

An “NO_{X} reduction catalyst” in the context of the invention catalyzes the chemical reduction of NO_{X} with reducing agent. However, the catalytic activity of an NO_{X} reduction catalyst need not be restricted exclusively to this reaction. For instance, it is quite possible and indeed preferred in accordance with the invention that the NO_{X} reduction catalyst can additionally catalyze further reactions, for example the decomposition of N₂O, the chemical reduction of N₂O and/or the establishment of the NO_{X} equilibrium or the selective oxidation of excess NH₃ with free O₂. Whether such further reactions do indeed take place depends on the conditions of the individual case and the kinetics of any processes that take place in parallel, for example on the presence or amount of the reducing agent and the presence or amount of other coreactants.

### Catalysts

N₂O decomposition catalysts are known per se, and it is possible to use a wide variety of substance classes. Preference is given to N₂O decomposition catalysts which have a high catalytic activity, for example, in the temperature range from 350 to 600° C. for decomposition of N₂O to N₂ and O₂.

According to the invention, preferred examples of N₂O decomposition catalysts are metal-laden zeolite catalysts, for example copper- or cobalt- or in particular iron-laden zeolite catalysts, precious metal catalysts or else transition metal oxide catalysts, for example cobalt oxide-containing catalysts. Examples of suitable catalysts are described inter alia by Kapteijn et al. in Appl. Cat. B: Environmental 9 (1996), 25-64, in U.S. Pat. No. 5,171,553, in Actes du 2ieme Congres International sur la Catalyse, Technip, Paris 1961, 1937-1953, and in WO-A-01/58,570. When iron-laden zeolite catalysts are used in the first catalyst bed, the NO_{X} still present in the gas, as expected, accelerates the desired N₂O decomposition by an activating effect (cocatalytic effect), as described for different N₂O/NO_{X} ratios by Kögel et al. in Catal. Comm. 2 (2001) 273-276.

Further examples of N₂O decomposition catalysts that are preferred in accordance with the invention are catalysts having activity for N₂O decomposition which is distinctly limited by the presence of NO_{X}. Such N₂O decomposition catalysts are also referred to as “NO_{X}-sensitive N₂O decomposition catalysts” for the purposes of the description. These catalysts contain one or more catalytically active compounds of elements selected from groups 5 to 11 of the Periodic Table of Elements (PTE). Especially preferred are compounds of the elements of group 9 to 11 of the PTE. Among these, preference is given in turn to the compounds of the elements Co, Pt, Pd, Ir, Rh, Ni and/or Cu, preferably Co, Rh, Ni and/or Cu, and here in particular Co or Rh. Preference is given to an N₂O decomposition catalyst based on precious metals, which are preferably supported on refractory oxides, or based on mixtures of transition metal oxides, in particular mixed oxides or simple transition metal oxides, in each case either in supported form or preferably as unsupported catalysts.

The catalytically active compounds themselves may be metallic and/or oxidic compounds, the latter either in the form of singular oxides or in the form of binary, ternary or polynary mixed oxides of different structure types, for example perovskites or spinels. These are described, for example, in Catalysis Letters 35 (1995) 372-382, Applied Catalysis 73 (1991) 165-171, Catal. Rev.-Sci. Eng.; 34 (4), 409-425 (1992) or Actes du 2ieme Congres International sur la Catalyse 97 (1961) 1937-1953. Mixtures of different catalytically active compounds may also be used. Examples of particularly preferred catalytically active compounds are metallic rhodium, rhodium oxides, such as RhO₂, or Rh₂O₃, CoO, Co₂O₃, Co-containing spinels, such as Co₃O₄, CuₓCo₃₋ₓO₄, or Co-containing perovskites such as LaCoO₃ or Co-containing perovskites substituted at A and B sites.

The catalytically active compounds may be present in the catalysts in pure form or may be applied to or mixed with suitable support materials. In the former case, they are what are called unsupported catalysts which, in addition to active compounds, may contain additives known to those skilled in the art, such as binders or other production-related additives such as plasticizers, pore formers, fiber reinforcements or compression aids.

The methods of producing such catalysts are known to those skilled in the art. In the case of “supported catalysts”, the catalytically active compounds have been applied to the support material. As a result, the catalytically active compound undergoes dispersion and stabilization against both mechanical and thermal stress. The methods of producing such catalysts are likewise known to those skilled in the art. The support materials are preferably refractory oxides, such as SiO₂, TiO₂, ZrO₂ or Al₂O₃, or mixtures of two or more of these, or materials which themselves have a certain catalytic activity for N₂O decomposition, such as MgO, zeolites, hydrotalcites or mixtures of two or more of these. Preference is given to using catalysts which contain essentially no zeolites, if any, preferably less than 15% by weight of zeolites, in particular less than 5% by weight of zeolites.

Preferred support materials for Rh-containing compounds are ZrO₂, TiO₂, Al₂O₃, hydrotalcites or zeolites, for example of the MFI structure type. These are described, for example, in Chemical Engineering and Technology 24 (2001) 281-285 or in Catalysis Today 35 (1997) 113-120. Particularly preferred supports for Rh-containing compounds are ZrO₂, TiO₂ and hydrotalcite. The Rh content of these catalysts is preferably 0.1% to 10% by weight, preferably 0.5% to 5% by weight. In addition to Rh, Rh-containing catalysts more preferably also contain CeO₂. The proportion of CeO₂ is preferably 5% to 50% by weight, in particular 10% to 30% by weight.

Preferred supports for Co-containing compounds are zeolites, or the preferred supports contain magnesium oxide. In the case of zeolites, particular preference is given to Si-rich structure types such as MFI, BEA, FER, MEL or MOR. The production of such Co-doped zeolites is known to those skilled in the art. Magnesium oxide supports may be pure MgO or MgO-containing compounds, for example hydrotalcites. Such catalysts are described, for example, in Appl. Catal. B: Environmental 7 (1996) 397-406 or Appl. Catal. B: Environmental 13 (1997) 69-79.

Particularly preference is given to catalysts consisting essentially of at least one oxidic magnesium compound and at least one oxidic cobalt compound, where the content of oxidic cobalt compounds is in the range from 0.1% to 50% by weight and the content of oxidic magnesium compounds is in the range from 50% to 99.9% by weight, based in each case on the total mass of the catalyst, and at least 30% by weight of the Co atoms present in the catalyst are in the chemically trivalent state. Such catalysts and the preparation thereof are described in EP 1 257 347 B1. Also particularly preferred in the case of use of oxidic Co compounds as active component are catalysts having a support consisting of at least 50% by weight of MgO or of a mixed oxide consisting of at least 50% by weight of MgO, and where a cerium oxide functional layer has been applied to the support. Such catalysts and the preparation thereof are described in DE 10 2007 038 711 A1.

The N₂O decomposition catalyst may take the form of shaped bodies of any size and geometry, preferably geometries having a high ratio of surface area to volume, with generation of a minimum pressure drop as they are traversed. All geometries known in catalysis are typical, for example cylinders, hollow cylinders, multi-hole cylinders, rings, crushed granulate, trilobes or honeycomb structures.

N₂O reduction catalysts and NO_{X} reduction catalysts are likewise known per se, and a wide variety of substance classes can likewise be used. Examples of these are metal-laden zeolite catalysts, such as copper- or cobalt-laden zeolite catalysts, or in particular iron-laden zeolite catalysts, or precious metal catalysts or catalysts that are used in the known SCR (selective catalytic reduction) processes.

In embodiments that are particularly preferred in accordance with the invention, the offgas comprises NH₃, and the offgas treatment system is configured to reduce the NH₃ content in the offgas. For this purpose, the offgas treatment system preferably comprises an NH₃ oxidation catalyst configured for chemical oxidation of NH₃ with O₂; preferably for chemical oxidation of NH₃ with O₂ to give N₂ and H₂O.

Preferably, the N₂O decomposition catalyst and/or the N₂O reduction catalyst and/or the NO_{X} reduction catalyst and/or the NH₃ oxidation catalyst independently comprise a zeolitic material; preferably a zeolite laden with transition metal (including lanthanide), in particular with iron, cobalt or copper; more preferably an iron- or copper-laden zeolite; even more preferably independently an iron- or copper-laden zeolite of the MFI, BEA, FER, MOR, FAU, AEI and/or MEL structure type.

Preferably, both the N₂O decomposition catalyst and/or the N₂O reduction catalyst and the NO_{X} reduction catalyst independently comprise a zeolitic material; preferably a zeolite laden with transition metal (including lanthanide), in particular with iron, cobalt or copper; more preferably an iron- or copper-laden zeolite; even more preferably independently an iron- or copper-laden zeolite of the MFI, BEA, FER, MOR, FAU, AEI and/or MEL structure type.

These may be different catalysts or the same catalysts. Iron-laden zeolite catalysts that are used with particular preference in accordance with the invention essentially contain preferably >50% by weight, in particular >70% by weight, of one or more iron-laden zeolites. For example, in addition to a Fe-ZSM-5 zeolite, a further iron-containing zeolite such as an iron-containing zeolite of the FER type, may be present in the catalyst used in accordance with the invention.

In addition, the catalyst used in accordance with the invention may contain further additives known to those skilled in the art, for example binders.

The iron content of the zeolites used with preference may be up to 25% based on the mass of zeolite, but preferably 0.1% to 10%.

The method of the invention also includes the use of zeolites in which the lattice aluminum has been partly isomorphically substituted by one or more elements, for example replaced by one or more elements selected from B, Be, Ga, Fe, Cu, Cr, V, As, Sb, and Bi. Likewise included is the use of zeolites in which the lattice silicon is isomorphically substituted by one or more elements, for example replaced by one or more elements selected from Ge, Ti, Zr and Hf. Exact details of the formation or structure of the zeolites preferably used in accordance with the invention is given in the Atlas of Zeolite Structure Types, Elsevier, 4th revised edition 1996, which is hereby explicitly incorporated by reference.

Very particular preference is given in the method of the invention to using zeolite catalysts that have been treated with water vapor (“steamed catalysts”). Such a treatment dealuminates the lattice of the zeolite; this treatment is known to those skilled in the art. These hydrothermally treated zeolite catalysts are notable for particularly high activity in the method of the invention. Preference is given to using hydrothermally treated zeolite catalysts that have been laden with iron and in which the ratio of extra-lattice aluminum to lattice aluminum is at least 1:2, preferably 1:2 to 20:1.

Preferred Catalysts for the Breakdown of N₂O and NO_{X}

The N₂O decomposition catalysts, N₂O reduction catalysts, and NO_{X} reduction catalysts of the invention preferably independently contain zeolitic materials (for the purpose of the description also “zeolites”) laden with at least one transition metal (atomic numbers 21-30, 39-48, 57-80, 89-112) and/or at least one lanthanoid (also called “lanthanide”; atomic numbers 57-71). For the purposes of the description, transition metals and lanthanoids are collectively referred to as “transition metals” for the sake of simplicity. The transition metals are preferably iron (“Fe zeolites”), copper (“Cu zeolites”) and cobalt (“Co zeolites”). Iron-laden zeolitic materials (i.e. Fe zeolites) are particularly preferred and may be laden with or comprise not only iron but also other transition metals, for example manganese, vanadium, chromium, nickel or mixtures.

The zeolitic materials of the invention preferably have high hydrothermal stability. Particular preference is given to SiO₂-rich zeolites, called “high-silica zeolites”, which have a molar ratio of [SiO₂] to [AlO₂⁻] units, and hence a molar Si/Al ratio of at least 8, preferably at least 9, more preferably at least 10, even more preferably at least 11, most preferably at least 12, and in particular at least 13.

Zeolitic materials that are preferred in accordance with the invention essentially have a zeolite structure of the BEA, MFI, MOR, MEL or FER structure type, more preferably of the MFI and BEA structure type, more preferably of the BEA structure type. In the case of the MFI structure type, the ZSM-5 type in particular is preferred. Further details of the naming of the structure types of zeolitic materials and their structure can be found in the Atlas of Zeolite Structure Types, Elsevier, 4th revised edition 1996.

N₂O decomposition, N₂O reduction or NO_{X} reduction catalysts that are particularly preferred in accordance with the invention independently contain at least 50% by weight of Fe zeolite in relation to the total weight of the zeolitic material, preferably at least 70% by weight of Fe zeolite, where a single structure type or else several structure types may be present. In preferred embodiments, in addition to Fe-BEA zeolite, another Fe zeolite of a different structure type is present, preferably Fe-MOR zeolite.

The loading (doping) of the zeolitic materials with the transition metals/lanthanoids can be effected by relevant methods of loading or doping zeolites with transition metals/lanthanoids that are known to the skilled person. The loading preferably proceeds from the commercially available H form or preferably NH₄ form of the zeolitic materials by ion exchange with appropriate salts of the transition metals, in an aqueous phase or by solid-state reaction. The laden zeolitic materials thus obtained are then calcined, preferably under air in a furnace at temperatures in the range from 400 to 650° C. After calcination, the laden zeolitic materials are vigorously washed in distilled water, and the laden zeolitic materials are filtered off and then dried. Suitable binders, for example aluminosilicates, boehmite or silica sol, and optionally auxiliaries for plasticization or for production of slips, are preferably added to and mixed with the laden zeolitic materials thus obtained. In preferred embodiments, the mixtures thus obtained are extruded to catalyst bodies (unsupported catalysts) and finally calcined. In other preferred embodiments, the mixtures thus obtained are applied to catalyst supports (supported catalysts) and finally calcined. These methods are also well known to the skilled person and established in many technical applications.

The N₂O decomposition, N₂O reduction, NO_{X} reduction, NH₃ oxidation, HCN breakdown and CO oxidation catalysts of the invention may independently take the form of shaped bodies of any size and geometry, preferably in geometries that have a large surface-to-volume ratio and generate a minimum pressure drop as the stream flows through them. Typical geometries are all of those known in catalysis, for example cylinders, hollow cylinders, multihole cylinders, rings, trilobes or star-shaped extrudates. Particular preference is given to monolithic catalyst elements permeated by parallel channels, for example, monolithic honeycombs, known as “catalyst honeycombs”, which are known, for example, from the cleaning or denoxing of power plant offgases or automotive exhaust gases.

### Catalyst Honeycombs, Honeycomb Bodies and Honeycomb Body Modules

The offgas treatment system of the invention or the catalyst beds encompassed therein preferably comprise catalyst honeycombs, preferably a plurality of catalyst honeycombs, arranged parallel to one another with honeycomb channels in the offgas duct [SMD1] that are aligned longitudinally to the flow direction of the offgas. The geometry of the cross-sectional area of the catalyst honeycombs (perpendicular to the flow direction of the offgas) can in in principle be chosen freely. The catalyst honeycombs preferably have a rectangular or, in particular, square cross-sectional area, but other cross-sectional areas are also possible, in particular hexagonal, triangular, trapezoidal, etc. Suitable geometries are known to those skilled in the art. Accordingly, the term “honeycomb”, according to the invention, is not limited to a rectangular or square cross-sectional area.

If the offgas treatment system of the invention comprises a first reaction zone (first catalyst bed) and a second reaction zone (second catalyst bed) downstream in flow direction of the offgas, which is preferred in accordance with the invention, the first and second reaction zones (the first and second catalyst beds) preferably have several catalyst honeycombs that are arranged parallel to one another with honeycomb channels in the offgas duct that are aligned longitudinally to the flow direction of the offgas.

In preferred embodiments, several catalyst honeycombs, i.e. several monolithic honeycombs, are combined to form a honeycomb body module, preferably by means of a metal frame which is open in flow direction of the offgas. Preferably, two, four or six honeycomb bodies, preferably monolithic honeycomb bodies, in each case are combined to form a honeycomb body module. This modular construction allows good utilization of the available cross-sectional area of the offgas duct and simple exchange of defective or deactivated honeycomb bodies.

The honeycomb bodies preferably have a rectangular cross section. The rectangular cross section preferably has a first edge length (perpendicular to the flow direction of the offgas) in the range from 5 to 20 cm, preferably 10 to 15 cm, and a second edge length (also perpendicular to the flow direction of the offgas) in the range from 5 to 20 cm, preferably 10 to 15 cm. The height of a honeycomb body (flow direction of the offgas) is preferably in the range from 5 to 25 cm, preferably in the range from 7.5 to 15 cm.

What is called the cell density, i.e. density of the channels of the honeycombs, is preferably 150 to 500 cpsi, preferably 180 to 450 cpsi (cells per square inch). 100 cpsi, i.e. 100 cells or honeycomb channels per square inch.

Preferably, the individual honeycomb body modules are stacked on top of one another and alongside one another in flow direction and fixed by appropriate mount devices in such a way as to achieve maximum exploitation of the inflow area, i.e. cross-sectional area of the offgas duct. Bypass flows between each honeycomb body module or in the outer edge area between the outer margin of the honeycomb body module and the inner wall of the offgas duct should be avoided. For this purpose, suitable sealing materials are preferably applied between the individual honeycomb body modules and between the outer honeycomb body modules and the inner wall and, in the case of greater wall separations, cover plates are used, which are mounted on the inner wall of the offgas duct in flow direction in front and/or behind the packing of the honeycomb body modules. The cover plates are preferably covered with seals at the contact points with the honeycomb body modules. The honeycomb body modules are preferably arranged and selected in terms of size in such a way that the usable inflow area of catalyst is preferably at least 60% of the inner cross-sectional area of the offgas duct, more preferably at least 70%, even more preferably at least 80%.

In the case of circular offgas ducts or offgas pipelines, the gaps that arise in the edge region of the packing of the honeycomb body modules, unless they can be easily occupied with rectangular honeycomb body modules, are preferably not filled with specially tailored honeycomb bodies, but closed by blind plates. This has the advantage that, when exchanging spent honeycomb bodies, only standardized honeycomb body modules have to be exchanged and no special adjustments are required.

When using offgas pipelines, it is preferably also possible to use individual larger honeycomb bodies adapted to the pipe cross section with a circular inflow cross section, several of which may also be arranged in succession in the flow direction in a preferred configuration. In this case, it is then unnecessary to arrange several honeycomb bodies parallel to one another.

In preferred embodiments, the honeycomb bodies or honeycomb body modules are arranged in several layers offset along the longitudinal axis in flow direction of the offgas. The honeycomb bodies or honeycomb body modules are preferably arranged in 2 to 5 layers, more preferably in 2 to 3 layers. A margin is preferably provided between the layers, i.e. between the end faces of the honeycomb bodies or honeycomb body modules, preferably in the range from 3 to 30 mm, preferably 4 to 20 mm. The margin can enable intermediate, in particular radial, mixing of the gas flow emerging from a first layer of the honeycomb bodies or honeycomb body modules. Furthermore, it is possible to prevent any possible slip of unreacted reducing agent and/or of the as yet incompletely oxidized reaction products thereof from propagating from the first layer of the honeycomb bodies into a subsequent, second layer of the honeycomb bodies.

The reducing agents for NO_{X} and optionally N₂O are preferably supplied and distributed via a manifold pipeline system having a multitude of openings or nozzles, disposed in the offgas duct or in the offgas conduit upstream of the respective catalyst bed in flow direction, preferably upstream of the packing of the catalyst honeycombs as honeycomb bodies or honeycomb body modules.

The distributor tubes are preferably designed in the form of grids, or in the form of concentrically connected circles, which extend as far as possible over the cross-sectional surface of the offgas duct or the inflow area of the catalyst bed.

The specific design and dimensioning of these distributors, including suitable exit nozzles, is part of specialist knowledge in catalytic offgas cleaning technology and is widely employed, for example, in offgas treatment for coal-fired power plants.

### NH₃ Oxidation Catalyst

NH₃ oxidation catalysts are known to those skilled in the art.

The NH₃ oxidation catalyst is preferably free of platinum group metals, preferably free of precious metals.

What is meant by “free of platinum group metals” for the purposes of the description is that essentially no metal of the platinum group (i.e. Ru, Rh, Pd, Os, Ir, Pt) is present. However, analytically detectable minimal traces of platinum group metals are possible. What is meant by “free of precious metals” for the purposes of the description is that essentially no precious metal is present. However, analytically detectable minimal traces of precious metal are possible.

The NH₃ oxidation catalyst is preferably an iron- or copper-laden zeolite; preferably an iron- or copper-laden zeolite of the MFI, BEA, FER, MOR, FAU, AEI and/or MEL structure type (referred to hereinafter as “NH₃ oxidation-active iron- or copper-laden zeolite catalyst”).

Preferred platinum group metal-free NH₃ oxidation catalysts are selected from transition metal oxides (for example of Fe, Mn, Cu, Cr, Co, Ni . . . ), metal-laden zeolites, described, for example, in Handbook of Heterogeneous Catalysis, Wiley-VCH, edited by Ertl, Knötzinger, Schüth, Weitkamp, 2nd Ed. 2008, Volume 5, Chapter 11.5 “Solid Catalysts for the Oxidation of Volatile Organic Compounds”.

Preferred NH₃ oxidation catalysts include
cobalt catalysts, especially Co₃O₄; Co₃O₄-derived mixed oxides (Co_{3-y}M_{y}O₄) that preferably crystallize like Co₃O₄ in the spinel structure, where M is preferably selected from Zn, Cu, Fe, Mn and V; cobalt-laden zeolites, preferably of the MFI, BEA, FER, MOR, FAU, CHA or AFI structure type;
manganese catalysts; especially MnO_{X} with x=1-2; MnO_{X}-derived mixed oxides (Mn_{x-y}M_{y}Oₓ) where M is preferably selected from Zn, Cu, Fe and Mn; manganese-laden zeolites, preferably of the MFI, BEA, FER, MOR, FAU, CHA or AFI structure type;
copper catalysts; especially CuO_{X} with x=0.5-1; CuO_{X}-derived mixed oxides (Cu_{x-y}M_{y}Oₓ) where M is preferably selected from Zn, Co, Fe and Mn; copper-laden zeolites, preferably of the MFI, BEA, FER, MOR, FAU, CHA, AFI structure type;
silver catalysts; especially in supported form, preferably supported on Al₂O₃, TiO₂, or SiO₂, more preferably, for example, X % Ag/TiO₂, X % Ag/Al₂O₃, or X % Ag/SiO₂, in each case with X=1-10.

In preferred embodiments, the apparatus of the invention contains no further NH₃ oxidation catalyst aside from the iron- or copper-laden zeolite.

In preferred embodiments, the NH₃ oxidation catalyst, preferably the NH₃ oxidation-active, iron-laden zeolite catalyst, has a molar ratio of iron to zeolitic aluminum n (Fe)/n (Al) of less than 0.50 to greater than 0.05; preferably less than 0.40 to greater than 0.05, more preferably less than 0.25 to greater than 0.05, even more preferably less than 0.15 to greater than 0.05.

In preferred embodiments, the NH₃ oxidation catalyst, preferably the NH₃ oxidation-active, copper-laden zeolite catalyst, has a molar ratio of copper to zeolitic aluminum n (Cu)/n (Al) of less than 1.00 to greater than 0.10; preferably less than 0.80 to greater than 0.10, more preferably less than 0.50 to greater than 0.10, even more preferably less than 0.30 to greater than 0.10.

It has been found that, surprisingly, iron- or copper-laden zeolites in which only some of the potentially available cation sites are occupied with Fe or Cu ions, such that the residual cation sites are essentially satisfied by protons, have a significantly increased activity for the oxidation of NH₃ with free oxygen.

The ratio of iron or copper to zeolitic aluminum can be adjusted by selecting the Al content in the synthesis of the zeolitic material, in particular via the proportions of the chosen Si and Al starting materials, and also by later loading with iron or copper ions.

In the synthesis of zeolites, the chosen Si and Al starting materials are usually heated in alkaline solution, often under elevated pressure, which results in occurrence of crystallization to give the microporous aluminosilicates formed from three-dimensionally catenated AlO₂⁻ and SiO₂ units, the zeolites. By controlled choice of the synthesis conditions, for example also by adding structure-directing reagents, e.g. organic cations, not only the Si/Al ratio and hence the Al content but also the structure type of the zeolite can be specifically adjusted or controlled. The synthesis methods are industrially established. Zeolites of different structure type with different Si/Al ratios and laden with different cations, for example in Na or NH₄ form, are commercially available.

Suitable methods known to those skilled in the art, for example liquid phase or solid-state ion exchange, can result in targeted exchange of the cations present in the zeolite, for example NH₄+, for other cations, e.g. iron or copper ions (J. Weitkamp, L. Puppe Catalysis and Zeolites—Fundamental and Applications Springer-Verlag Berlin Heidelberg New York, 1999 or Kucherov, A. V. Slinkin, A. A.: Solid state reactions as method of introducing transition metals cations into high-silica zeolites, Russ. Chem. Rev. 1992, vol. 61, no. 9, p. 925-943). If all negative charges generated by the AlO₂ units have been compensated for by cations, what is called the exchange level is 100%.

The exact Al content of the present zeolitic material or of the shaped catalyst bodies produced therefrom, and likewise the Fe content, as is well known, can be determined by X-ray fluorescence analysis (XRF). This is appropriately done in accordance with DIN EN 169-2 (section 5) after determination of ignition loss and after a lithium tetraborate digestion.

If the intention is to determine the Al content of the parent zeolitic material subsequently on the finished shaped body, it should be noted that the shaped body may also contain Al-based binder components which cannot be distinguished from zeolitic Al by XRF. In this case, an additional study of the shaped bodies is required, for example by means of ²⁷Al solid-state NMR which allows a distinction between the Al bound in the zeolite structure and extra-lattice Al. Those skilled in the art will be familiar with details of the fundamentals, implementation and evaluation of such studies (J. Weitkamp, L. Puppe Catalysis and Zeolites—Fundamental and Applications Springer-Verlag Berlin Heidelberg New York, 1999, Chapter 4.2 (NMR Spectroscopy; especially sections 4.2.4.1 (²⁹Si MAS NMR Spectroscopy of SiO₄ Tetrahedra in the Zeolite Framework) and 4.3.4.2 (²⁷Al NMR Spectroscopy of Framework and NonFramework Aluminum in Zeolites)).

The NH₃ oxidation catalyst, preferably the NH₃ oxidation-active iron-laden zeolite catalyst, preferably has a total iron content (reported as mass content of Fe₂O₃) of less than 10.0% by weight to greater than 2.0% by weight, preferably of less than 7.0% by weight to greater than 2.0% by weight, more preferably of less than 5.0% by weight to greater than 2.0% by weight, and even more preferably of less than 4.0% by weight to greater than 2.0% by weight.

The NH₃ oxidation catalyst, preferably the NH₃ oxidation-active copper-laden zeolite catalyst, preferably has a total copper content (reported as mass content of Cu₂O) of less than 9.0% by weight to greater than 1.5% by weight, preferably of less than 6.5% by weight to greater than 1.5% by weight, more preferably of less than 4.5% by weight to greater than 1.5% by weight, and even more preferably of less than 3.5% by weight to greater than 1.5% by weight.

In preferred embodiments, the NH₃ oxidation catalyst, preferably the NH₃ oxidation-active iron- or copper-laden zeolite catalyst, is configured for selective oxidation of NH₃ with O₂ to N₂ and H₂O, and, introduced in the form of a particulate bed, the particles of which have an equivalent diameter of 3.5 to 5.5 mm, which is defined as the diameter of a spherical particle of equal volume, and where the ratio of the outer geometrically detectable surface area of the particles to the volume of the particulate bed is 1000 m²/m³ to 1500 m²/m³, in an amount of 8.0±0.5 ml in an isothermal tubular reactor with axial flow having an internal diameter of 20±3 mm, contacted with a volumetric flow rate of a gas mixture consisting of 500±50 ppmv of NH₃, 2.5±0.1% by volume of O₂ and 0.30±0.05% by volume of H₂O in N₂ at a space velocity based on standard conditions (0° C.; 1.01325 bara) of 10 000±500 h⁻¹, a total pressure of 6±0.5 bara and a temperature of 380 C±5 K, brings about an NH₃ conversion of at least 50%, preferably at least 60%, more preferably at least 70%, even more preferably at least 80%, in particular at least 90%.

In preferred embodiments, the N₂O decomposition catalyst and/or the N₂O reduction catalyst and/or the NO_{X} reduction catalyst and/or the NH₃ oxidation catalyst independently have a honeycomb monolithic structure.

In preferred embodiments, the N₂O decomposition catalyst and/or the N₂O reduction catalyst and/or the NO_{X} reduction catalyst and/or the NH₃ oxidation catalyst independently have a honeycomb monolithic structure.

The N₂O decomposition catalyst and/or the N₂O reduction catalyst and the NO_{X} reduction catalyst preferably each independently comprise transition metal-laden zeolites, preferably respectively iron-laden zeolites (Fe zeolites), even more preferably respectively iron-laden zeolites of the same structure type, most preferably with the same outer shape (e.g. honeycomb or pellet).

In preferred embodiments, the N₂O decomposition catalyst and the N₂O reduction catalyst are made from the same material.

In preferred embodiments, the N₂O decomposition catalyst and the NO_{X} reduction catalyst are made from the same material.

In preferred embodiments, the N₂O reduction catalyst and the NO_{X} reduction catalyst are made from the same material.

In preferred embodiments, the N₂O decomposition catalyst, the N₂O reduction catalyst and the NO_{X} reduction catalyst are made from the same material.

In preferred embodiments, the NH₃ oxidation catalyst and the N₂O decomposition catalyst are made from the same material.

In preferred embodiments, the NH₃ oxidation catalyst and the N₂O reduction catalyst are made from the same material.

In preferred embodiments, the NH₃ oxidation catalyst and the NO_{X} reduction catalyst are made from the same material.

In preferred embodiments, the NH₃ oxidation catalyst, the NO_{X} reduction catalyst and the N₂O decomposition catalyst are made from the same material.

In step (a) of the method of the invention, NH₃ is combusted to drive an internal combustion engine, or the apparatus of the invention is configured correspondingly. The combustion generates an offgas comprising N₂, H₂O, NO_{X} and N₂O, and preferably additionally also NH₃. The offgas leaves the internal combustion engine and is then fed to step (b) of the method of the invention, or the apparatus of the invention is configured correspondingly.

Preferably, the internal combustion engine, which is preferably a reciprocating piston engine, comprises a compression ignition system.

Preferably, the internal combustion engine comprises a turbocharger comprising a turbo compressor and an offgas turbine. Preferably, all components of the offgas treatment system are disposed upstream of the offgas turbine in flow direction of the offgas.

Preferably, the internal combustion engine comprises a system for exhaust gas recirculation (EGR).

In step (a) or in the internal combustion engine configured in accordance with the invention, the combustion of NH₃, i.e. the oxidation of NH₃ with O₂ (or the mixture of NH₃ with a further combustible gas, for example H₂, CH₄, etc.), is preferably not over a catalyst, i.e. combustion is not performed in the presence of a heterogeneous catalyst.

In preferred embodiments, the internal combustion engine is an ammonia dual-fuel engine.

In preferred embodiments, in step (a) or in the internal combustion engine configured in accordance with the invention, NH₃ is combusted in a mixture with one or more further combustible gases, meaning that both NH₃ and at least one further combustible gas are oxidized with O₂.

In preferred embodiments, the further combustible gas is a fossil fuel.

In preferred embodiments, the further combustible gas is selected from hydrocarbons and hydrocarbon mixtures, preferably methane, ethane, propane, butane, natural gas, gasoline and/or diesel.

In preferred embodiments, the further combustible gas is selected from alcohols, preferably methanol and/or ethanol.

In other preferred embodiments, the further combustible gas is H₂.

More preferably, the further combustible gas is H₂ which is formed by thermal and/or catalytic cracking of NH₃. It is preferably the integrated combustion of NH₃ with O₂ that supplies the energy for the cracking. Preferably, in step (a) or in the internal combustion engine configured in accordance with the invention, the combustion of NH₃ is therefore integrated in a process for thermal and/or catalytic cracking of NH₃ to N₂ and H₂.

Preferably, the apparatus of the invention comprises a cracking apparatus for thermal and/or catalytic cracking of NH₃. Preferably, the cracking apparatus and the internal combustion engine are configured such that the combustion of NH₃ in the internal combustion engine provides the energy for the cracking of NH₃ in the cracking apparatus. The cracking apparatus and the internal combustion engine are preferably configured such that the cracking of NH₃ in the cracking apparatus provides the further combustible gas for combustion in the mixture with NH₃ in the internal combustion engine.

Preferably, the cracking apparatus is disposed downstream of an NH₃ reservoir and upstream of an NH₃ injection for the internal combustion engine in flow direction of NH₃.

In particularly preferred embodiments, step (a) of the method of the invention comprises the component steps of, or the internal combustion engine of the invention is configured for the purpose of:
(a₁) thermally and/or catalytically cracking NH₃ to produce a cracking gas comprising N₂, H₂ and optionally residual NH₃;
(a₂) optionally mixing the cracking gas with further NH₃ to produce a mixture comprising H₂ and NH₃;
(a₃) combusting the cracking gas or the mixture.

Suitable methods of thermal and/or catalytic cracking of NH₃ to N₂ and H₂ are known to those skilled in the art. Suitable catalysts for the cracking of NH₃ to N₂ and H₂ are, for example, Al₂O₃- or SiO₂-supported Ru, MgAl₂O₄-supported Fe, Co, Ni, Cu or Ru, or CO₃MO₃N (A. Boisen et al., Journal of Catalysis 230 (2005) 309-312; I. Lucentini et al., Ind. Eng. Chem. Res. 2021, 60, 18560-18611; H. J. Lee et al., Catalysts 2022, 12, 1203).

If the cracking in component step (a₁) does not proceed to completion, the cracking gas (i.e. the cracking product) will additionally still contain residual unconverted NH₃ as well as N₂ and H₂. In this way, a mixture of NH₃ and H₂ is then already obtained, which can either be directly combusted as such or first enriched with further NH₃ in optional component step (a₂).

If the cracking in component step (a₁) proceeds to completion, the required amount of NH₃ still has to be added to the cracking gas in step (a₂).

Preferably, component step (a₁) and optionally component step (a₂) establish a mixing ratio of NH₃ and H₂ which is optimized with regard to the subsequent combustion. The proportion of H₂ is preferably at most 80 mol %, more preferably at most 70 mol %, even more preferably at most 60 mol %, most preferably at most 50 mol %, and in particular at most 40 mol %. The proportion of H₂ is preferably at least 10 mol %, more preferably at least 20 mol %, even more preferably at least 30 mol %, most preferably at least 40 mol %, and in particular at least 50 mol %, or the apparatus of the invention is configured correspondingly.

In particularly preferred embodiments, the molar ratio of H₂:NH₃ in the mixture is in the range from 45:55 to 90:10, preferably 50:50 to 85:15, more preferably 55:45 to 80:20, even more preferably 60:40 to 75:25, most preferably 65:35 to 70:30, or the apparatus of the invention is configured correspondingly.

In component step (a₃), the mixture is combusted, typically with air. In preferred embodiments, the air ratio λ for the combustion in component step (a₃) is in the range from 0.9 to 1.7, preferably 1.05 to 1.7, more preferably 1.0 to 1.6, even more preferably 1.1 to 1.5, most preferably 1.2 to 1.4, or the apparatus of the invention is configured correspondingly.

Preferably, the internal combustion engine is configured such that the air ratio λ on combustion is at least 1.05; preferably at least 1.10, more preferably at least 1.15, even more preferably at least 1.20, most preferably at least 1.25, and in particular at least 1.20.

Preferably, the internal combustion engine is configured such that the air ratio λ on combustion is at least 1.25; preferably at least 1.30, more preferably at least 1.35, even more preferably at least 1.40, most preferably at least 1.45, and in particular at least 1.50.

The air ratio λ (i.e. the combustion air ratio) indicates the mass ratio of air to fuel relative to the stoichiometrically ideal ratio for a theoretically complete combustion process. It is defined as that ratio of air to fuel which contains a sufficient mass of oxygen to achieve complete combustion of a given mass of fuel (cf. e.g. K. Soman, Thermal Engineering, PHI, 2011, page 224, no. 5.4.2). In principle, the ratio can be expressed in terms of mass or molar amount (cf. e.g. P. Majumdar, Design of Thermal Energy Systems, Wiley 2021, page 66, No. 2.13.5.2). For the purposes of the description, the ratio is based on mass. If not air but another oxygen-containing gas is used for a combustion operation, “air” should, strictly speaking, be replaced by “oxygen carrier”. However, the λ parameter is still used in the above definition.

In preferred embodiments, the equivalence ratio NH₃/H₂ (Φ) (not to be confused with the reciprocal of the air ratio 1/λ) is in the range from 0.55 to 1.40, more preferably 1.05 to 1.20, or the apparatus of the invention is configured correspondingly.

In other preferred embodiments, in step (a) or in the internal combustion engine configured in accordance with the invention, NH₃ is combusted alone, i.e. NH₃ is the only combustible gas that is combusted.

Preferably, the internal combustion engine is configured such that the combustion of NH₃ accounts for at least 90% of the total energy obtained; preferably at least 95%, more preferably at least 96%, even more preferably at least 97%, most preferably at least 98%, and in particular at least 99%.

The internal combustion engine is mounted in a ship and serves to move the ship.

In preferred embodiments, the offgas has an NO_{X} content greater than the N₂O content, or the apparatus of the invention is configured correspondingly. The NO_{X} content is preferably at least twice as high, more preferably at least three times as high, even more preferably at least four times as high, most preferably at least seven times as high and in particular at least ten times as high as the N₂O content, or the apparatus of the invention is configured correspondingly. Preferably, the molar ratio of NO_{X}:N₂O is more than 10:1, more preferably at least 20:1, even more preferably at least 30:1, most preferably at least 40:1, and in particular at least 50:1.

In preferred embodiments, the offgas has an NO content greater than the N₂O content, or the apparatus of the invention is configured correspondingly. The NO content is preferably at least twice as high, more preferably at least three times as high, even more preferably at least four times as high, most preferably at least seven times as high and in particular at least ten times as high as the N₂O content, or the apparatus of the invention is configured correspondingly.

In preferred embodiments, the offgas has an NO₂ content greater than the N₂O content, or the apparatus of the invention is configured correspondingly. The NO₂ content is preferably at least twice as high, more preferably at least three times as high, even more preferably at least four times as high, most preferably at least seven times as high and in particular at least ten times as high as the N₂O content, or the apparatus of the invention is configured correspondingly.

Preferably, the offgas has an NO_{X} content of at least 10 ppmv, preferably at least 20 ppmv, more preferably at least 30 ppmv, even more preferably at least 40 ppmv, and in particular at least 50 ppmv, or the apparatus of the invention is configured correspondingly.

Preferably, the offgas has an NO_{X} content of at least 75 ppmv, preferably at least 100 ppmv, more preferably at least 150 ppmv, even more preferably at least 200 ppmv, and in particular at least 250 ppmv, or the apparatus of the invention is configured correspondingly.

Preferably, offgas has an NO_{X} content of at least 500 ppmv, preferably at least 1000 ppmv, more preferably at least 2000 ppmv, even more preferably at least 3000 ppmv, and in particular at least 3500 ppmv, or the apparatus of the invention is configured correspondingly.

Preferably, the offgas has an N₂O content of at least 10 ppmv, preferably at least 20 ppmv, more preferably at least 30 ppmv, even more preferably at least 40 ppmv, and in particular at least 50 ppmv, or the apparatus of the invention is configured correspondingly.

Preferably, the offgas has an N₂O content of at least 75 ppmv, preferably at least 100 ppmv, more preferably at least 150 ppmv, even more preferably at least 200 ppmv, and in particular at least 250 ppmv, or the apparatus of the invention is configured correspondingly.

Preferred offgases have an NO_{X} content in the range from 1500 to 3000 ppmv, preferably 2000 to 3000 ppmv, and an N₂O content in the range from 20 to 100 ppmv, or the apparatus of the invention is configured correspondingly.

In preferred embodiments, the offgas has an H₂O content of more than 4.0% by volume; preferably at least 5.0% by volume, more preferably at least 6.0% by volume, even more preferably at least 7.0% by volume, most preferably at least 8.0% by volume, and in particular at least 9.0% by volume, or the apparatus of the invention is configured correspondingly.

In further preferred embodiments, the offgas has an H₂O content of at least 10% by volume; preferably at least 12% by volume, more preferably at least 14% by volume, even more preferably at least 16% by volume, most preferably at least 18% by volume, and in particular at least 20% by volume, or the apparatus of the invention is configured correspondingly.

In preferred embodiments, the offgas has an H₂O content in the region of 10±8% by volume; preferably in the region of 10±7% by volume, more preferably in the region of 10±6% by volume, even more preferably in the region of 10±5% by volume, most preferably in the region of 10±4% by volume, and especially in the region of 10±3% by volume, or the apparatus of the invention is configured correspondingly.

In preferred embodiments, the offgas has an H₂O content in the region of 15±8% by volume; preferably in the region of 15±7% by volume, more preferably in the region of 15±6% by volume, even more preferably in the region of 15±5% by volume, most preferably in the region of 15±4% by volume, and especially in the region of 15±3% by volume, or the apparatus of the invention is configured correspondingly.

In preferred embodiments, the offgas has an H₂O content in the region of 20±8% by volume; preferably in the region of 20±7% by volume, more preferably in the region of 20±6% by volume, even more preferably in the region of 20±5% by volume, most preferably in the region of 20±4% by volume, and especially in the region of 20±3% by volume, or the apparatus of the invention is configured correspondingly.

In preferred embodiments, the offgas has an H₂O content in the region of 25±8% by volume; preferably in the region of 25±7% by volume, more preferably in the region of 25±6% by volume, even more preferably in the region of 25±5% by volume, most preferably in the region of 25±4% by volume, and especially in the region of 25±3% by volume, or the apparatus of the invention is configured correspondingly.

In preferred embodiments, the offgas has an H₂O content in the region of 30±8% by volume; preferably in the region of 30±7% by volume, more preferably in the region of 30±6% by volume, even more preferably in the region of 30±5% by volume, most preferably in the region of 30±4% by volume, and especially in the region of 30±3% by volume, or the apparatus of the invention is configured correspondingly.

Preferably, the offgas has an N₂ content of at most 95% by volume, preferably at most 90% by volume, more preferably at most 85% by volume, even more preferably at most 80% by volume, most preferably at most 75% by volume, and in particular at most 70% by volume, or the apparatus of the invention is configured correspondingly.

Preferably, the offgas has an N₂ content of at least 40% by volume; preferably at least 50% by volume, more preferably at least 60% by volume, even more preferably at least 70% by volume, most preferably at least 80% by volume, and in particular at least 90% by volume, or the apparatus of the invention is configured correspondingly.

Preferably, the offgas comprises further gaseous components; preferably selected from the group consisting of O₂, CO, CO₂, NH₃, CH₄ and mixtures thereof, or the apparatus of the invention is configured correspondingly.

Preferably, the offgas comprises NH₃, or the apparatus of the invention is configured correspondingly

Preferably, the offgas on departure from the internal combustion engine is at a temperature in the range from 250 to 450° C., or the apparatus of the invention is configured correspondingly.

Preferably, the offgas, after leaving the internal combustion engine, is cooled over the course of the method of the invention, although steps (c₁) and/or (c₂) and/or (d) can introduce new heat, or the apparatus of the invention is configured correspondingly.

### Preferred Variants of Combinations of Steps (c) and (d):

In preferred embodiments, steps (c₁) and/or (c₂) and/or (d) of the method of the invention are performed at different temperatures, i.e. at different temperature levels, where a step conducted earlier or upstream in flow direction of the offgas preferably proceeds at a higher temperature than a step performed subsequently or downstream in flow direction of the offgas, or the apparatus of the invention is configured correspondingly.

Preferably, the offgas on departure from internal combustion engine is at a pressure of at most 5.0 bar; preferably 2.5 to 4.0 bar, or the apparatus of the invention is configured correspondingly.

Preferably, the offgas on departure from the internal combustion engine has a degree of oxidation of NO_{X} of at least 10%, more preferably at least 20%, even more preferably at least 30%, most preferably at least 40%, and in particular at least 50%, or the apparatus of the invention is configured correspondingly.

Preferably, the offgas on departure from the internal combustion engine has a degree of oxidation of NO_{X} of at most 90%, preferably at most 80%, more preferably at most 70%, preferably at most 60%, and in particular at most 50%, or the apparatus of the invention is configured correspondingly.

Preferably, the offgas on departure from the internal combustion engine has an O₂ content of less than 2.0% by volume, or the apparatus of the invention is configured correspondingly.

Preferably, the offgas on departure from the internal combustion engine has an O₂ content of more than 4.0% by volume, or the apparatus of the invention is configured correspondingly.

In step (b) of the method of the invention, the offgas that has left the internal combustion engine is transferred to an offgas treatment system, or the apparatus of the invention is configured correspondingly.

This can be effected, for example, by means of pipelines that connect the outlet of the internal combustion engine to the inlet of the offgas treatment system. Since the method of the invention is preferably conducted at atmospheric pressure, or the apparatus of the invention is configured correspondingly, such pipelines are typically not subject to any special requirements with regard to possible compressive stress.

However, the pipelines should withstand the temperatures of the offgas on departure from the internal combustion engine or on entry into the offgas treatment system.

In preferred embodiments, the offgas temperature is measured at the outlet of the internal combustion engine and optionally modified with suitable devices in order that the offgas on entry into the offgas treatment system has an optimized temperature under the given conditions for performance of steps (c) and (d) of the method of the invention within the offgas treatment system, or the apparatus of the invention is configured correspondingly. The optimized temperature depends in particular on the type of catalyst materials used for the N₂O decomposition catalyst and/or N₂O reduction catalyst and the NO_{X} reduction catalyst. The optimized temperature is guided by the chosen configuration of steps (c) and (d), i.e. the type and sequence of the individual process steps for N₂O reduction and NO_{X} reduction and in particular the type of catalyst materials used for the N₂O decomposition catalyst and/or N₂O reduction catalyst and the NO_{X} reduction catalyst.

Suitable devices for altering the offgas temperature are known to those skilled in the art and include in particular heat exchangers, which may be configured, for example, as plate heat exchangers or tube heat exchangers.

In order to avoid heat losses, it may be preferable in accordance with the invention to choose as short as possible a distance from the outlet of the internal combustion engine to the inlet into the offgas treatment system, and in this way to achieve a compact design.

However, depending on the nature of the catalysts used, the steps may not be completely separable from each other, either locally or in time. If a catalyst used is simultaneously suitable for catalysis of two or more of steps (c₁), (c₂) and (d), these steps may proceed simultaneously and/or sequentially. In flow direction of the offgas, it is possible to consider individual segments of one and the same catalyst through which the offgas flows successively and in which different reactions may dominate. Which reaction is dominant in which section depends in particular on the respective reaction kinetics, the local temperature and the local concentrations of the reactants, possibly including the concentration of reducing agent and possibly including the concentration of cocatalytically active species.

The offgas treatment system of the invention serves in particular for performance of steps (c) and (d) of the method of the invention, or the apparatus of the invention is configured correspondingly. However, it is also possible that further steps and chemical reactions are conducted within the offgas treatment system in addition to steps (c) and (d), or the apparatus of the invention is configured correspondingly.

This preferably relates to the installation of a catalyst bed disposed downstream in flow direction of the offgas for oxidation of incompletely converted reducing agents or the as yet incompletely oxidized reaction products thereof, i.e., for example, for oxidation of NH₃ (NH₃ oxidation catalyst) or CO (CO oxidation catalyst; when hydrocarbons are used as reducing agents). In such embodiments, the offgas is preferably cooled before it is introduced into the downstream catalyst bed, i.e. the oxidation of NH₃ and/or CO is preferably effected at a lower temperature than steps (c) and (d).

In the performance of the steps (c) and (d) of the method of the invention, according to the invention, there are different preferred variants of the process regime, which can differ from each other with regard to the sequence of the reactions that proceed, the catalysts used, the reducing agents used, the space velocities and other reaction conditions.

In preferred embodiments, these reactions are conducted in a common reaction zone (catalyst bed), which is equipped upstream with an apparatus for metering reducing agent into the offgas.

In other preferred embodiments, these reactions are conducted in two separate reaction zones (catalyst beds) arranged in succession, of which preferably at least one reaction zone, preferably both reaction zones, is/are independently equipped upstream with an apparatus for metering reducing agent into the offgas. In that case, the offgas flows first through the first reaction zone and subsequently through the second reaction zone.

Particularly preferred variants/embodiments include
[a] (c₂) the chemical reduction of N₂O with NH₃ and (d) the chemical reduction of NO_{X} with NH₃, preferably collectively in one reaction zone;
[b] (c₂) the chemical reduction of N₂O with hydrocarbon (CH₄, natural gas, etc.) and (d) the chemical reduction of NO_{X} with NH₃, preferably collectively in one reaction zone;
[c] (c₁) the decomposition of N₂O and (d) the chemical reduction of NO_{X} with NH₃, preferably collectively in one reaction zone;
[d] (c₁) the decomposition of N₂O and (c₂) the chemical reduction of N₂O with NH₃ and (d) the chemical reduction of NO_{X} with NH₃, preferably collectively in one reaction zone;
[e] (c₁) the decomposition of N₂O and (c₂) the chemical reduction of N₂O with hydrocarbon (CH₄, natural gas, etc.) and (d) the chemical reduction of NO_{X} with NH₃, preferably collectively in one reaction zone;
[f] (c₁) the decomposition of N₂O, preferably in a first reaction zone; and subsequently (d) the chemical reduction of NO_{X} with NH₃, preferably in a second reaction zone;
[g] (c₁) the incomplete decomposition of N₂O, preferably in a first reaction zone; and subsequently (c₂) the chemical reduction of residual N₂O with NH₃ and (d) the chemical reduction of NO_{X} with NH₃, preferably in a second reaction zone;
[h] (c₁) the incomplete decomposition of N₂O, preferably in a first reaction zone; and subsequently (c₂) the chemical reduction of residual N₂O with hydrocarbon (CH₄, natural gas, etc.) and (d) the chemical reduction of NO_{X} with NH₃, preferably in a second reaction zone;
[i] (c₁) the incomplete decomposition of N₂O, preferably in a first reaction zone; and subsequently (c1*) the decomposition of residual N₂O and (d) the chemical reduction of NO_{X} with NH₃, preferably in a second reaction zone;
[j] (c₁) the incomplete decomposition of N₂O, preferably in a first reaction zone; and then (c1*) the decomposition of residual N₂O and (c₂) the chemical reduction of residual N₂O with NH₃ (d) and the chemical reduction of NO_{X} with NH₃, preferably in a second reaction zone;
[k] (c₁) the incomplete decomposition of N₂O, preferably in a first reaction zone; and then (c1*) the decomposition of residual N₂O and (c₂) the chemical reduction of residual N₂O with hydrocarbon (CH₄, natural gas, etc.) and (d) the chemical reduction of NO_{X} with NH₃, preferably in a second reaction zone;
[l] (d) the incomplete chemical reduction of NO_{X}, preferably in a first reaction zone; and subsequently (c₁) the decomposition of N₂O and (d*) the chemical reduction of residual NO_{X} with NH₃, preferably in a second reaction zone;
[m] (d) the incomplete chemical reduction of NO_{X}, preferably in a first reaction zone; and subsequently (c₁) the decomposition of N₂O and (c₂) the chemical reduction of N₂O with NH₃ and (d*) the chemical reduction of residual NO_{X} with NH₃, preferably in a second reaction zone; or
[n] (d) the incomplete chemical reduction of NO_{X}, preferably in a first reaction zone; and subsequently (c₁) the decomposition of N₂O and (c₂) the chemical reduction of N₂O with hydrocarbon (CH₄, natural gas, etc.) and (d*) the chemical reduction of residual NO_{X} with NH₃, preferably in a second reaction zone.

This does not mean, however, that the reactions explicitly mentioned must be the only reactions that take place in the respective reaction zone. Depending on the catalyst used, it is instead preferred in accordance with the invention that, in addition, further reactions also take place simultaneously, which are not explicitly mentioned but can proceed in parallel. The reactions explicitly mentioned are therefore only those reactions that at least take place in the respective variant/embodiment.

If NO_{X}, N₂O and NH₃ are present in the mixture and the catalyst used catalyzes both the chemical reduction of NO_{X} with NH₃ and the chemical reduction of N₂O with NH₃, the chemical reduction of NO_{X} with NH₃ is typically much faster than the chemical reduction of N₂O with NH₃. If the catalyst used additionally catalyzes the decomposition of N₂O, the decomposition of N₂O typically overlaps with the chemical reduction of N₂O with NH₃, where the extent of the chemical reduction of N₂O can be increased by increasing the amount of NH₃ metered in.

For the purposes of the description, “*” denotes a component method step that has previously been conducted only partially in a component method step of the same type, where the component method step identified by “*” then continues the component method step that has previously been conducted only partially, but possibly in a different reaction zone or a different catalyst bed. As with all other method steps, unless explicitly stated otherwise, the result achieved at the end of all component method steps is not quantified. If, for example, NO_{X} is chemically incompletely reduced in a first component method step (d), the fact that component method step (d*) is subsequently conducted does not necessarily mean that, at the end of component method step (d*), the total amount of NO_{X} must have been completely chemically reduced, i.e. to 0.0 ppmv. Instead, it is entirely possible that, at the end of component method step (d*), there is still a residual amount of NO_{X}.

The offgas treatment system comprises at least one injection site for reducing agents. The offgas treatment system may comprise several injection sites for reducing agents.

The mode of introduction of the reducing agents into the stream of the offgas to be treated is freely configurable in accordance with the invention, provided that this is done upstream of the N₂O reduction catalyst or NO_{X} reduction catalyst in flow direction. The reducing agent can be introduced in the form of a gas or else a liquid or aqueous solution that evaporates in the stream of the offgas to be treated. The feeding is effected by a suitable apparatus, for example an appropriate pressure valve or appropriately designed nozzles, which leads into a mixer for the stream of the offgas to be treated and the reducing agent supplied. When different reducing agents for NO_{X} and N₂O are used, the supply and introduction into the offgas can be effected separately or together.

In the case of configuration of the catalyst beds as a packing of catalyst honeycombs or honeycomb body modules, the supply and distribution of the reducing agents for NO_{X} and optionally N₂O to the one or more reaction zones (catalyst beds) is preferably effected via a manifold pipeline system having a multitude of openings or nozzles, disposed upstream of the respective reaction zone (catalyst bed) in flow direction of the offgas, i.e. upstream of the packing of the catalyst honeycombs or honeycomb body modules.

The distributors are preferably designed in the form of grids, or concentrically connected circles, which extend as far as possible over the cross-sectional area of the offgas duct or the inflow area of the reaction zone (catalyst bed).

The specific design and dimensioning of these distributors, including suitable exit nozzles, is part of specialist knowledge in catalytic offgas cleaning technology and is widely employed, for example, in offgas treatment for coal-fired power plants.

The offgas treatment system of the invention may comprise a single reaction zone. In this case, the catalyst used in this single reaction zone serves as N₂O decomposition catalyst and/or N₂O reduction catalyst and as NO_{X} reduction catalyst. In this case, the steps (c) and (d) of the method of the invention are effected essentially simultaneously within this reaction zone, or the apparatus of the invention is configured correspondingly. However, it should be noted that the kinetics of the individual conversions can be quite different. For instance, depending on the catalyst material used, the chemical reduction of NO_{X} with NH₃ as reducing agent can proceed much more quickly than the chemical reduction of N₂O with NH₃. Thus, if NO_{X} and N₂O are in a mixture and NH₃ is fed in as reducing agent, different reactions will take place in the front section of the single reaction zone than in the rear section of the single reaction zone. In the front section, owing to the faster kinetics, the chemical reduction of NO_{X} proceeds predominantly, and only in the rear section, once the majority of the NO_{X} has been broken down, does the chemical reduction of N₂O proceed.

Alternatively, the offgas treatment system may comprise several reaction zones, which is preferred in accordance with the invention. If several reaction zones are included, they are preferably in succession, such that offgas flows through them one after another: first the first reaction zone and then the second reaction zone and, if appropriate, then the third reaction zone, or the apparatus of the invention is configured correspondingly.

In preferred embodiments, the reaction zones are each spatially separated catalyst beds.

In preferred embodiments, the offgas undergoes the steps of the method of the invention in one of the following sequences, or the apparatus of the invention is configured correspondingly:
(i) (a)→(b)→(c₁)→(d); where step (c₁) preferably proceeds in a first reaction zone; and step (d) proceeds in a second reaction zone;
(ii) (a)→(b)→(d)→(c₂); where step (d) preferably proceeds in a first reaction zone; and step (c₂) proceeds in a second reaction zone;
(iii) (a)→(b)→(d)→(c₂)→(c₁); where step (d) preferably proceeds in a first reaction zone; step (c₂) proceeds in a second reaction zone; and step (c₁) proceeds in a third reaction zone;
(iv) (a)→(b)→(d)→(c₁)+ (c₂); where step (d) preferably proceeds in a first reaction zone; and step (c₁) and step (c₂) proceed in a second reaction zone;
(v) (a)→(b)→(d)→(c₁); where step (d) preferably proceeds in a first reaction zone; and step (c₁) proceeds in a second reaction zone;
(vi) (a)→(b)→(c₁)+ (d)→(d*); preferably, step (c₁) and step (d) incompletely proceed in a first reaction zone; and the remainder of step (d*) proceeds in a second reaction zone;
(vii) (a)→(b)→(c₁)+ (d)→(d*)+ (c₂); where step (c₁) and step (d) incompletely preferably proceed in a first reaction zone; and step (2) and the remainder of step (d*) proceed in a second reaction zone;
(viii) (a)→(b)→(c₁)+ (c₂)+ (d)→(c1*)+ (c2*)+ (d*); wherein step (c₁) incompletely and step (c₂) incompletely and step (d) incompletely preferably proceed in a first reaction zone which preferably does not contain a zeolitic material as catalyst; and the remainder of step (c1*) and the remainder of step (c2*) and the remainder of step (d*) proceed in a second reaction zone which preferably contains zeolitic material as catalyst;
(ix) (a)→(b)→(c₁)+ (c₂)+ (d)→(c1*)+ (c2*)+ (d*); wherein step (c₁) incompletely and step (c₂) incompletely and step (d) incompletely preferably proceed in a first reaction zone which preferably contains a zeolitic material as catalyst; and the remainder of step (c1*) and the remainder of step (c2*) and the remainder of step (d*) proceed in a second reaction zone which preferably contains an NO_{X}-sensitive N₂O decomposition catalyst as catalyst;
(x) (a)→(b)→(c₁)→(c1*)+ (c2)+ (d); where step (c₁) incompletely preferably proceeds in a first reaction zone which preferably contains zeolitic material as catalyst; and the remainder of step (c1*) and step (c₂) and step (d) proceed in a second reaction zone which preferably contains zeolitic material as catalyst;
(xi) (a)→(b)→(c₁)→(c1*)+ (c₂)+ (d); where step (c₁) incompletely preferably proceeds in a first reaction zone which preferably contains an NO_{X}-sensitive N₂O decomposition catalyst as catalyst; and the remainder of step (c1*) and step (c₂) and step (d) proceed in a second reaction zone which preferably contains zeolitic material as catalyst.

If, for engine-related reasons, it is necessary to use an NH₃ oxidation catalyst which cannot consist of the same material as the catalyst for step (c) and/or (d), this may be arranged in a dedicated additional reaction zone, and NH₃ is oxidized with O₂ therein.

In preferred embodiments, this is effected upstream of the respective reaction zones for steps (d) and (c) in flow direction of the offgas.

In preferred embodiments, this is effected downstream of the reaction zones for steps (d) and (c) in flow direction of the offgas.

According to the invention, it is also possible to implement such a materially different NH₃ oxidation catalyst within one or more of the reaction zones for step (c) and/or step (d), in particular when the reaction zones are configured as a honeycomb body. The NH₃ oxidation catalyst is then preferably in a layered configuration, in which case the layer of the catalyst for step (c) and/or step (d) preferably covers the layer of the NH₃ oxidation catalyst.

However, it is also possible that two or more reaction zones can be implemented by a single catalyst bed. Two reaction zones in a shared catalyst bed can be formed in particular by a feed of reducing agent in the middle (or another position along the longitudinal extent) of the catalyst bed, or the apparatus of the invention is configured correspondingly. There is then no reducing agent upstream of the feed point, such that steps (c₂) and (d) of the method of the invention cannot take place for lack of reducing agent, or the apparatus of the invention is configured correspondingly. What is then effected upstream is essentially the decomposition of N₂O as per step (c₁) (first reaction zone), or the apparatus of the invention is configured correspondingly. Downstream of the feed point, reducing agent is present, and so steps (c₂) and (d) of the method of the invention can take place, possibly overlapping with step (c₁) of the method of the invention (second reaction zone), or the apparatus of the invention is configured correspondingly. In this case too, different reactions may occur in the front section of each reaction zone than in the rear section of each reaction zone, because of the different reaction kinetics; however, the first reaction zone and the second reaction zone will in any case differ from one another in that no chemical reduction of N₂O and also no chemical reduction of NO_{X} takes place in the first reaction zone for lack of reducing agent, or the apparatus of the invention is configured correspondingly.

In particularly preferred embodiments, the offgas treatment system comprises a first reaction zone and a second reaction zone. It is possible that further reaction zones are present.

In preferred embodiments, the first reaction zone and the second reaction zone are spatially separated from each other. In this case, they are preferably separate catalyst beds. In the case of spatial separation of the catalyst beds, it is possible to adjust the temperature of the second catalyst bed or the gas stream entering it by removal or supply of heat such that it is lower or higher than that of the first catalyst bed. The temperature of a single catalyst bed can appropriately be determined as the arithmetic mean of the temperature of the gas stream at the inlet and outlet from the catalyst bed.

In preferred embodiments, the temperature in the first reaction zone (in the first catalyst bed) is higher than the temperature in the second reaction zone (in the second catalyst bed), or the apparatus of the invention is configured correspondingly.

Preferably, the offgas temperature on entry into the first reaction zone is in the range from 280 to 400° C., in each case depending on the load and the properties of the internal combustion engine.

Preferably, the temperature in the first reaction zone (in the first catalyst bed) is at least 450° C., preferably at least 500° C., more preferably at least 550° C., most preferably at least 600° C. and in particular at least 650° C., or the apparatus of the invention is configured correspondingly.

Preferably, the offgas temperature on entry into the second reaction zone is in the range from 280 to 400° C., in each case depending on the load and the properties of the internal combustion engine.

Preferably, the temperature in the second reaction zone (in the second catalyst bed) is at most 600° C., more preferably at most 550° C., even more preferably at most 500° C., most preferably at most 450° C., and in particular at most 400° C., or the apparatus of the invention is configured correspondingly.

Preferably, the temperature in the first reaction zone (in the first catalyst bed), in relative terms, is at least 20° C., more preferably at least 40° C., even more preferably at least 60° C., most preferably at least 80° C. and in particular at least 100° C. higher than the temperature in the second reaction zone (in the second catalyst bed), or the apparatus of the invention is configured correspondingly.

Preferably, the temperature in the first reaction zone (in the first catalyst bed), in relative terms, is at least 120° C., more preferably at least 140° C., even more preferably at least 160° C., most preferably at least 180° C. and in particular at least 200° C. higher than the temperature in the second reaction zone (in the second catalyst bed), or the apparatus of the invention is configured correspondingly.

Preferably, the offgas temperature on entry into the first reaction zone (into the first catalyst bed) is at least 400° C., more preferably at least 425° C., even more preferably at least 450° C., most preferably at least 500° C., or the apparatus of the invention is configured correspondingly.

Preferably, the temperature of the offgas on departure from the second reaction zone (from the second catalyst bed) is at most 600° C., more preferably at most 550° C., even more preferably at most 500° C., or the apparatus of the invention is configured correspondingly.

In preferred embodiments, the temperature of the offgas on entry into the first reaction zone (into the first catalyst bed), in relative terms, is at least 20 K, more preferably at least 40 K, even more preferably at least 60 K, most preferably at least 80 K and in particular at least 100 K higher than the temperature of the offgas on entry into the second reaction zone (into the second catalyst bed), or the apparatus of the invention is configured correspondingly.

In preferred embodiments, the temperature of the offgas on entry into the second reaction zone (into the second catalyst bed), in relative terms, is at least 10 K, more preferably at least 20 K, even more preferably at least 30 K, most preferably at least 40 K and in particular at least 50 K higher than the temperature of the offgas on entry into the first reaction zone (into the first catalyst bed), or the apparatus of the invention is configured correspondingly.

In preferred embodiments, the temperature in the first reaction zone (in the first catalyst bed), in relative terms, is at least 120 K, more preferably at least 140 K, even more preferably at least 160 K, most preferably at least 180 K and in particular at least 200 K higher than the temperature in the second reaction zone (in the first catalyst bed), or the apparatus of the invention is configured correspondingly.

In preferred embodiments, the temperature in the second reaction zone (in the second catalyst bed), in relative terms, is at least 120 K, more preferably at least 140 K, even more preferably at least 160 K, most preferably at least 180 K and in particular at least 200 K higher than the temperature in the first reaction zone (in the first catalyst bed), or the apparatus of the invention is configured correspondingly.

In other preferred embodiments, the first reaction zone and the second reaction zone are spatially connected to one another. In this case, the catalyst bed is preferably a shared catalyst bed, wherein outside influences result in a division into reaction zones, in particular by the site of injection of reducing agent, such that reducing agent is not present uniformly across the catalyst bed, or the apparatus of the invention is configured correspondingly.

Preferably, the first reaction zone and the second reaction zone are disposed in a shared vessel.

Preferably, the offgas temperature in the first reaction zone and in the second reaction zone is in each case independently at most 500° C., preferably in each case independently in the range from 350 to 450° C., or the apparatus of the invention is configured correspondingly.

In preferred embodiments, the space velocity in the first reaction zone is greater than the space velocity in the second reaction zone, or the apparatus of the invention is configured correspondingly. Preferably, the space velocity in the first reaction zone is greater at least by a factor of 1.2, more preferably at least a factor of 1.4, even more preferably at least a factor of 1.6, most preferably at least a factor of 1.8 and in particular at least a factor of 2.0 than the space velocity in the second reaction zone.

In other preferred embodiments, the space velocity in the second reaction zone is greater than the space velocity in the first reaction zone, or the apparatus of the invention is configured correspondingly. Preferably, the space velocity in the second reaction zone is greater at least by a factor of 1.5, more preferably at least a factor of 2.0, even more preferably at least a factor of 3.0, most preferably at least a factor of 5.0 and in particular at least a factor of 10.0 than the space velocity in the first reaction zone.

In the context of the invention, “space velocity” means the quotient of the volume flow rate of the gas mixture conducted through the catalyst bed (measured at 0° C. and 1.014 bara and typically reported in standard m³·h⁻¹), based on the volume of the catalyst or catalyst bed. The space velocity can thus be adjusted via the volume flow rate of the gas and/or the amount of catalyst.

Preferably, the offgas on entry into the offgas treatment system is at a temperature of at least 300° C., more preferably at least 350° C., even more preferably at least 400° C., most preferably at least 425° C., and in particular at least 450° C., or the apparatus of the invention is configured correspondingly.

Preferably, the offgas on entry into the offgas treatment system is at a temperature of at least 500° C., more preferably at least 550° C., even more preferably at least 600° C., most preferably at least 625° C., and in particular at least 650° C.

Preferably, the offgas on entry into the offgas treatment system is at a temperature of at least 500° C., more preferably at least 550° C., even more preferably at least 600° C., most preferably at least 625° C., and in particular at least 650° C., or the apparatus of the invention is configured correspondingly.

Preferably, the offgas on entry into the offgas treatment system is at a temperature of at most 825° C., more preferably at most 800° C., even more preferably at most 775° C., most preferably at most 750° C., and in particular at most 725° C., or the apparatus of the invention is configured correspondingly.

Preferably, the offgas on entry into the offgas treatment system is at a temperature of at most 700° C., more preferably at most 650° C., even more preferably at most 600° C., most preferably at most 550° C., and in particular at most 500° C., or the apparatus of the invention is configured correspondingly.

Preferably, the offgas on entry into the offgas treatment system is at a temperature in the range from 320 to 600° C.; preferably 350 to 600° C.

Preferably, the offgas on entry into the offgas treatment system is at a temperature which, in relative terms, is at least 20° C., preferably at least 40° C., more preferably at least 60° C., even more preferably at least 80° C., most preferably at least 100° C., and in particular at least 120° C., below the temperature of the offgas on departure from the internal combustion engine, or the apparatus of the invention is configured correspondingly.

Preferably, the offgas on entry into the offgas treatment system is at a pressure of at most 5 bara, preferably of at most 4 bara, or the apparatus of the invention is configured correspondingly.

Preferably, the offgas on entry into the offgas treatment system has a degree of oxidation of NO_{X} of at least 10%, more preferably at least 20%, even more preferably at least 30%, most preferably at least 40%, and in particular at least 50%, or the apparatus of the invention is configured correspondingly.

Preferably, the offgas on entry into the offgas treatment system has a degree of oxidation of NO_{X} of at most 90%, preferably at most 80%, even more preferably at most 70%, most preferably at most 60%, and in particular at most 50%, or the apparatus of the invention is configured correspondingly.

Depending on the combustion temperature, the degree of oxidation may also be significantly lower, and the degree of oxidation decreases with increasing combustion temperature. Preferably, the offgas on entry into the offgas treatment system has a degree of oxidation of NO_{X} of at most 15%, more preferably at most 12.5%, even more preferably at most 10%, most preferably at most 7.5%, and in particular at most 5.0%.

Preferably, the offgas on entry into the offgas treatment system has an O₂ content of less than 2.0% by volume, or the apparatus of the invention is configured correspondingly.

Preferably, the offgas on entry into the offgas treatment system has an O₂ content of at least 3.0% by volume; preferably at least 3.1% by volume, more preferably at least 3.2% by volume, even more preferably at least 3.3% by volume, most preferably at least 3.4% by volume, and in particular at least 3.5% by volume, or the apparatus of the invention is configured correspondingly.

Preferably, the offgas on entry into the offgas treatment system has an O₂ content of more than 4.0% by volume, or the apparatus of the invention is configured correspondingly.

In step (c) of the method of the invention, the N₂O content in the offgas is reduced, or the apparatus of the invention is configured correspondingly. This can be effected in various ways, namely by (c₁) decomposition of N₂O over an N₂O decomposition catalyst and/or by (c₂) chemical reduction of N₂O with reducing agent over an N₂O reduction catalyst. Step (c) of the method of the invention is performed in the offgas treatment system, or the apparatus of the invention is configured correspondingly.

In preferred embodiments, step (c) comprises reducing the N₂O content in the offgas by (c₁) decomposition of N₂O over an N₂O decomposition catalyst, or the apparatus of the invention is configured correspondingly.

In preferred embodiments, the N₂O decomposition catalyst comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.

In other preferred embodiments, the N₂O decomposition catalyst is an NO_{X}-sensitive N₂O decomposition catalyst within the context of the invention, which has already been described in detail above. In this case, the offgas preferably first passes through step (d), i.e. the NO_{X} content in the offgas is first reduced by chemical reduction of NO_{X} with reducing agent over an NO_{X} reduction catalyst, preferably quantitatively, before the offgas then comes into contact with the NO_{X}-sensitive N₂O decomposition catalyst, or the apparatus of the invention is configured correspondingly.

Preferably, the N₂O decomposition catalyst is disposed in a radial basket through which the flow passes axially, or the apparatus of the invention is configured correspondingly.

The N₂O decomposition catalyst is preferably particulate and comprises at least 50 particles.

In preferred embodiments, step (c) comprises reducing the N₂O content in the offgas by (c₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type, or the apparatus of the invention is configured correspondingly.

Preferably, the N₂O reduction catalyst is disposed in a radial basket through which the flow passes axially, or the apparatus of the invention is configured correspondingly.

The N₂O reduction catalyst is preferably particulate and comprises at least 50 particles.

In preferred embodiments, step (c) comprises reducing the N₂O content in the offgas
both by (c₁) decomposing N₂O over an N₂O decomposition catalyst; preferably wherein the N₂O decomposition catalyst is a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU, AEI and/or MEL structure type, or the apparatus of the invention is configured correspondingly;
and by (c₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type, or the apparatus of the invention is configured correspondingly.

Preferably, the reducing agent in step (c₂) is selected from NH₃, hydrocarbons, CO, H₂ and mixtures thereof; preferably NH₃, or the apparatus of the invention is configured correspondingly.

In preferred embodiments, the reducing agent in step (c₂) is NH₃, which is preferably used in an amount of 0.5 to 2.0 molar parts, more preferably in an amount of 0.8 to 1.8 molar parts, based on a molar proportion of N₂O to be reduced chemically, i.e. based on the amount of N₂O at the inlet into the catalyst bed of the N₂O reduction catalyst, or the apparatus of the invention is configured correspondingly.

In preferred embodiments, the reducing agent in step (c₂) is NH₃, which is preferably used in an amount of 0.5 to 2.0 molar parts, more preferably in an amount of 0.8 to 1.8 molar parts based on the molar amount of N₂O in the offgas at the inlet into the catalyst bed of the N₂O reduction catalyst. This amount is additive to any required amount of NH₃ for NO_{X} reduction if step (d) likewise proceeds in the catalyst bed of the N₂O reduction catalyst.

In other preferred embodiments, the reducing agent is a hydrocarbon or a mixture of two or more hydrocarbons, which are preferably used in an amount of 0.2 to 1.0 molar part, more preferably of 0.2 to 0.7 molar part, based on the molar amount of N₂O in the offgas at the inlet into the catalyst bed of the N₂O reduction catalyst. This amount is likewise additive to any required amount of NH₃ for NO_{X} reduction if step (d) likewise proceeds in the catalyst bed of the N₂O reduction catalyst, or the apparatus of the invention is configured correspondingly.

The reducing agent may likewise already be present in the offgas, for example in the form of residual fuels and/or oxidation products thereof. In that case, the method of the invention not only reduces the content of nitrogen oxides (NO_{X} and N₂O) but also the content of these impurities (residual fuels and/or oxidation products thereof, especially NH₃ slip), or the apparatus of the invention is configured correspondingly.

In step (d) of the method of the invention, the NO_{X} (i.e. NO and NO₂) content in the offgas is reduced, or the apparatus of the invention is configured correspondingly. This is effected by chemical reduction of NO_{X} with reducing agent over an NO_{X} reduction catalyst. Step (d) of the method of the invention is likewise performed in the offgas treatment system, or the apparatus of the invention is configured correspondingly.

The NO_{X} reduction catalyst preferably contains a zeolitic material; preferably a zeolite laden with transition metal (including lanthanide), in particular with iron, cobalt or copper; more preferably an iron-laden zeolite comprises; even more preferably an iron-laden zeolite of the MFI, BEA, FER, MOR, FAU, AEI and/or MEL structure type.

Preferably, the NO_{X} reduction catalyst is disposed in a radial basket through which the flow passes axially, or the apparatus of the invention is configured correspondingly.

Preferably, the NO_{X} reduction catalyst is particulate and comprises at least 50 particles.

Preferably, the reducing agent in step (d) is selected from NH₃, hydrocarbons, CO, H₂ and mixtures thereof; preferably NH₃, or the apparatus of the invention is configured correspondingly.

Preferably, the reducing agent in step (d) is NH₃, which is used in an amount of 0.9 to 2.5 molar parts, preferably 1.0 to 1.4 molar parts, preferably 1.0 to 1.2 molar parts, based on a molar proportion of NO_{X} to be chemically reduced, or the apparatus of the invention is configured correspondingly.

In preferred embodiments, the reducing agent in step (c₂) is the same as the reducing agent in step (d); preferably NH₃, or the apparatus of the invention is configured correspondingly.

In addition to NH₃, in steps (c₂) and/or (d) of the method of the invention, other nitrogen-containing reducing agents are also suitable in principle, for example hydrogen compounds of nitrogen, such as azanes, hydroxyl derivatives of azanes, and amines, oximes, carbamates, urea or urea derivatives, or the apparatus of the invention is configured correspondingly. Examples of azanes are hydrazine and very particularly ammonia. Examples of hydroxyl derivatives of azanes are hydroxylamine. Examples of amines are primary aliphatic amines, such as methylamine. One example of carbamates is ammonium carbamate. Examples of urea derivatives are N,N′-substituted ureas, such as N,N′-dimethyl urea. Urea and urea derivatives are preferably used in the form of aqueous solutions. Particular preference is given to ammonia or substances that release ammonia on introduction, such as urea or ammonium carbamate.

Particularly preferred process regimes of the invention or corresponding configurations of the apparatus of the invention are elucidated in detail hereinafter:

### Single Reaction Zone

In preferred embodiments, the offgas treatment system comprises a single reaction zone (optionally, aside from a further reaction zone comprising an NH₃ oxidation catalyst, preferably an NH₃ oxidation-active iron- or copper-laden zeolite catalyst, see below) comprising
as N₂O decomposition catalyst and/or N₂O reduction catalyst and
as NH₃ reduction catalyst
   a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type; and wherein a device for metered addition of reducing agent for N₂O and/or NO_{X} to the offgas is disposed upstream of the single reaction zone in flow direction of the offgas.

Preferably, the device for metered addition of reducing agent is a device for metered addition of NH₃.

In preferred embodiments, a further device for metered addition of reducing agent for N₂O and/or NO_{X} to the offgas is disposed upstream of the single reaction zone in flow direction of the offgas. Preferably, the further device for metered addition of reducing agent is a device for metered addition of natural gas.

In preferred embodiments, a further reaction zone comprising an NH₃ oxidation catalyst is disposed upstream of the single reaction zone in flow direction of the offgas; preferably an NH₃ oxidation catalyst which is free of platinum group metals, more preferably free of precious metals; more preferably an NH₃ oxidation-active iron- or copper-laden zeolite catalyst; even more preferably in layer configuration.

For the purpose of the description, “zone configuration” means that the catalysts are in the form of honeycomb bodies, which are optionally combined to form honeycomb body modules, wherein several honeycomb bodies or honeycomb body modules may be arranged successively in flow direction of the offgas. Honeycomb bodies or honeycomb body modules disposed upstream then form a first “zone”, which serves as the first reaction zone. Honeycomb bodies or honeycomb body modules disposed downstream then form a second “zone”, which serves as the second reaction zone. In this way, two, three, four or more zones can be configured in succession and form a zone configuration of the invention.

For the purposes of the description, what is meant by “layer configuration”, in delimitation and addition to the zone configuration, is that the catalytically active material takes the form of a bifunctional two-layer catalyst (bifunctional dual-layer catalyst), where the NH₃ oxidation catalyst of the invention is preferably present in the lower of the two layers (lower washcoat), and the N₂O decomposition, N₂O reduction and/or NO_{X} reduction catalyst of the invention in the upper of the two layers. The bifunctional two-layer catalyst preferably takes the form of a honeycomb body or honeycomb body module.

If steps (c) and (d) of the method of the invention are performed in a first reaction zone and a second reaction zone downstream (zone configuration), the above-described layer configuration of the NH₃ oxidation catalyst is possible in both reaction zones. In preferred embodiments, the NH₃ oxidation catalyst in layer configuration is present only in the first reaction zone. In other preferred embodiments, the NH₃ oxidation catalyst in layer configuration is present only in the second reaction zone. In further preferred embodiments, the NH₃ oxidation catalyst in layer configuration is present in both the first reaction zone and the second reaction zone.

In preferred embodiments, the apparatus has a controllable bypass around the NH₃ oxidation catalyst which is preferably free of platinum group metals, more preferably free of precious metals, more preferably NH₃ oxidation-active iron- or copper-laden zeolite catalyst. Preferably, a device disposed upstream of the single reaction zone in flow direction of the offgas is used to measure the concentration in the offgas of NH₃, NO_{X} or N₂O; preferably of NH₃ and NO_{X} and N₂O; and wherein the opening of the bypass is controllable by open-loop or closed-loop control.

In preferred embodiments, a further reaction zone comprising an NH₃ oxidation catalyst is disposed downstream of the single reaction zone in flow direction of the offgas; preferably an NH₃ oxidation catalyst which is free of platinum group metals, more preferably free of precious metals; more preferably an NH₃ oxidation-active iron- or copper-laden zeolite catalyst; even more preferably in layer configuration.

In preferred embodiments, the NH₃ oxidation catalyst which is preferably free of platinum group metals, more preferably free of precious metals; more preferably NH₃ oxidation-active iron- or copper-laden zeolite catalyst, is disposed upstream of an offgas turbine in flow direction of the offgas. In other preferred embodiments, the NH₃ oxidation catalyst which is preferably free of platinum group metals, more preferably free of precious metals; more preferably NH₃ oxidation-active iron- or copper-laden zeolite catalyst, is disposed downstream of an offgas turbine in flow direction of the offgas. Preferably, the sole reaction zone is disposed upstream of the offgas turbine in flow direction of the offgas.

### At Least Two Reaction Zones Arranged in Succession

In preferred embodiments, the offgas treatment system comprises a first reaction zone and a second reaction zone disposed downstream in flow direction of the offgas, which are configured in such a way that the offgas passes through them successively;
wherein the first reaction zone and the second reaction zone each independently comprise, as N₂O decomposition catalyst and/or N₂O reduction catalyst and/or as NH₃ reduction catalyst, a zeolitic material;
preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type; and
wherein a device for metered addition of reducing agent for N₂O and/or NO_{X} to the offgas is disposed downstream of the first reaction zone and upstream of the second reaction zone in flow direction of the offgas.

Preferably, the device for metered addition of reducing agent is a device for metered addition of NH₃.

In preferred embodiments, a further device for metered addition of reducing agent for N₂O and/or NO_{X} to the offgas is disposed upstream of the single reaction zone in flow direction of the offgas. Preferably, the further device for metered addition of reducing agent is a device for metered addition of natural gas.

In preferred embodiments, an additional device for metered addition of reducing agent for N₂O and/or NO_{X} to the offgas is disposed upstream of the first reaction zone flow direction of the offgas. Preferably, the additional device for metered addition of reducing agent is a device for metered addition of NH₃.

In preferred embodiments,
the first reaction zone comprises a copper-laden zeolite; preferably a copper-laden zeolite of the MFI, BEA, FER, MOR, FAU, AEI and/or MEL structure type; and
the second reaction zone comprises an iron-laden zeolite; preferably an iron-laden zeolite of the MFI, BEA, FER, MOR, FAU, AEI and/or MEL structure type.

In preferred embodiments, a device disposed downstream of the first reaction zone and upstream of the second reaction zone in flow direction of the offgas is used to measure the concentration in the offgas of NH₃, NO_{X} or N₂O; preferably of NH₃ and NO_{X} and N₂O. Preferably, at least one device selected from the device for metered addition of reducing agent, any further device for metered addition of reducing agent, and any additional device for metered addition of reducing agent is controllable by open-loop or closed-loop control; preferably by feed-forward control; as a function of the measured concentration in the offgas of NH₃, NO_{X} or N₂O; preferably of NH₃ and NO_{X} and N₂O.

In preferred embodiments, a device disposed upstream of the first reaction zone in flow direction of the offgas is used to measure the concentration in the offgas of NH₃, NO_{X} or N₂O; preferably of NH₃ and NO_{X} and N₂O. Preferably, at least one device selected from the device for metered addition of reducing agent, any further device for metered addition of reducing agent, and any additional device for metered addition of reducing agent is controllable by open-loop or closed-loop control; preferably by feed-forward control; as a function of the measured concentration in the offgas of NH₃, NO_{X} or N₂O; preferably of NH₃ and NO_{X} and N₂O.

In preferred embodiments, a further reaction zone comprising an NH₃ oxidation catalyst is disposed downstream of the first reaction zone and upstream of the second reaction zone in flow direction of the offgas; preferably an NH₃ oxidation catalyst which is free of platinum group metals, more preferably free of precious metals; more preferably an NH₃ oxidation-active iron- or copper-laden zeolite catalyst; even more preferably in layer configuration.

In preferred embodiments, a further reaction zone comprising an NH₃ oxidation catalyst is disposed downstream of the first reaction zone and upstream of the second reaction zone and upstream of the device for metered addition of reducing agent and any further device for metered addition of reducing agent flow direction of the offgas; preferably an NH₃ oxidation catalyst which is free of platinum group metals, more preferably free of precious metals; more preferably an NH₃ oxidation-active iron- or copper-laden zeolite catalyst; even more preferably in layer configuration.

In preferred embodiments, a further reaction zone comprising an NH₃ oxidation catalyst is disposed downstream of the second reaction zone in flow direction of the offgas; preferably an NH₃ oxidation catalyst which is free of platinum group metals, more preferably free of precious metals; more preferably an NH₃ oxidation-active iron- or copper-laden zeolite catalyst; even more preferably in layer configuration.

In preferred embodiments, the apparatus has a controllable bypass around the NH₃ oxidation catalyst which is preferably free of platinum group metals, more preferably free of precious metals, more preferably NH₃ oxidation-active iron- or copper-laden zeolite catalyst. Preferably, a device disposed upstream of the first reaction zone or upstream of the second reaction zone in flow direction of the offgas is used to measure the concentration in the offgas of NH₃, NO_{X} or N₂O; preferably of NH₃ and NO_{X} and N₂O; and wherein the opening of the bypass is controllable by open-loop or closed-loop control.

In preferred embodiments, the NH₃ oxidation catalyst which is preferably free of platinum group metals, more preferably free of precious metals; more preferably NH₃ oxidation-active iron- or copper-laden zeolite catalyst, is disposed upstream of an offgas turbine in flow direction of the offgas. In other preferred embodiments, the NH₃ oxidation catalyst which is preferably free of platinum group metals, more preferably free of precious metals; more preferably NH₃ oxidation-active iron- or copper-laden zeolite catalyst, is disposed downstream of an offgas turbine in flow direction of the offgas. Preferably, the first reaction zone is disposed upstream of the offgas turbine in flow direction of the offgas. Preferably, the second reaction zone is disposed upstream of the offgas turbine in flow direction of the offgas.

In preferred embodiments, the offgas treatment system comprises at least one additional component selected from diesel oxidation catalysts, lean NO_{X} trap catalysts, NO_{X} absorption components, noncatalytic particulate filters, and catalytic particulate filters; preferably wherein all additional components are disposed upstream of the second reaction zone in flow direction of the offgas.

DeNO_{X}-deN₂O—Variant 1

In preferred embodiments, the offgas treatment system comprises a first reaction zone and a second reaction zone beyond, through which the offgas passes successively;
wherein reducing agent is added to the offgas upstream of the first reaction zone;
wherein, in the first reaction zone, the NO_{X} content in the offgas is first reduced by chemical reduction of NO_{X} with reducing agent over an NO_{X} reduction catalyst (step (d)) (deNO_{X} stage); wherein the N₂O content in the offgas is optionally additionally reduced by decomposition of N₂O over an N₂O decomposition catalyst (step (c₁)) and/or by chemical reduction of N₂O with reducing agent over an N₂O reduction catalyst (step (c₂));
wherein further reducing agent is optionally added to the offgas upstream of the second reaction zone; and
wherein, in the second reaction zone, the N₂O content in the offgas is then reduced by decomposition of N₂O over an N₂O decomposition catalyst (step (c₁)) and/or by chemical reduction of N₂O with reducing agent over an N₂O reduction catalyst (step (c₂)) (deN₂O stage); wherein the NO_{X} content in the offgas is optionally additionally further reduced by chemical reduction of NO_{X} over an NO_{X} reduction catalyst (step (d)), or the apparatus of the invention is configured correspondingly.

Preferably, the NO_{X} reduction catalyst in the first reaction zone comprises a conventional, preferably non-zeolitic SCR catalyst, for example based on V₂O₅—WO₃—/TiO₂.

Preferably, the temperature of the offgas on entry into the first reaction zone is at most 400° C., preferably at most 350° C., or the apparatus of the invention is configured correspondingly.

Preferably, the N₂O decomposition catalyst in the second reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.

Preferably, the offgas temperature on entry into the second reaction zone is in the range from 300 to 550° C., preferably 350 to 500° C., or the apparatus of the invention is configured correspondingly.

Preferably, the offgas after leaving the first reaction zone and before entering the second reaction zone has an NO_{X} content in the range from 0 to 200 ppmv, preferably 1 to 200 ppmv, and an N₂O content in the range from 200 to 2000 ppmv, or the apparatus of the invention is configured correspondingly.

DeNO_{X}-deN₂O—Variant 2

In other preferred embodiments, the offgas treatment system likewise comprises a first reaction zone and a second reaction zone beyond, through which the offgas passes successively;
wherein reducing agent is added to the offgas upstream of the first reaction zone;
wherein, in the first reaction zone, the NO_{X} content in the offgas is first reduced by chemical reduction of NO_{X} with reducing agent over an NO_{X} reduction catalyst (step (d)) (deNO_{X} stage); wherein the N₂O content in the offgas is optionally additionally reduced by decomposition of N₂O over an N₂O decomposition catalyst (step (c₁)) and/or by chemical reduction of N₂O with reducing agent over an N₂O reduction catalyst (step (c₂));
wherein further reducing agent is optionally added to the offgas upstream of the second reaction zone; and
wherein, in the second reaction zone, the N₂O content in the offgas is then reduced by decomposition of N₂O over an N₂O decomposition catalyst (step (c₁)) and/or by chemical reduction of N₂O with reducing agent over an N₂O reduction catalyst (step (c₂)) (deN₂O stage); wherein the NO_{X} content in the offgas is optionally additionally further reduced by chemical reduction of NO_{X} over an NO_{X} reduction catalyst (step (d)), or the apparatus of the invention is configured correspondingly.

Preferably, the NO_{X} reduction catalyst in the first reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.

Preferably, the offgas temperature on entry into the first reaction zone is at least 300° C., more preferably at least 350° C., even more preferably at least 400° C. Preferably, the temperature of the offgas on entry into the first reaction zone is at most 600° C., more preferably at most 550° C., or the apparatus of the invention is configured correspondingly.

Preferably, the N₂O decomposition catalyst in the second reaction zone comprises an NO_{X}-sensitive N₂O decomposition catalyst within the context of the invention, which has already been described in detail above.

Preferably, the offgas temperature on entry into the second reaction zone is at least 300° C., more preferably at least 350° C., even more preferably at least 400° C. Preferably, the temperature of the offgas on entry into the second reaction zone is at most 600° C., more preferably at most 550° C., or the apparatus of the invention is configured correspondingly.

Preferably, the offgas after leaving the first reaction zone and before entering the second reaction zone has an NO_{X} content of at most 20 ppmv, more preferably at most 10 ppmv, even more preferably at most 5 ppmv, and an N₂O content in the range from 200 to 2000 ppmv, or the apparatus of the invention is configured correspondingly.

Particularly Preferred Embodiments of deNO_{X}-deN₂O—Variant 2

In particularly preferred embodiments, the offgas treatment system of the invention comprises a first catalyst bed and a spatially separated second catalyst bed; wherein the first catalyst bed is disposed upstream of the second catalyst bed in flow direction of the offgas; wherein a first apparatus with a first control valve for metered addition of NH₃ to the offgas is optionally and preferably disposed upstream of the first catalyst bed; wherein a second apparatus with a second control valve for metered addition of NH₃ to the offgas is disposed downstream of the first catalyst bed and upstream of the second catalyst bed, with which further NH₃ is metered into the offgas; wherein both the first catalyst bed and the second catalyst bed each contain an iron-laden zeolite catalyst; wherein (i) in the first catalyst bed (c₁), N₂O is decomposed; and (d) NO_{X} is incompletely chemically reduced with NH₃, where at least a portion of the NH₃ optionally and preferably comes from incomplete combustion of NH₃ in step (a) (NH₃ slip); and (ii) in the second catalyst bed (c₂), residual N₂O is chemically reduced with NH₃ and (c1*) residual N₂O is optionally decomposed; and (d*) residual NO_{X} is chemically reduced with NH₃.

Preferably, the catalytic decomposition of N₂O in the first catalyst bed is cocatalyzed by NO_{X} present in the offgas.

Preferably, the incomplete chemical reduction of NO_{X} with NH₃ in the first catalyst bed leads down to a predetermined residual NO_{X} content which is sufficient to bring about a cocatalytic effect on the decomposition of N₂O in the first catalyst bed. Since the chemical reduction of NO_{X} with NH₃ in the first catalyst bed typically proceeds much more quickly than the chemical reduction of N₂O with NH₃, and the amount of NO_{X} chemically reduced in the first catalyst bed is not the whole amount, the extent of any parallel chemical reduction of N₂O with NH₃ in the first catalyst bed is typically negligible.

Preferably, additional NH₃ for NO_{X} reduction is metered into the offgas by means of the first apparatus; preferably under feedback control, i.e. a particular value for the concentration of NO_{X} on departure from the first catalyst bed is defined as the target value (setpoint) and the actual concentration of NO_{X} on departure from the first catalyst bed is measured (actual value); and in the event of a difference between setpoint and actual value (control difference), the output of the first control valve is altered in order to minimize the difference. Preferably, the setpoint of the NO_{X} concentration on departure from the first catalyst bed and hence the amount of additional NH₃ is chosen such that the residual concentration of NO_{X} on departure from the first catalyst bed is at most 1000 ppmv, preferably at most 500 ppmv, more preferably at most 100 ppmv. Preferably, the setpoint of the NO_{X} concentration on departure from the first catalyst bed and hence the amount of additional NH₃ is chosen such that the residual concentration of NO_{X} on departure from the first catalyst bed is at least 10 ppmv, preferably at least 20 ppmv, more preferably at least 40 ppmv. The expected specific consumption of NH₃ for the chemical reduction of NO_{X} in the first catalyst bed is typically in the range from 0.9 to 1.1 mol of NH₃ per mole of reduced NO_{X} and is therefore significantly smaller than the expected specific (mol/mol) consumption of NH₃ in the second catalyst bed.

Preferably, the offgas temperature on departure from the first catalyst bed is in the range from 400 to 550° C.

Preferably, the offgas on departure from the first catalyst bed has a pressure greater than atmospheric pressure, i.e. ≥1.0 bara, but at most 1.2 bara, more preferably at most 1.1 bara.

Preferably, the offgas on departure from the first catalyst bed has a degree of oxidation of NO_{X} of at least 5.0%, preferably at least 7.5%, more preferably at least 10%, even more preferably at least 12.5%, most preferably at least 15%, and in particular at least 17.5%.

In preferred embodiments, the offgas on departure from the first catalyst bed has a degree of oxidation of NO_{X} in the range from 30% to 50%.

In other preferred embodiments, the offgas on departure from the first catalyst bed has a degree of oxidation of NO_{X} in the range from 15% to 35%, preferably 15% to 30%.

In further preferred embodiments, the offgas on departure from the first catalyst bed has a degree of oxidation of NO_{X} in the range from 10% to 20%.

In other preferred embodiments, the offgas on departure from the first catalyst bed has a degree of oxidation of NO_{X} in the range from 5% to 15%.

Preferably, residual N₂O is broken down in the second catalyst bed down to a residual concentration of N₂O on departure from the second catalyst bed of at most 20 ppmv, more preferably at most 10 ppmv, even more preferably at most 5 ppmv, most preferably at most 2 ppmv.

Preferably, residual NO_{X} is broken down in the second catalyst bed down to a residual concentration of NO_{X} on departure from the second catalyst bed of at most 20 ppmv, more preferably at most 10 ppmv, even more preferably at most 5 ppmv, most preferably at most 2 ppmv.

Preferably, the further NH₃ is metered in with the second apparatus under feed-forward control, i.e. the concentrations of NO_{X} and optionally preferably of N₂O and optionally preferably of NH₃ are each measured on departure from the first catalyst bed or optionally on entry into the second catalyst bed; the amount of offgas entering the second catalyst bed is taken into account to calculate the amount of NH₃ required for NO_{X} reduction and optionally preferably the sum total of the amount required for NO_{X} reduction and for N₂O reduction with the aid of stored molar ratios (mol/mol) of NH₃/NO_{X} and optionally preferably of NH₃/N₂O or factors derived therefrom; and the calculated result (manipulated variable) is used to alter the output of the second control valve in order to meter in the required amount of NH₃.

Preferably in accordance with the invention, the molar NH₃ concentration [NH₃] of the offgas on entry into the second catalyst bed is in the range from the sum of 0.7×[N₂O] and 1.0×[NO_{X}] to the sum of 4.0×[N₂O] and 2.0×[NO_{X}], more preferably in the range from the sum of 1.0×[N₂O] and 1.1×[NO_{X}] to the sum of 3.0×[N₂O] and 1.6×[NO_{X}], even more preferably in the range from the sum of 1.5×[N₂O] and 1.2×[NO_{X}] to the sum of 2.5×[N₂O] and 1.4×[NO_{X}], where [N₂O] is the molar concentration of N₂O and [NO_{X}] is the molar concentration of NO_{X}, each in the offgas on entry into the second catalyst bed.

Preferably, for the feed-forward control of the metered addition of NH₃ into the second catalyst bed with regard to the NO_{X} reduction, a molar ratio of NH₃/NO_{X} in the range from 1.0 to 2.0; preferably 1.1 to 1.6; more preferably 1.2 to 1.4 is chosen.

Preferably, for the feed-forward control of the metered addition of NH₃ into the second catalyst bed with regard to the N₂O reduction, a molar ratio of NH₃/N₂O in the range from 0.7 to 4.0; preferably 1.0 to 3.0; more preferably 1.5 to 2.5 is chosen.

Preferably, the further NH₃ is not metered in with the second apparatus under feedback control, since the aim is maximum chemical reduction of NO_{X} in the second catalyst bed, meaning that the result is zero or only very small residual concentrations of NO_{X} and N₂O, which would be of limited utility as reference variables for closed-loop control purposes.

Preferably, the amount of catalyst, i.e. the space velocity (=ratio of offgas volume flow rate under standard conditions to catalyst volume) is chosen in such a way that breakdown of N₂O is at least 50% in the first catalyst bed, more preferably at least 70%, even more preferably at least 80%, based on the concentration of N₂O on entry into the first catalyst bed.

Preferably, the catalyst amount and the amount of additional NH₃ are chosen such that, on departure from the first catalyst bed, the molar ratio of NO_{X}/N₂O is at least 5, more preferably at least 10, even more preferably at least 20.

The space velocity of the first catalyst bed is preferably in the range from 5000 h⁻¹ to 100 000 h 1, more preferably 10 000 h⁻¹ to 50 000 h⁻¹, even more preferably 15 000 h⁻¹ to 45 000 h⁻¹.

If the molar ratio of NO_{X}/N₂O on departure from the first catalyst bed is at least 10, the metered addition of NH₃ to the second catalyst bed via the second apparatus can preferably be effected solely in relation to the amount of incoming NO_{X}.

Preferably, the offgas temperature on entry into the first catalyst bed is at least 400° C., more preferably at least 425° C., even more preferably at least 450° C. Preferably, the offgas temperature on entry into the first catalyst bed is not more than 550° C., more preferably not more than 525° C., even more preferably not more than 500° C. The temperature can be adjusted by measures known those skilled in the art, in particular design of heat exchangers and conditions for the combustion of NH₃.

Depending on the exothermicity of the chemical reactions that proceed in the first catalyst bed and in the second catalyst bed, the inlet temperature of the offgas into the first catalyst bed is preferably chosen such that the offgas temperature on departure from the second catalyst bed is at most 600° C., more preferably at most 550° C., even more preferably at most 520° C.

The space velocity of the second catalyst bed is preferably in the range from 5000 h⁻¹ to 100 000 h⁻¹, more preferably 10 000 h⁻¹ to 50 000 h⁻¹, even more preferably 15 000 h⁻¹ to 45 000 h⁻¹.

Preferably, the ratio of catalyst volumes (V1_{cat}/V2_{cat}) of the first catalyst bed V1_{cat} to the second catalyst bed V2_{cat} is in the range from 1/2 to 20/1, more preferably ½ to 10/1, even more preferably 1/1 to 4/1.

In preferred embodiments, at least one, more than one or all of the following conditions are met:
the pressure of the offgas on entry into the first catalyst bed is at most 5 bara, more preferably at most 4 bara;
the H₂O content in the offgas on entry into the first catalyst bed is at least 5% by volume, more preferably at least 10% by volume, even more preferably at least 15% by volume, most preferably at least 20% by volume and in particular at least 25% by volume;
the NO_{X} content in the offgas on entry into the first catalyst bed is at least 500 ppmv, more preferably at least 1000 ppmv, even more preferably at least 1500 ppmv, most preferably at least 2000 ppmv, and in particular at least 2500 ppmv;
the N₂O content in the offgas on entry into the first catalyst bed is at most <500 ppmv, more preferably at most 200 ppmv, even more preferably at most 100 ppmv, but at least 5 ppmv, preferably at least 10 ppmv, more preferably at least 50 ppmv;
the offgas on entry into the first catalyst bed contains uncombusted residues of NH₃ from the combustion of NH₃;
the N₂O decomposition catalyst and/or the N₂O reduction catalyst takes the form of a honeycomb body;
the NO_{X} reduction catalyst takes the form of a honeycomb body;
the first catalyst bed contains Fe zeolite;
the second catalyst bed contains Fe zeolite;
the offgas passes through a temperature control device before entering the first catalyst bed and its temperature is adjusted therein;
the NO_{X} content on departure from the first catalyst bed is at most 1000 ppmv, more preferably at most 500 ppmv, even more preferably at most 300 ppmv, most preferably at most 100 ppmv; but preferably at least 10 ppmv, more preferably at least 20 ppm, even more preferably at least 40 ppmv, most preferably at least 100 ppmv, and in particular at least 250 ppmv;
the N₂O content on departure from the first catalyst bed is at most 20 ppmv, more preferably at most 15 ppmv, even more preferably at most 10 ppmv, most preferably at most 5 ppmv and in particular at most 2 ppmv;
there is no intermediate cooling of the offgas after departure from the first catalyst bed up to entry into the second catalyst bed;
the molar ratio of N₂O:NO_{X} on entry into the first catalyst bed is at most 0.5, more preferably at most 0.2, even more preferably at most 0.1;
the molar ratio of N₂O:NO_{X} on departure from the first catalyst bed is at most 0.20, more preferably at most 0.1, even more preferably at most 0.05;
the feeding of NH₃ into the offgas upstream of the first catalyst bed in flow direction of the offgas is optional; if there is feeding, it is preferably substoichiometric with respect to the NO_{X} content on entry into the first catalyst bed;
the feeding of NH₃ into the offgas downstream of the first catalyst bed and upstream of the second catalyst bed in flow direction of the offgas is obligatory and preferably superstoichiometric with respect to the total content of NO_{X} and N₂O on entry into the second catalyst bed.

The above-described method using Fe zeolite catalysts in two catalyst beds, by comparison with conventional deNO_{X} methods using V₂O₅/TiO₂ catalysts, enables
complete or almost complete breakdown of large amounts of NO_{X} without the risk of NH₃ slip; and
simultaneous, complete or virtually complete breakdown of N₂O at comparatively low catalyst volumes, i.e. at comparatively high space velocities.

Aside from the operating method of the invention, this is achieved by the oxidative properties of the Fe zeolite catalysts used in accordance with the invention. Thus, in the first catalyst bed, the molar ratio of NO to NO₂, according to the invention, is brought as close as possible to the thermodynamic equilibrium position. For instance, the degree of oxidation of NO_{X} (molar ratio of NO₂/(NO+NO₂)) prior to entry into the first catalyst bed, because of the upstream NH₃ combustion at very high temperatures and the only slow establishment of the equilibrium in the gas phase when the offgas is cooled, is less than 5% as expected, and hence well below the thermodynamic equilibrium applicable to the inlet temperature into the first catalyst bed. However, this is very disadvantageous for an efficient chemical reduction of NO_{X} since, as a result, only a small portion of the NO_{X} present in the offgas can be broken down by a fast SCR and a majority of the NO_{X} or of the remaining NO has to be broken down by significantly slower normal SCR.

The chosen mode of operation of the limited metered addition of NH₃ in the first catalyst bed and the ability of the Fe zeolite catalysts to oxidize NO or to catalytically accelerate the establishment of equilibrium results in achievement of a distinctly faster, i.e. more efficient, chemical reduction of NO_{X} in the first catalyst bed, and at the same time establishment of the maximum possible degree of oxidation of NO_{X} in the remaining NO_{X}. This enables efficient chemical reduction of NO_{X} in the second catalyst bed too from the very start.

It has thus been found that large amounts of NH₃, as needed for complete chemical reduction of high concentrations of NO_{X}, similarly to water, inhibit the establishment of the NO_{X} equilibrium on the Fe zeolite catalyst.

In addition, the chemical reduction of NO_{X} as such is also inhibited by NH₃ itself at correspondingly high doses of NH₃. As a result, depending on temperature, catalyst quantity and content of NO_{X}, no further increase in NO_{X} degradation occurs with increasing addition of NH₃ from a certain amount of NH₃ onwards. In the case of a further increase in the addition of NH₃, it is then even possible under some circumstances that a decline in NO_{X} degradation will be observed with a simultaneous NH₃ slip.

Chemical reduction of the NO_{X} previously in the first catalyst bed distinctly reduces the amount of NH₃ needed for chemical reduction of NO_{X} in the second catalyst bed.

In this way, together with the above-described establishment or permanent readjustment of the NO_{X} balance, a very efficient chemical reduction of NO_{X} is also possible in the second catalyst bed, even with the superstoichiometric metered addition of NH₃ in accordance with the invention.

The fact that this is additionally effected in accordance with the invention with a zero or only insignificant NH₃ slip of preferably not more than 10 ppmv, more preferably not more than 5 ppmv, even more preferably not more than 3 ppmv is likewise because of the oxidative properties of the Fe zeolite catalysts used in accordance with the invention. If the inlet temperature of the offgas into the second catalyst bed is preferably at least 400° C., more preferably at least 425° C., even more preferably at least 450° C., the NH₃ metered in in excess within the limits of the invention is selectively oxidized by the residual oxygen content of the offgas present to N₂ and H₂O.

All these advantages cannot be achieved in a single or multistage arrangement when using conventional V₂O₅/TiO₂-based SCR catalysts as typically also used for denoxing of offgases from natural gas-fired reformers. For reasons of stability, these conventional SCR catalysts typically cannot be operated at temperatures above 400° C., which limits the achievable speeds of the breakdown reaction. It is also the case that conventional SCR catalysts have only very limited oxidation activity, and so establishment or permanent readjustment of the NO_{X} equilibrium is not possible, nor do these catalysts enable effective and N₂-selective oxidation of NH₃ metered in in excess. Instead, there is even a risk of unwanted formation of N₂O.

In a variant of the above-described embodiments which is preferred in accordance with the invention, the first catalyst bed and the second catalyst bed contain the same catalyst. In preferred embodiments, the second apparatus with a second control valve for metered addition of NH₃ to the offgas is omitted, while the spatial separation of the first catalyst bed from the second catalyst bed is preferably omitted—in that case, there is in fact only a single shared catalyst bed, with a first apparatus having a first control valve for metered addition of NH₃ to the offgas preferably disposed upstream of this shared catalyst bed. Additional NH₃ is preferably metered into the offgas via the first apparatus, preferably under feed-forward control, i.e. the concentration of NO_{X}, N₂O and NH₃ in the offgas upstream of the common catalyst bed is measured; the amount of offgas entering the shared catalyst bed is taken into account to calculate the additional amount of NH₃ still required; and the calculated result (manipulated variable) is used to alter the setting of the first control valve in order to meter in the amount of additional NH₃ still required. Preferably, in such embodiments, an NH₃ oxidation catalyst is disposed downstream of the shared catalyst bed in order to reduce possible NH₃ slip.

Simultaneous Firing of NH₃ and CH₄-Reduction of the Hydrogen Cyanide Content

In preferred embodiments, in step (a), a mixture of CH₄ and NH₃ with air and/or oxygen is combusted to produce an offgas additionally containing CO₂, CO and HCN as well as NO_{X} and N₂O.

In these cases, the first catalyst bed preferably assumes the additional function of catalytic cracking of HCN by hydrolysis with water present in the offgas to give the CO and NH₃ products as follows: HCN+H₂O↔CO+NH₃. The CO and NH₃ products formed can then, with regard to NH₃, preferably be utilized for NO_{X} reduction in the first catalyst bed, and, with regard to CO, preferably for N₂O reduction in the second catalyst bed as reducing agent for the elimination of N₂O and NO_{X} in the offgas.

The content of HCN in the offgas, as a pollutant and greenhouse gas, has to be limited or eliminated owing to its toxicity and longevity in the atmosphere and its absorption in the infrared. The fact that when HCN is broken down in accordance with the invention over zeolite catalysts in the first catalyst bed with CO and NH₃, cracking products are formed that are suitable as reducing agents for the further offgas aftertreatment of NO_{X} and N₂O in the second catalyst bed completes the singularity of the inventive offgas treatment over zeolite catalysts. Conventional SCR catalysts based on vanadium oxide show virtually no activity for HCN hydrolysis and are therefore unsuitable for elimination of HCN from offgases. In this case, a downstream oxidation catalyst would have to be used.

DeN₂O-deNO_{X}.

In further preferred embodiments, the offgas treatment system comprises a first reaction zone and a second reaction zone beyond, through which the offgas passes successively;
wherein reducing agent is added to the offgas between the first reaction zone and the second reaction zone;
wherein, in the first reaction zone, the N₂O content in the offgas is first reduced by decomposition of N₂O over an N₂O decomposition catalyst (step (c₁)) (deN₂O stage); and
wherein, in the second reaction zone, the NO_{X} content in the offgas is then reduced by chemical reduction of NO_{X} with reducing agent over an NO_{X} reduction catalyst (step (d)) (deNO_{X} stage); wherein the N₂O content in the offgas is optionally additionally further reduced by further decomposition of N₂O over an N₂O decomposition catalyst (step (c₁)) and/or by chemical reduction of N₂O with reducing agent over an N₂O reduction catalyst (step (c₂)), or the apparatus of the invention is configured correspondingly.

Preferably, no reducing agent is added to the offgas upstream of the first reaction zone, or the apparatus of the invention is configured correspondingly.

Such a process regime is particularly preferred in accordance with the invention. This makes it possible first to adjust the relative content of NO_{X} and N₂O without consumption of reducing agents. While the absolute NO_{X} content in the first reaction zone remains virtually unchanged, the N₂O content in the offgas is selectively reduced by decomposition. This can be effected to an extent as required to establish the desired relative content of NO_{X} and N₂O. For economic reasons, the chosen amount of the N₂O decomposition catalyst is preferably not so great as to achieve quantitatively complete reduction of the N₂O content in the offgas by decomposition (0 ppmv); instead, a compromise is found between breakdown rate and dimensions of the N₂O decomposition catalyst.

In preferred embodiments, the N₂O decomposition catalyst in the first reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.

In other preferred embodiments, the N₂O decomposition catalyst in the first reaction zone comprises an NO_{X}-sensitive N₂O decomposition catalyst within the context of the invention, which has already been described above.

In preferred embodiments, the NO_{X} reduction catalyst in the second reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.

Preferably, the first reaction zone and the second reaction zone are operated at different temperature levels, or the apparatus of the invention is configured correspondingly.

Preferably,
the N₂O decomposition catalyst in the first reaction zone comprises an NO_{X}-sensitive N₂O decomposition catalyst; wherein the offgas temperature in the first reaction zone is preferably at least 450° C., more preferably at least 500° C., even more preferably at least 550° C., most preferably at least 600° C., or the apparatus of the invention is configured correspondingly; and
the NO_{X} reduction catalyst in the second reaction zone is a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type; where the offgas temperature in the second reaction zone is preferably not more than 550° C., more preferably not more than 500° C., even more preferably not more than 450° C., most preferably not more than 400° C.; and wherein, in addition to the chemical reduction of NO_{X}, the (residual) N₂O content is preferably further reduced in the second reaction zone by decomposition and/or chemical reduction, or the apparatus of the invention is configured correspondingly.

Preferably, in the first reaction zone, the space velocity is set in such a way that the N₂O content in the offgas is reduced in the first reaction zone by at most 95%, preferably by at most 90%, more preferably by at most 85%, based on the N₂O content in the offgas on entry into the first reaction zone, or the apparatus of the invention is configured correspondingly.

In preferred embodiments, the N₂O content in the offgas after leaving the first reaction zone and before entering the second reaction zone is at least 20 ppmv, more preferably at least 40 ppmv, even more preferably at least 60 ppmv, most preferably at least 80 ppmv and in particular at least 100 ppmv, or the apparatus of the invention is configured correspondingly.

In preferred embodiments, the N₂O content in the offgas after leaving the first reaction zone and before entering the second reaction zone is at most 400 ppmv, more preferably at most 300 ppmv, even more preferably at most 200 ppmv, most preferably at most 100 ppmv and in particular at most 50 ppmv, or the apparatus of the invention is configured correspondingly.

Preferably, in the second reaction zone, the space velocity is set in such a way that the N₂O content in the offgas is reduced further in the second reaction zone by at least 30%, preferably by at least 40%, more preferably by at least 50%, based on the N₂O content in the offgas on entry into the second reaction zone, or the apparatus of the invention is configured correspondingly. Since reducing agent is present in the second reaction zone, further reduction of the N₂O content in the second reaction zone can be achieved both by decomposition over an N₂O decomposition catalyst (step (c₁)) and by chemical reduction with reducing agent over an N₂O reduction catalyst (step (c₂)), or the apparatus of the invention is configured correspondingly.

Preferably, in the second reaction zone, the N₂O content in the offgas is further reduced by chemical reduction of N₂O with reducing agent over an N₂O reduction catalyst (step (c₂)), or the apparatus of the invention is configured correspondingly.

In addition, the NO_{X} content is reduced in the second reaction zone by chemical reduction with reducing agent over an NO_{X} reduction catalyst, or the apparatus of the invention is configured correspondingly. This reduction typically has fast kinetics and preferably proceeds virtually quantitatively in accordance with the invention.

### Closed-Loop Control

Regardless of the respective process regime, the method of the invention is preferably under closed-loop control, or the apparatus of the invention is configured correspondingly.

In preferred embodiments, depending on the mode of construction of the internal combustion engine, a first measured variable used for closed-loop control of the method of the invention is at least one parameter which is characteristic of the current state of operation of the internal combustion engine, or the apparatus of the invention is configured correspondingly. Preferably, this first measured variable or the parameter is selected from the group consisting of combustion temperature, NH₃ consumption, speed of rotation, and noise emitted by the internal combustion engine.

Depending on the characteristics of the offgas leaving the internal combustion engine, in particular
NO_{X} content in the offgas;
degree of oxidation of NO_{X} in the offgas;
N₂O content in the offgas;
content of other constituents in the offgas, for example H₂O, O₂, and N₂;
offgas temperature;
offgas pressure; and
offgas volume flow rate;
   the method conditions can be optimized in order to achieve an efficient and economically viable reduction of the content of NO_{X} and N₂O in the offgas, or the apparatus of the invention is configured correspondingly.

In preferred embodiments, therefore, a second measured variable measured for closed-loop control of the method of the invention is at least one parameter characteristic of the current state of the offgas prior to entry into the offgas treatment system, which is measured on departure from the internal combustion engine and/or on entry into the offgas treatment system, either in addition to the first measured variable or instead of the first measured variable, or the apparatus of the invention is configured correspondingly. Preferably, this second measured variable or parameter is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas, or the apparatus of the invention is configured correspondingly.

In preferred embodiments, a third measured variable measured for closed-loop control of the method of the invention is at least one parameter characteristic of the current state of the offgas at the outlet of the offgas treatment system, which is measured at the outlet of the offgas treatment system, either in addition to the first measured variable or instead of the first measured variable, and either in addition to the second measured variable or instead of the second measured variable, or the apparatus of the invention is configured correspondingly. Preferably, this third measured variable or parameter is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas, or the apparatus of the invention is configured correspondingly.

In preferred embodiments, especially when the offgas treatment system comprises a first reaction zone and a second reaction zone through which the offgas passes successively, wherein reducing agent is fed in between the first reaction zone and the second reaction zone, for closed-loop control of the method of the invention, at least one parameter characteristic of the current state of the offgas after leaving the first reaction zone and before entering the second reaction zone, is measured at the outlet from the first reaction zone and before entry into the second reaction zone as a fourth measured variable, either in addition to the first measured variable or instead of the first measured variable, and either in addition to the second measured variable or instead of the second measured variable, and, either in addition to the third measured variable or instead of the third measured variable, or the apparatus of the invention is configured correspondingly. Preferably, this fourth measured variable or parameter is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas, or the apparatus of the invention is configured correspondingly.

Depending on the first measured variable and/or second measured variable and/or the third measured variable and/or the fourth measured variable, at least one manipulated variable is preferably modified for open-loop or closed-loop control of the method of the invention, or the apparatus of the invention is configured correspondingly. Preferably, therefore, the open-loop or closed-loop control of the method is based on the first measured variable and/or on the second measured variable and/or on the third measured variable and/or on the fourth measured variable by means of a controlled change in the manipulated variable (control variable), preferably by a controlled change in the amount of reducing agent metered in, or the apparatus of the invention is configured correspondingly.

In terms of preferred manipulated variables, a distinction is necessary between
conditions that can be changed at short notice only with a relatively high apparatus complexity, if at all, and
conditions that can be changed at short notice and are therefore of better suitability for closed-loop control.

Preferably in accordance with the invention,
the dimensions of the offgas treatment apparatus;
the nature, amount and flow direction of the N₂O decomposition catalyst and/or N₂O reduction catalyst;
the nature, amount and flow direction of the NO_{X} reduction catalyst;
the type of reducing agent;
the offgas pressure;
the feeding position of reducing agent; and
the relative arrangement of the first reaction zone and the second reaction zone are not manipulated variables, i.e. these parameters remain preferably constant during the performance of the method of the invention, or the apparatus of the invention is configured correspondingly.

However, these parameters may be chosen or adjusted in the planning and design of the offgas treatment system such that control is possible within wide limits. In this way, it is also possible to react to changes at short notice, for instance with regard to the offgas to be treated. An efficient and economically viable reduction of the content of NO_{X} and N₂O in the offgas is assured without unwanted breakthrough of reducing agent (called slippage).

Manipulated variables (control variables) that are preferred in accordance with the invention are:
the amount of reducing agent;
if appropriate the offgas temperature; and
if appropriate the temperature of the catalysts.

Preferably, the offgas leaving the offgas treatment system has a residual NO_{X} content of at most 20 ppmv, preferably at most 15 ppmv, more preferably at most 10 ppmv, even more preferably at most 7.5 ppmv, most preferably at most 5.0 ppmv, and in particular at most 2.5 ppmv, or the apparatus of the invention is configured correspondingly.

Preferably, the offgas leaving the offgas treatment system has a residual N₂O content of at most 20 ppmv, preferably at most 15 ppmv, more preferably at most 10 ppmv, even more preferably at most 7.5 ppmv, most preferably at most 5.0 ppmv, and in particular at most 2.5 ppmv, or the apparatus of the invention is configured correspondingly.

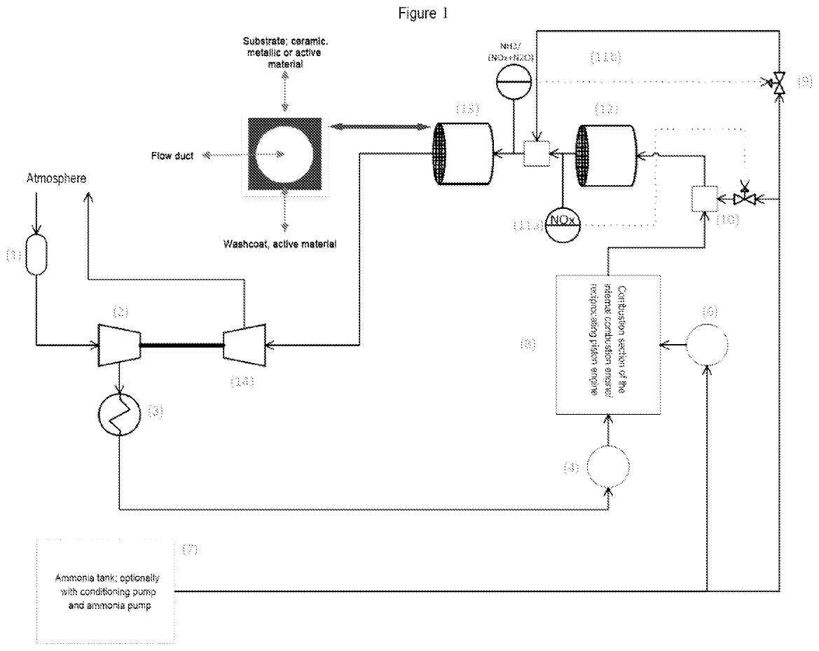

Preferred embodiments of the invention are illustrated schematically by FIGS. 1 to 5.

FIG. 1 shows a particularly preferred deN₂O-deNO_{X} variant with two catalyst beds without an additional NH₃ oxidation catalyst. The internal combustion engine comprises, for example, a turbocharged reciprocating piston engine, which, in the embodiment shown in the figure, is operated exclusively with ammonia as fuel (single fuel). Combustion air is supplied to the suction side of the turbo compressor (2) through an air manifold (1). Compressed air is directed to the cylinders of the reciprocating piston engine (8) via the air charge cooler (3) and the accumulator (4). Analogously, fuel from the ammonia tank (7) is supplied to the engine via the accumulator (6). Ammonia is combusted in the engine compartment, and the offgas flows into the offgas duct to the exhaust gas aftertreatment system essentially at the pressure built up by the offgas turbine (14).

The offgas treatment system comprises two spatially separate catalyst beds (12 and 13), preferably each containing an “Fe zeolite catalyst”.

In the first catalyst bed (12) (upstream of the second catalyst bed), NO_{X} is reduced and N₂O is decomposed catalytically, cocatalyzed by the (residual) NO_{X} content present in the offgas.

NO_{X} is reduced by the NH₃ present in the offgas (originating from incomplete combustion of NH₃ in the firing system or combustion device) and optionally NH₃ additionally added via the metering device (10), as far as a maximum of a defined residual NO_{X} value (sufficient to bring about a cocatalytic effect on a decomposition of N₂O that likewise takes place in the first bed). The addition of NH₃ to the NO_{X} reduction is under closed-loop control here by what is called a feedback control method (11a). This means that a particular value for the NO_{X} exit concentration is defined as the target value (setpoint) and the actual exit concentration of NO_{X} is measured downstream of the first bed (actual value). In the event of a difference between setpoint and actual value (control difference), the degree of actuation of an appropriate NH₃ metering valve (actuator) is adjusted in order to minimize the difference. In the case, owing to incomplete combustion, of relatively high residual ammonia concentrations in the offgas flowing out of the reciprocating piston engine (8) and toward the 1st catalyst bed (12), the offgas metering device (10) may close completely. In borderline cases of engine design (in the corresponding order of magnitude of incomplete combustion at all relevant engine operating points), it may even be obsolete and then be omitted.

In the second catalyst bed (13) (downstream of the first catalyst bed), (i) further, preferably virtually complete reduction of the residual NO_{X} concentration (originating from the first catalyst bed) is effected by further addition of NH₃ (metering device (9)), and the NO_{X} is preferably broken down to a residual concentration of <20 ppmv, preferably <10 ppmv, more preferably <5 ppmv, even more preferably <2 ppmv. In addition, further, likewise preferably virtually complete breakdown of N₂O is effected in the second catalyst bed by chemical reduction of the N₂O with NH₃ (this proceeds in parallel or preferably after complete reduction of NO_{X}), where N₂O is preferably broken down to a residual concentration of <20 ppmv, preferably <10 ppmv, more preferably <5 ppmv, even more preferably <2 ppmv.

Preferably, the further NH₃ is metered in with the second apparatus under feed-forward control, i.e. the concentrations of NO_{X} and optionally preferably of N₂O and optionally preferably of NH₃ are each measured on departure from the first catalyst bed or optionally on entry into the second catalyst bed; the amount of offgas entering the second catalyst bed is taken into account to calculate the amount of NH₃ required for NO_{X} reduction and optionally preferably the sum total of the amount required for NO_{X} reduction and for N₂O reduction with the aid of stored molar ratios (mol/mol) of NH₃/NO_{X} and optionally preferably of NH₃/N₂O or factors derived therefrom; and the calculated result (manipulated variable) is used to alter the output of the second control valve in order to meter in the required amount of NH₃.

Preferably in accordance with the invention, the molar NH₃ concentration [NH₃] of the offgas on entry into the second catalyst bed is in the range from the sum of 0.7×[N₂O] and 1.0×[NO_{X}] to the sum of 4.0×[N₂O] and 2.0×[NO_{X}], more preferably in the range from the sum of 1.0×[N₂O] and 1.1×[NO_{X}] to the sum of 3.0×[N₂O] and 1.6×[NO_{X}], even more preferably in the range from the sum of 1.5×[N₂O] and 1.2×[NO_{X}] to the sum of 2.5×[N₂O] and 1.4×[NO_{X}], where [N₂O] is the molar concentration of N₂O and [NO_{X}] is the molar concentration of NO_{X}, each in the offgas on entry into the second catalyst bed.

Preferably, for the feed-forward control of the metered addition of NH₃ into the second catalyst bed with regard to the NO_{X} reduction, a molar ratio of NH₃/NO_{X} in the range from 1.0 to 2.0; preferably 1.1 to 1.6; more preferably 1.2 to 1.4 is chosen.

Preferably, for the feed-forward control of the metered addition of NH₃ into the second catalyst bed with regard to the N₂O reduction, a molar ratio of NH₃/N₂O in the range from 0.7 to 4.0; preferably 1.0 to 3.0; more preferably 1.5 to 2.5 is chosen.

Customary feedback control of the addition of NH₃ as in the first catalyst bed is not preferred in accordance with the invention in the second catalyst bed since the aim is complete NO_{X} reduction in the second catalyst bed and hence the result is only very small or zero residual concentrations of NO_{X} and N₂O, which would be of very limited utility as reference variables for closed-loop control purposes.

The amount of NH₃ added to the first catalyst bed is preferably selected in accordance with the invention such that the NO_{X} concentration at the outlet of the first catalyst bed is <1000 ppmv, preferably <500 ppmv, in particular <100 ppmv. According to the invention, the minimum NO_{X} concentration at the outlet of the first catalyst bed should preferably be >10 ppmv, preferably >20 ppmv, more preferably >40 ppmv. The expected specific NH₃ consumption for NO_{X} reduction in the first catalyst bed in the mode of operation of the invention is 0.9-1.1 mol of NH₃ per mole of NO_{X} reduced and is thus significantly smaller than the expected specific NH₃ consumption in the second catalyst bed.

In the preferred form of the invention shown here, no further NH₃ oxidation catalysts are used except for oxidation-active Fe (Cu) zeolite catalysts. The mode of operation of the internal combustion engine (8), which is preferably a reciprocating piston engine for marine propulsion, is therefore configured at the main operating point such that the offgas flowing out of the internal combustion engine (8) has a maximum of such residual NH₃ concentrations that the abovementioned molar ratios of NH₃/NO_{X} and NH₃/N₂O can be established. In addition to the preferred lean mode of operation of the combustion, further internal engine measures are conceivable for this purpose, for example advantageous closed-loop control of the charge air cooling (3).

The amount of catalyst, i.e. the space velocity (=ratio of offgas volume flow rate under standard conditions to catalyst volume) of the first catalyst bed is chosen so as to result in N₂O decomposition therein of preferably >50%, more preferably >70% and most preferably >80%.

In particular, the space velocity of the first catalyst bed and the added amount of NH₃ is chosen so as to result in a molar ratio of NO_{X}/N₂O of >5, preferably of >10, in particular of >20, at the outlet of the first catalyst bed.

Preferably, the space velocity of the first catalyst bed is 5000 h⁻¹ to 100 000 h⁻¹, in particular 10 000 h⁻¹-50 000 h⁻¹, most preferably 15 000 h⁻¹ to 45 000 h⁻¹.

If the ratio of NO_{X}/N₂O at the outlet of the first catalyst bed is >10, in a preferred embodiment, the complete addition of the NH₃ to the second catalyst bed can be effected solely in relation to the amount of incoming amount of NO_{X}.

According to the invention, the offgas temperature on entry into the first catalyst bed (via the mode of operation of the internal combustion engine and/or additional cooling/heating measures) is preferably reduced to a value greater than 300° C., preferably greater than 400° C., in particular greater than 450° C., and at the same time less than 550° C., preferably less than 525° C. and in particular less than 500° C.

Depending on the exothermicity of the chemical reactions that proceed in the catalyst beds, the inlet temperature of the offgas into the first catalyst bed is chosen such that the temperature of the offgas on departure from the second catalyst bed does not exceed a value of 600° C., preferably of 550° C., in particular of 520° C.

The space velocity of the second catalyst bed is preferably 5000 h⁻¹ to 100 000 h⁻¹, in particular 10 000 h⁻¹-50 000 h⁻¹, most preferably 15 000 h⁻¹ to 45 000 h⁻¹.

The ratio of the catalyst volumes from the first to the second catalyst bed (V1_{cat}/V2_{cat}) is preferably ½ to 20/1, more preferably ½ to 10/1, most preferably 1/1 to 4/1.

The above-described method using Fe zeolite catalysts, by comparison with conventional deNO_{X} methods using V₂O₅/TiO₂ catalysts, enables
complete or almost complete breakdown of large amounts of NO_{X} without the risk of NH₃ slip,
simultaneous, complete or almost complete degradation of N₂O present in the offgas; or where this can be done within the specified limits with minimum possible supply of additional ammonia; i.e. the proportion of the N₂O decomposition reaction can also be maximized,
and all the above with relatively low catalyst volumes, i.e. at relatively high space velocities.

Aside from the above-described operating method of the invention, this is achieved by the oxidative properties of the Fe zeolite catalysts used in accordance with the invention. Thus, in the first catalyst bed, the molar ratio of NO to NO₂, according to the invention, is brought as close as possible to the thermodynamic equilibrium position. For instance, the degree of oxidation of NO_{X} (molar ratio of NO₂/(NO+NO₂)) prior to entry into the first catalyst bed (because of the upstream NH₃ combustion at very high temperatures and the only slow establishment of the equilibrium in the gas phase when the offgas is cooled) is <5% as expected, and hence well below the thermodynamic equilibrium applicable to the inlet temperature into the first catalyst bed. However, this is very disadvantageous for efficient of NO_{X} reduction since, as a result, only a small portion of the NO_{X} present in the offgas can proceed by a fast SCR and a majority of the NO_{X} or of the remaining NO has to proceed by distinctly slower normal SCR.

The chosen mode of operation of the limited metered addition of NH₃ in the first catalyst bed and the ability of the Fe zeolite catalysts to oxidize NO or to catalytically accelerate the establishment of equilibrium results in achievement of a distinctly faster, i.e. more efficient, NO_{X} reduction in the first catalyst bed, and at the same time establishment of the maximum possible degree of oxidation of NO_{X} in the remaining NO_{X}. This enables efficient NO_{X} reduction in the second catalyst bed too from the very start.

It has thus been found that large amounts of NH₃, as needed for complete reduction of high concentrations of NO_{X}, similarly to water, inhibit the establishment of the NO_{X} equilibrium on the Fe zeolite catalyst.

In addition, NO_{X} reduction as such is also inhibited by NH₃ itself at correspondingly high doses of NH₃. As a result, depending on temperature, amount of catalyst and NO_{X} content, no further increase in NO_{X} degradation occurs with increasing addition of NH₃ from a certain amount of NH₃ onwards. In the case of a further increase in the addition of NH₃, it is then even possible under some circumstances that a decline in NO_{X} degradation will be observed with a simultaneous NH₃ slip.

Prereduction of the NO_{X} in the first catalyst bed distinctly reduces the amount of NH₃ needed for NO_{X} reduction in the second bed.

In this way, together with the above-described establishment or permanent readjustment of the NO_{X} equilibrium, very efficient NO_{X} reduction is also possible in the second bed, even with the superstoichiometric metered addition of NH₃ in accordance with the invention.

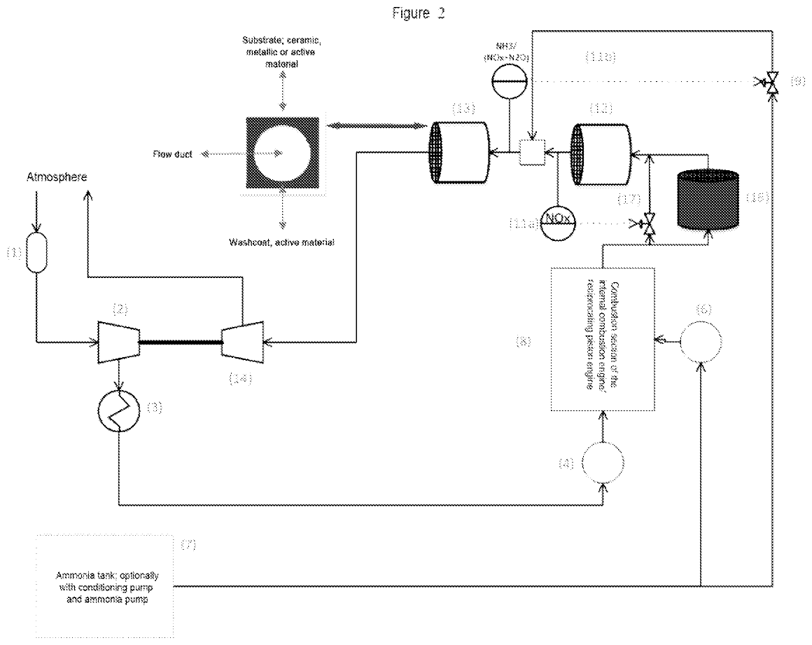

FIG. 2 shows a particularly preferred deN₂O-deNO_{X} variant with two catalyst beds and an additional NH₃ oxidation catalyst in an upstream separate 3rd reaction zone, and a bypass around the upstream oxidation catalyst.

In the preferred form of the invention shown here, in addition to the oxidation-active Fe (Cu) zeolite catalysts, a further ammonia oxidation catalyst (16) which is free of Pt group metals and more preferably free of precious metals is used. Such a variant is preferred when the mode of operation of the internal combustion engine (8) (preferably a reciprocating piston engine for ship propulsion) is not configurable such that the above-cited advantageous molar ratios of NH₃/NO_{X} and NH₃/N₂O in the relevant states of operation can be established.

If, on the contrary, higher stoichiometric ammonia excesses already emerge from the internal combustion engine in relevant states of operation and it is not possible to rule out an inhibitory effect on the first deN₂O-deNO_{X} reaction zone in relevant states of operation, an upstream oxidation catalyst (16) which is free of Pt group metals and more preferably free of precious metals, optionally with a bypass (17) controllable by closed-loop control, may be employed:

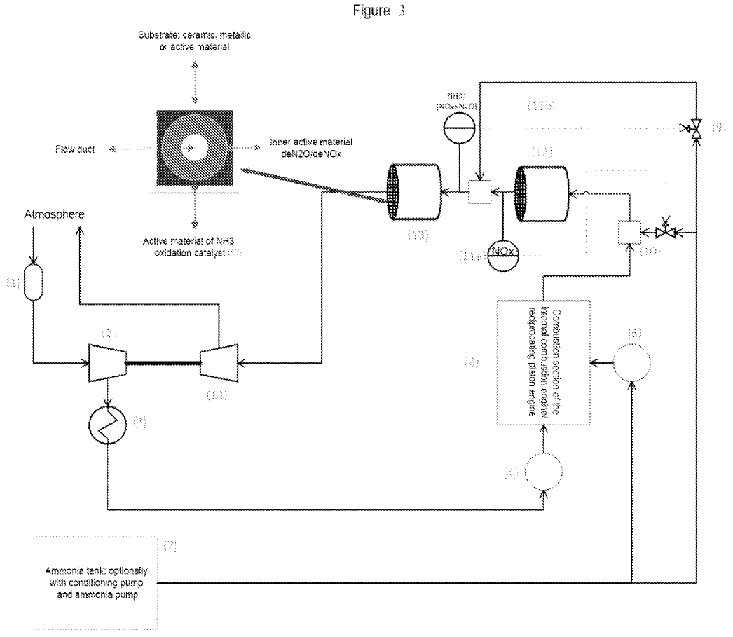

FIG. 3 shows a particularly preferred deN₂O-deNO_{X} variant with two catalyst beds and an additional NH₃ oxidation catalyst in layer configuration, integrated into the second zone (the second catalyst bed) of the deN₂O-deNO_{X} system.

Such a variant is preferred when the mode of operation of the internal combustion engine (8) (preferably a reciprocating piston engine for ship propulsion) is not configurable such that the above-cited advantageous molar ratios of NH₃/NO_{X} and NH₃/N₂O NO_{X} in the relevant states of operation can be established, although any inhibiting effect resulting from high ammonia concentrations on the first deN₂O-deNO_{X} reaction zone in relevant states of operation can be ruled out or is negligibly low.

Integration of the NH₃ oxidation catalyst which is free of Pt group metals, more preferably free of precious metals, ultimately has the effect of broadening of the preferred ratios of NH₃/NO_{X} and NH₃/N₂O on entry into the second catalyst bed.

If the NH₃ oxidation catalyst which is free of Pt group metals, more preferably free of precious metals, is to constitute or be integrated into the last reaction zone (the second catalyst bed) for the purpose of better ammonia exploitation, implementation in layer configuration is preferred since it is possible to achieve a better selectivity overall in the oxidation of excess ammonia to nitrogen (rather than NO_{X} and N₂O).

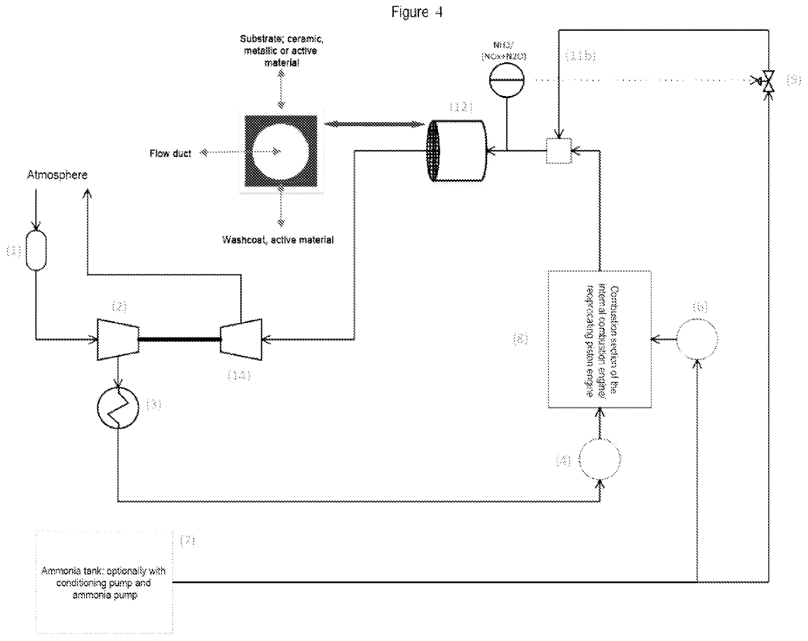

FIG. 4 shows a variant with a catalyst bed without an NH₃ oxidation catalyst.

The internal combustion engine comprises, for example, a turbocharged reciprocating piston engine, which, in the embodiment shown in the figure, is operated exclusively with ammonia as fuel (single fuel):

Combustion air is supplied to the suction side of the turbo compressor (2) through an air manifold (1). Compressed air is directed to the cylinders of the reciprocating piston engine (8) via the air charge cooler (3) and the accumulator (4). Analogously, fuel from the ammonia tank (7) is supplied to the engine via the accumulator (6). Ammonia is combusted in the engine compartment, and the offgas flows into the offgas duct to the exhaust gas aftertreatment system at the pressure built up by the offgas turbine (14).

The offgas treatment system comprises a single catalyst bed (12), preferably containing a Fe zeolite catalyst.

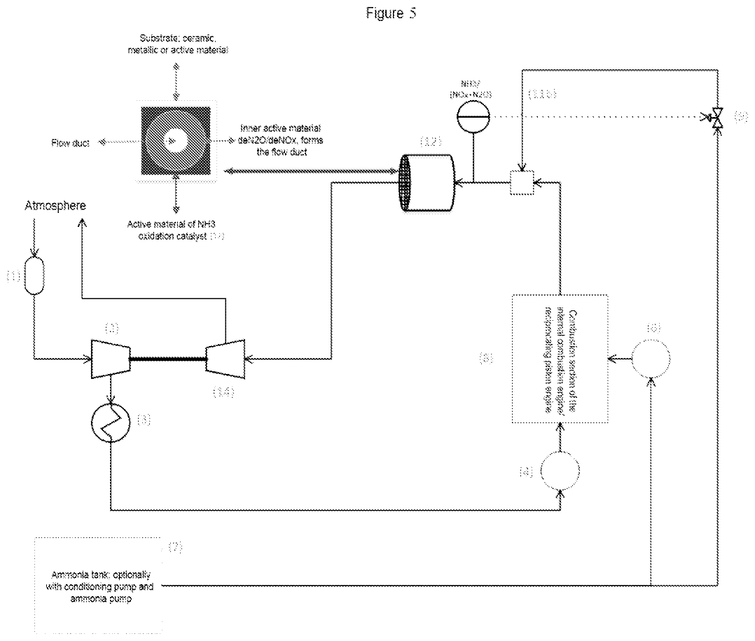

FIG. 5 shows a variant with a catalyst bed containing an additional NH₃ oxidation catalyst which is free of Pt group metals, preferably free of precious metals.

The internal combustion engine comprises, for example, a turbocharged reciprocating piston engine, which, in the embodiment shown in the figure, is operated exclusively with ammonia as fuel (single fuel). Combustion air is supplied to the suction side of the turbo compressor (2) through an air manifold (1). Compressed air is directed to the cylinders of the reciprocating piston engine (8) via the air charge cooler (3) and the accumulator (4). Analogously, fuel from the ammonia tank (7) is supplied to the engine via the accumulator (6). Ammonia is combusted in the engine compartment, and the offgas flows into the offgas duct to the exhaust gas aftertreatment system at the pressure built up by the offgas turbine (14).

The offgas treatment system comprises a single catalyst bed (12), preferably containing a Fe zeolite catalyst, and a Pt metal group-free NH₃ oxidation catalyst, arranged in layer configuration, where it is preferably the deNO_{X}-deN₂O catalyst that forms the flow channel.

Particularly preferred embodiments of the invention are collated below as sentences:
Sentence 1: A method of reducing the content of NO_{X} and N₂O in the offgas of an NH₃-operated internal combustion engine, wherein the method comprises the following steps: (a) combusting NH₃ to drive the internal combustion engine, producing an offgas which comprises N₂, H₂O, NO_{X} and N₂O and which leaves the internal combustion engine; (b) transferring the offgas to an offgas treatment system; (c) reducing the N₂O content in the offgas by (c₁) decomposing N₂O over an N₂O decomposition catalyst and/or (c₂) chemically reducing N₂O with reducing agent over an N₂O reduction catalyst; and (d) reducing the NO_{X} content in the offgas by chemical reduction of NO_{X} with reducing agent over an NO_{X} reduction catalyst.
Sentence 2: The method according to sentence 1, wherein the N₂O decomposition catalyst and/or the N₂O reduction catalyst and/or the NO_{X} reduction catalyst independently comprise a zeolitic material; preferably a zeolite laden with transition metal (including lanthanide), in particular with iron, cobalt or copper; more preferably an iron- or copper-laden zeolite; even more preferably independently an iron- or copper-laden zeolite of the MFI, BEA, FER, MOR, FAU, AEI and/or MEL structure type.
Sentence 3: The method according to sentence 1 or 2, wherein the N₂O decomposition catalyst and the N₂O reduction catalyst are made from the same material.
Sentence 4: The method according to any of the preceding sentences, wherein the N₂O decomposition catalyst and the NO_{X} reduction catalyst are made from the same material.
Sentence 5: The method according to any of the preceding sentences, wherein the N₂O reduction catalyst and the NO_{X} reduction catalyst are made from the same material.
Sentence 6: The method according to any of the preceding sentences, wherein the N₂O decomposition catalyst, the N₂O reduction catalyst and the NO_{X} reduction catalyst are made from the same material.
Sentence 7: The method according to any of the preceding sentences, wherein the combustion of NH₃ in step (a) is not over a catalyst.
Sentence 8: The method according to any of the preceding sentences, wherein NH₃ is combusted in step (a) in a mixture with a further combustible gas; preferably wherein the further combustible gas is selected from (i) H₂; (ii) fossil fuels; preferably hydrocarbons and hydrocarbon mixtures, more preferably methane, ethane, propane, butane, natural gas, petrol and/or diesel; (iii) alcohols, preferably methanol and/or ethanol; and mixtures thereof.
Sentence 9: The method according to any of the preceding sentences, wherein NH₃ is combusted in step (a) in a mixture with H₂.
Sentence 10: The method according to sentence 9, wherein step (a) comprises the following component steps: (a₁) thermal and/or catalytic cracking of NH₃ to produce a cracking gas comprising N₂, H₂ and optionally residual NH₃; (a₂) optionally mixing of cracking gas with further NH₃ to produce a mixture comprising H₂ and NH₃; (a₃) combusting the cracking gas or mixture.
Sentence 11: The method according to sentence 9 or 10, wherein the proportion of H₂ in the mixture with NH₃ is at most 80 mol %, more preferably at most 70 mol %, even more preferably at most 60 mol %, most preferably at most 50 mol %, and in particular at most 40 mol %.
Sentence 12: The method according to any of sentences 9 to 11, wherein the proportion of H₂ in the mixture with NH₃ is at least 10 mol %, more preferably at least 20 mol %, even more preferably at least 30 mol %, most preferably at least 40 mol %, and in particular at least 50 mol %.
Sentence 13: The method according to any of sentences 9 to 12, wherein the molar ratio of H₂:NH₃ in the mixture is in the range from 45:55 to 90:10, preferably 50:50 to 85:15, more preferably 55:45 to 80:20, even more preferably 60:40 to 75:25, most preferably 65:35 to 70:30.
Sentence 14: The method according to any of sentences 9 to 13, wherein the air ratio λ is in the range from 0.9 to 1.7, more preferably 1.0 to 1.6, even more preferably 1.1 to 1.5, most preferably 1.2 to 1.4.
Sentence 15: The method according to any of sentences 1 to 7, wherein NH₃ is combusted alone in step (a), and so NH₃ is the only combustible gas that is combusted.
Sentence 16: The method according to any of the preceding sentences, wherein the internal combustion engine is mounted in a vehicle and is used to move the vehicle.
Sentence 17: The method according to sentence 16, where the vehicle is a ship.
Sentence 18: The method according to any of the preceding sentences, wherein the offgas has an NO_{X} content greater than the N₂O content; preferably wherein the NO_{X} content is at least twice as high, more preferably at least three times as high, even more preferably at least four times as high, most preferably at least seven times as high and in particular at least ten times as high as the N₂O content; preferably wherein the molar ratio of NO_{X}:N₂O is more than 10:1, more preferably at least 20:1, even more preferably at least 30:1, most preferably at least 40:1, and in particular at least 50:1.
Sentence 19: The method according to any of the preceding sentences, wherein the offgas has an NO content greater than the N₂O content; preferably wherein the NO content is at least twice as high, more preferably at least three times as high, even more preferably at least four times as high, most preferably at least seven times as high and in particular at least ten times as high as the N₂O content.
Sentence 20: The method according to any of the preceding sentences, wherein the offgas has an NO₂ content greater than the N₂O content; preferably wherein the NO₂ content is at least twice as high, more preferably at least three times as high, even more preferably at least four times as high, most preferably at least seven times as high and in particular at least ten times as high as the N₂O content.
Sentence 21: The method according to any of the preceding sentences, wherein the offgas has an N₂O content greater than the NO_{X} content; preferably wherein the N₂O content is at least twice as high, more preferably at least three times as high, even more preferably at least four times as high, most preferably at least seven times as high and in particular at least ten times as high as the NO_{X} content.
Sentence 22: The method according to any of the preceding sentences, wherein the offgas has an N₂O content greater than the NO content; preferably wherein the N₂O content is at least twice as high, more preferably at least three times as high, even more preferably at least four times as high, most preferably at least seven times as high and in particular at least ten times as high as the NO content.
Sentence 23: The method according to any of the preceding sentences, wherein the offgas has an N₂O content greater than the NO₂ content; preferably wherein the N₂O content is at least twice as high, more preferably at least three times as high, even more preferably at least four times as high, most preferably at least seven times as high and in particular at least ten times as high as the NO₂ content.
Sentence 24: The method according to any of the preceding sentences, wherein the offgas has an NO_{X} content of at least 10 ppmv, preferably at least 20 ppmv, more preferably at least 30 ppmv, even more preferably at least 40 ppmv, and in particular at least 50 ppmv.
Sentence 25: The method according to any of the preceding sentences, wherein the offgas has an NO_{X} content of at least 75 ppmv, preferably at least 100 ppmv, more preferably at least 150 ppmv, even more preferably at least 200 ppmv, and in particular at least 250 ppmv.
Sentence 26: The method according to any of the preceding sentences, wherein the offgas has an NO_{X} content of at least 500 ppmv, preferably at least 1000 ppmv, more preferably at least 2000 ppmv, even more preferably at least 3000 ppmv, and in particular at least 3500 ppmv.
Sentence 27: The method according to any of the preceding sentences, wherein the offgas has an N₂O content of at least 10 ppmv, preferably at least 20 ppmv, more preferably at least 30 ppmv, even more preferably at least 40 ppmv, and in particular at least 50 ppmv.
Sentence 28: The method according to any of the preceding sentences, wherein the offgas has an N₂O content of at least 75 ppmv, preferably at least 100 ppmv, more preferably at least 150 ppmv, even more preferably at least 200 ppmv, and in particular at least 250 ppmv.
Sentence 29: The method according to any of the preceding sentences, wherein the offgas has an N₂O content of at least 500 ppmv, preferably at least 1000 ppmv, more preferably at least 2000 ppmv, even more preferably at least 3000 ppmv, and in particular at least 3500 ppmv.
Sentence 30: The method according to any of the preceding sentences, wherein the offgas has an H₂O content of less than 2.0% by volume.
Sentence 31: The method according to any of the preceding sentences, wherein the offgas has an H₂O content of more than 4.0% by volume; preferably at least 5.0% by volume, more preferably at least 6.0% by volume, even more preferably at least 7.0% by volume, most preferably at least 8.0% by volume, and in particular at least 9.0% by volume.
Sentence 32: The method according to any of the preceding sentences, wherein the offgas has an H₂O content of at least 10% by volume; preferably at least 12% by volume, more preferably at least 14% by volume, even more preferably at least 16% by volume, most preferably at least 18% by volume, and in particular at least 20% by volume.
Sentence 33: The method according to any of the preceding sentences, wherein the offgas has an H₂O content in the region of 10±8% by volume; preferably in the region of 10±7% by volume, more preferably in the region of 10±6% by volume, even more preferably in the region of 10±5% by volume, most preferably in the region of 10±4% by volume, and especially in the region of 10±3% by volume.
Sentence 34: The method according to any of the preceding sentences, wherein the offgas has an H₂O content in the region of 15±8% by volume; preferably in the region of 15±7% by volume, more preferably in the region of 15±6% by volume, even more preferably in the region of 15±5% by volume, most preferably in the region of 15±4% by volume, and especially in the region of 15±3% by volume.
Sentence 35: The method according to any of the preceding sentences, wherein the offgas has an H₂O content in the region of 20±8% by volume; preferably in the region of 20±7% by volume, more preferably in the region of 20±6% by volume, even more preferably in the region of 20±5% by volume, most preferably in the region of 20±4% by volume, and especially in the region of 20±3% by volume.
Sentence 36: The method according to any of the preceding sentences, wherein the offgas has an H₂O content in the region of 25±8% by volume; preferably in the region of 25±7% by volume, more preferably in the region of 25±6% by volume, even more preferably in the region of 25±5% by volume, most preferably in the region of 25±4% by volume, and especially in the region of 25±3% by volume.
Sentence 37: The method according to any of the preceding sentences, wherein the offgas has an H₂O content in the region of 30±8% by volume; preferably in the region of 30±7% by volume, more preferably in the region of 30±6% by volume, even more preferably in the region of 30±5% by volume, most preferably in the region of 30±4% by volume, and especially in the region of 30±3% by volume.
Sentence 38: The method according to any of the preceding sentences, wherein the offgas has a content of N₂ of at most 95% by volume, preferably at most 90% by volume, more preferably at most 85% by volume, even more preferably at most 80% by volume, most preferably at most 75% by volume, and in particular at most 70% by volume.
Sentence 39: The method according to any of the preceding sentences, wherein the offgas has an N₂ content of at least 40% by volume; preferably at least 50% by volume, more preferably at least 60% by volume, even more preferably at least 70% by volume, most preferably at least 80% by volume, and in particular at least 90% by volume.
Sentence 40: The method according to any of the preceding sentences, wherein the offgas comprises further gaseous constituents; preferably selected from the group consisting of O₂, CO, CO₂, NH₃, CH₄ and mixtures thereof.
Sentence 41: The method according to any of the preceding sentences, wherein the offgas when leaving the internal combustion engine is at a temperature of at least 500° C., more preferably at least 600° C., even more preferably at least 700° C., most preferably at least 800° C., and in particular at least 900° C.
Sentence 42: The method according to any of the preceding sentences, wherein the offgas when leaving the internal combustion engine is at a temperature of at most 1100° C., more preferably at most 1000° C., even more preferably at most 900° C., most preferably at most 800° C., and in particular at most 700° C.
Sentence 43: The method according to any of the preceding sentences, wherein the offgas when leaving the internal combustion engine is at a pressure of at most 1.5 bar; preferably atmospheric pressure.
Sentence 44: The method according to any of the preceding sentences, wherein the offgas when leaving the internal combustion engine has a degree of oxidation of NO_{X} of at least 10%, more preferably at least 20%, even more preferably at least 30%, most preferably at least 40%, and in particular at least 50%.
Sentence 45: The method according to any of the preceding sentences, wherein the offgas when leaving the internal combustion engine has a degree of oxidation of NO_{X} of at most 90%, more preferably at most 80%, even more preferably at most 70%, most preferably at most 60%, and in particular at most 50%.
Sentence 46: The method according to any of the preceding sentences, wherein the offgas when leaving the internal combustion engine has an O₂ content of less than 2.0% by volume.
Sentence 47: The method according to any of sentences 1 to 28, wherein the offgas when leaving the internal combustion engine has an O₂ content of more than 4.0% by volume.
Sentence 48: The method according to any of the preceding sentences, wherein the offgas on entry into the offgas treatment system is at a temperature of at least 300° C., more preferably at least 350° C., even more preferably at least 400° C., most preferably at least 425° C., and in particular at least 450° C.
Sentence 49: The method according to any of the preceding sentences, wherein the offgas on entry into the offgas treatment system is at a temperature of at least 500° C., more preferably at least 550° C., even more preferably at least 600° C., most preferably at least 625° C., and in particular at least 650° C.
Sentence 50: The method according to any of the preceding sentences, wherein the offgas on entry into the offgas treatment system is at a temperature of at most 825° C., more preferably at most 800° C., even more preferably at most 775° C., most preferably at most 750° C., and in particular at most 725° C.
Sentence 51: The method according to any of the preceding sentences, wherein the offgas on entry into the offgas treatment system is at a temperature of at most 700° C., more preferably at most 650° C., even more preferably at most 600° C., most preferably at most 550° C., and in particular at most 500° C.
Sentence 52: The method according to any of the preceding sentences, wherein the offgas on entry into the offgas treatment system is at a temperature which, in relative terms, is at least 20° C., preferably at least 40° C., more preferably at least 60° C., even more preferably at least 80° C., most preferably at least 100° C., and in particular at least 120° C., below the temperature of the offgas when leaving the internal combustion engine.
Sentence 53: The method according to any of the preceding sentences, wherein the offgas on entry into the offgas treatment system is at a pressure of at most 1.4 bara, more preferably of at most 1.3 bara, more preferably of at most 1.2 bara.
Sentence 54: The method according to any of the preceding sentences, wherein the offgas on entry into the offgas treatment system has a degree of oxidation of NO_{X} of at least 10%, more preferably at least 20%, even more preferably at least 30%, most preferably at least 40%, and in particular at least 50%.
Sentence 55: The method according to any of the preceding sentences, wherein the offgas on entry into the offgas treatment system has a degree of oxidation of NO_{X} of at most 90%, more preferably at most 80%, even more preferably at most 70%, most preferably at most 60%, and in particular at most 50%.
Sentence 56: The method according to any of the preceding sentences, wherein the offgas on entry into the offgas treatment system has an O₂ content of less than 2.0% by volume.
Sentence 57: The method according to any of sentences 1 to 36, wherein the offgas on entry into the offgas treatment system has an O₂ content of more than 4.0% by volume.
Sentence 58: The method according to any of the preceding sentences, wherein step (c) comprises reducing the N₂O content in the offgas by (c₁) decomposition of N₂O over an N₂O decomposition catalyst; preferably wherein the N₂O decomposition catalyst comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 59: The method according to any of the preceding sentences, wherein step (c) comprises reducing the N₂O content in the offgas by (c₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 60: The method according to any of the preceding sentences, wherein the reducing agent in step (c₂) is selected from NH₃, hydrocarbons, CO, H₂ and mixtures thereof; preferably NH₃.
Sentence 61: The method according to any of the preceding sentences, wherein the reducing agent in step (c₂) is NH₃, which is used in an amount of 0.5 to 2.0 molar parts, preferably 0.8 to 1.8 molar parts, based on a molar proportion of N₂O to be chemically reduced.
Sentence 62: The method according to any of the preceding sentences, wherein the reducing agent in step (c₂) is a hydrocarbon or a mixture of several hydrocarbons, which are preferably used in an amount of 0.2 to 1.0 molar part, more preferably of 0.2 to 0.7 molar part, based on a molar proportion of N₂O to be broken down.
Sentence 63: The method according to any of the preceding sentences, wherein the NO_{X} reduction catalyst comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 64: The method according to any of the preceding sentences, wherein the reducing agent in step (d) is selected from NH₃, hydrocarbons, CO, H₂ and mixtures thereof; preferably NH₃.
Sentence 65: The method according to any of the preceding sentences, wherein the reducing agent in step (d) is NH₃, which is used in an amount of 0.9 to 2.5 molar parts, preferably 1.0 to 1.4 molar parts, more preferably 1.0 to 1.2 molar parts, based on a molar proportion of NO_{X}. to be chemically reduced.
Sentence 66: The method according to any of the preceding sentences, wherein the reducing agent in step (c₂) is the same as the reducing agent in step (d); preferably NH₃.
Sentence 67: The method according to any of the preceding sentences, wherein the offgas treatment system comprises a first reaction zone and a second reaction zone beyond, through which the offgas passes successively; wherein reducing agent is added to the offgas upstream of the first reaction zone; wherein, in the first reaction zone, the NO_{X} content in the offgas is first reduced by chemical reduction of NO_{X} with reducing agent over an NO_{X} reduction catalyst (step (d)); wherein the N₂O content in the offgas is optionally additionally reduced by decomposition of N₂O over an N₂O decomposition catalyst (step (c₁)) and/or by chemical reduction of N₂O with reducing agent over an N₂O reduction catalyst (step (c₂)); wherein further reducing agent is optionally added to the offgas upstream of the second reaction zone; and wherein, in the second reaction zone, the N₂O content in the offgas is then reduced by decomposition of N₂O over an N₂O decomposition catalyst (step (c₁)) and/or by chemical reduction of N₂O with reducing agent over an N₂O reduction catalyst (step (c₂)); wherein the NO_{X} content in the offgas is optionally additionally further reduced by chemical reduction of NO_{X} over an NO_{X} reduction catalyst (step (d)).
Sentence 68: The method according to sentence 67, wherein the NO_{X} reduction catalyst in the first reaction zone comprises a conventional SCR catalyst, preferably based on V₂O₅—WO₃—/TiO₂.
Sentence 69: The method according to sentence 67 or 68, wherein the offgas temperature on entry into the first reaction zone is not more than 400° C., preferably not more than 350° C.
Sentence 70: The method according to any of sentences 67 to 69, wherein the N₂O decomposition catalyst in the second reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 71: The method according to any of sentences 67 to 70, wherein the offgas temperature on entry into the second reaction zone is in the range from 300 to 550° C., preferably 350 to 500° C.
Sentence 72: The method according to any of sentences 67 to 71, wherein the NO_{X} reduction catalyst in the first reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 73: The method according to any of sentences 67 to 72, wherein the offgas temperature on entry into the first reaction zone is at least 300° C., more preferably at least 350° C., even more preferably at least 400° C.
Sentence 74: The method according to any of sentences 67 to 73, wherein the offgas temperature on entry into the first reaction zone is not more than 600° C., more preferably not more than 550° C.
Sentence 75: The method according to any of sentences 67 to 74, wherein the N₂O decomposition catalyst in the second reaction zone comprises an NO_{X}-sensitive N₂O decomposition catalyst.
Sentence 76: The method according to any of sentences 67 to 75, wherein the offgas temperature on entry into the second reaction zone is at least 300° C., more preferably at least 350° C., even more preferably at least 400° C.
Sentence 77: The method according to any of sentences 67 to 76, wherein the offgas temperature on entry into the second reaction zone is not more than 600° C., preferably not more than 550° C.
Sentence 78: The method according to any of sentences 67 to 77, wherein the offgas after leaving the first reaction zone and before entering the second reaction zone has an NO_{X} content in the range from 0 to 200 ppmv, preferably 1 to 200 ppmv, and an N₂O content in the range from 200 to 2000 ppmv.
Sentence 79: The method according to any of sentences 67 to 78, wherein the offgas after leaving the first reaction zone and before entering the second reaction zone has an NO_{X} content of not more than 20 ppmv, more preferably not more than 10 ppmv, even more preferably not more than 5 ppmv, and an N₂O content in the range from 200 to 2000 ppmv.
Sentence 80: The method according to any of the preceding sentences, wherein the offgas treatment system comprises a first reaction zone and a second reaction zone beyond, through which the offgas passes successively; wherein reducing agent is added to the offgas between the first reaction zone and the second reaction zone; wherein, in the first reaction zone, the N₂O content in the offgas is first reduced by decomposition of N₂O over an N₂O decomposition catalyst (step (c₁)); and wherein, in the second reaction zone, the NO_{X} content in the offgas is then reduced by chemical reduction of NO_{X} with reducing agent over an NO_{X} reduction catalyst (step (d)); wherein the N₂O content in the offgas is optionally additionally further reduced by further decomposition of N₂O over an N₂O decomposition catalyst (step (c₁)) and/or by chemical reduction of N₂O with reducing agent over an N₂O reduction catalyst (step (c₂)).
Sentence 81: The method according to sentence 80, wherein no reducing agent is added to the offgas upstream of the first reaction zone.
Sentence 82: The method according to sentence 80 or 81, wherein the N₂O decomposition catalyst in the first reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 83: The method according to any of sentences 80 to 82, wherein the N₂O decomposition catalyst in the first reaction zone comprises an NO_{X}-sensitive N₂O decomposition catalyst.
Sentence 84: The method according to any of sentences 80 to 83, wherein the NO_{X} reduction catalyst in the second reaction zone comprises a zeolitic material; preferably a zeolite laden with transition metal (including lanthanide), in particular with iron, cobalt or copper; more preferably an iron- or copper-laden zeolite; even more preferably an iron- or copper-laden zeolite of the MFI, BEA, FER, MOR, FAU, AEI and/or MEL structure type.
Sentence 85: The method according to any of sentences 80 to 84, wherein, in the first reaction zone and in the second reaction zone, the space velocity is set in such a way that the N₂O content in the offgas is reduced in the first reaction zone by at most 95%, preferably at most 90%, based on the N₂O content in the offgas on entry into the first reaction zone.
Sentence 86: The method according to any of sentences 80 to 85, wherein, in the second reaction zone, the N₂O content in the offgas is further reduced by at least 30%, preferably at least 40%, more preferably at least 50%, based on the N₂O content in the offgas on entry into the second reaction zone.
Sentence 87: The method according to any of sentences 80 to 86, wherein, in the second reaction zone, the N₂O content in the offgas is further reduced by chemical reduction of N₂O with reducing agent over an N₂O reduction catalyst (step (c₂)).
Sentence 88: The method according to any of sentences 67 to 87, wherein the first reaction zone and the second reaction zone are spatially separated.
Sentence 89: The method according to any of sentences 67 to 88, wherein the first reaction zone and the second reaction zone are spatially connected to each other.
Sentence 90: The method according to any of sentences 67 to 89, wherein the first reaction zone and the second reaction zone are disposed in a shared vessel.
Sentence 91: The method according to any of sentences 67 to 90, wherein the offgas temperature in the first reaction zone and in the second reaction zone is not more than 500° C., preferably in the range from 350 to 450° C.
Sentence 92: The method according to any of sentences 67 to 91, wherein the space velocity in the first reaction zone is greater than in the second reaction zone; preferably at least by a factor of 1.2, more preferably at least a factor of 1.4, even more preferably at least a factor of 1.6, most preferably at least a factor of 1.8, and in particular at least a factor of 2.0.
Sentence 93: The method according to any of sentences 67 to 92, wherein the space velocity in the first reaction zone is smaller than in the second reaction zone; preferably at least by a factor of 1.5, more preferably at least a factor of 2.0, even more preferably at least a factor of 3.0, most preferably at least a factor of 5.0, and in particular at least a factor of 10.0.
Sentence 94: The method according to any of sentences 67 to 93, wherein the temperature in the first reaction zone is at least 450° C., more preferably at least 500° C., even more preferably at least 550° C., most preferably at least 600° C. and in particular at least 650° C.
Sentence 95: The method according to any of sentences 67 to 94, wherein the temperature in the second reaction zone is at most 600° C., more preferably at most 550° C., even more preferably at most 500° C., most preferably at most 450° C. and in particular at most 400° C.
Sentence 96: The method according to any of sentences 67 to 95, wherein the temperature in the first reaction zone, in relative terms, is at least 20° C., more preferably at least 40° C., even more preferably at least 60° C., most preferably at least 80° C. and in particular at least 100° C. higher than the temperature in the second reaction zone.
Sentence 97: The method according to any of sentences 67 to 96, wherein the temperature in the first reaction zone, in relative terms, is at least 120° C., more preferably at least 140° C., even more preferably at least 160° C., most preferably at least 180° C. and in particular at least 200° C. higher than the temperature in the second reaction zone.
Sentence 98: The method according to any of the preceding sentences, wherein the offgas leaves the offgas treatment system and has a residual NO_{X} content of at most 20 ppmv, preferably at most 15 ppmv, more preferably at most 10 ppmv, even more preferably at most 7.5 ppmv, most preferably at most 5.0 ppmv, and in particular at most 2.5 ppmv.
Sentence 99: The method according to any of the preceding sentences, wherein the offgas leaves the offgas treatment system and has a residual N₂O content of at most 20 ppmv, preferably at most 15 ppmv, more preferably at most 10 ppmv, even more preferably at most 7.5 ppmv, most preferably at most 5.0 ppmv, and in particular at most 2.5 ppmv.
Sentence 100: The method according to any of the preceding sentences, wherein the N₂O decomposition catalyst is disposed in a radial basket through which the flow passes axially.
Sentence 101: The method according to any of the preceding sentences, wherein the N₂O decomposition catalyst is particulate and comprises at least 50 particles.
Sentence 102: The method according to any of the preceding sentences, wherein the N₂O reduction catalyst is disposed in a radial basket through which the flow passes axially.
Sentence 103: The method according to any of the preceding sentences, wherein the N₂O reduction catalyst is particulate and comprises at least 50 particles.
Sentence 104: The method according to any of the preceding sentences, wherein the NO_{X} reduction catalyst is disposed in a radial basket through which the flow passes axially.
Sentence 105: The method according to any of the preceding sentences, wherein the NO_{X} reduction catalyst is particulate and comprises at least 50 particles.
Sentence 106: The method according to any of the preceding sentences, wherein at least one parameter characteristic of the current operating state of the internal combustion engine is measured in the internal combustion engine as a first measured variable.
Sentence 107: The method according to sentence 106, wherein the first measured variable is selected from the group consisting of combustion temperature, NH₃ consumption, speed of rotation, and noise emitted by the internal combustion engine.
Sentence 108: The method according to any of the preceding sentences, wherein at least one parameter characteristic of the current state of the offgas before entry into the offgas treatment system is measured as a second measured variable before entry into the offgas treatment system.
Sentence 109: The method according to sentence 108, wherein the second measured variable is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.
Sentence 110: The method according to any of the preceding sentences, wherein at least one parameter characteristic of the current state of the offgas at the outlet of the offgas treatment system is measured as a third measurement parameter at the outlet of the offgas treatment system.
Sentence 111: The method according to sentence 110, wherein the third measured variable is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.
Sentence 112: The method according to any of the preceding sentences, wherein the offgas treatment system comprises a first reaction zone and a second reaction zone, through which the offgas flows successively, wherein reducing agent is fed in between the first reaction zone and the second reaction zone, and wherein, after leaving the first reaction zone and before entering the second reaction zone, at least one parameter characteristic of the current state of the offgas after leaving the first reaction zone and before entering the second reaction zone is measured as a fourth measured variable.
Sentence 113: The method according to sentence 112, wherein the fourth measured variable is selected from the group consisting of NO_{X} content in the offgas; degree of oxidation of the NO_{X} in the offgas; N₂O content in the offgas; content of other components in the offgas, for example H₂O, O₂, and N₂; offgas temperature; offgas pressure; and volume flow rate of the offgas.
Sentence 114: The method according to any of sentences 106 to 113, wherein the control of the method is based on the first measured variable and/or on the second measured variable and/or on the third measured variable and/or on the fourth measured variable by means of a controlled change in a manipulated variable.
Sentence 115: The method according to sentence 114, wherein the manipulated variable is the amount of reducing agent metered in.
Sentence 116: An apparatus comprising (i) an NH₃-driven internal combustion engine; and (ii) an offgas treatment system; wherein the device is configured to perform the method according to any of the preceding sentences.

What is claimed is:

1. An apparatus comprising:
(i) an internal combustion engine which is configured to be powered by combustion of NH₃ and which is mounted in a ship and configured to move the ship; and
(ii) an offgas treatment system configured to reduce the content of NO_{X} and N₂O in an offgas produced by combustion from the NH₃ and comprising N₂, H₂O, NO_{X} and N₂O, wherein the offgas treatment system comprises:
an N₂O decomposition catalyst configured to decompose N₂O; and/or an N₂O reduction catalyst configured for chemical reduction of N₂O with reducing agent; and
an NO_{X} reduction catalyst configured for chemical reduction of NO_{X} with reducing agent.

2. The apparatus as claimed in claim 1, wherein the offgas comprises NH₃ and wherein the offgas treatment system is configured to reduce the NH₃ content in the offgas.

3. The apparatus as claimed in claim 1, wherein the offgas treatment system comprises an NH₃ oxidation catalyst configured for chemical oxidation of NH₃ with O₂; preferably for chemical oxidation of NH₃ with O₂ to give N₂ and H₂O.

4. The apparatus as claimed in claim 1, wherein the N₂O decomposition catalyst and/or the N₂O reduction catalyst and/or the NO_{X} reduction catalyst and/or the NH₃ oxidation catalyst independently comprise a zeolitic material; preferably a zeolite laden with transition metal, including lanthanide, in particular with iron, cobalt or copper; more preferably an iron- or copper-laden zeolite; even more preferably independently an iron- or copper-laden zeolite of the MFI, BEA, FER, MOR, FAU, AEI and/or MEL structure type.

5.-9. (canceled)

10. The apparatus as claimed in claim 1, wherein the N₂O decomposition catalyst and/or the N₂O reduction catalyst and/or the NO_{X} reduction catalyst and/or the NH₃ oxidation catalyst independently have a honeycomb monolithic structure.

11.-19. (canceled)

20. The apparatus as claimed in claim 1, comprising an NH₃ oxidation catalyst in addition to the N₂O decomposition catalyst and/or N₂O reduction catalyst and the NO_{X} reduction catalyst.

21. (canceled)

22. The apparatus as claimed in claim 20, wherein the NH₃ oxidation catalyst is free of platinum group metals, preferably free of precious metals; preferably an NH₃ oxidation-active iron- or copper-laden zeolite catalyst.

23. The apparatus as claimed in claim 20, wherein the NH₃ oxidation catalyst is selected from:
cobalt catalysts, especially Co₃O₄; Co₃O₄-derived mixed oxides (Co_{3-y}M_{y}O₄) where M is preferably selected from Zn, Cu, Fe, Mn and V; cobalt-laden zeolites, preferably of the MFI, BEA, FER, MOR, FAU, CHA or AFI structure type;
manganese catalysts; especially MnO_{X} with x=1-2; MnO_{X}-derived mixed oxides (Mn_{x-y}M_{y}Oₓ) where M is preferably selected from Zn, Cu, Fe and Mn; manganese-laden zeolites, preferably of the MFI, BEA, FER, MOR, FAU, CHA or AFI structure type;
copper catalysts; especially CuO_{X} with x=0.5-1; CuO_{X}-derived mixed oxides (Cu_{x-y}M_{y}Oₓ) where M is preferably selected from Zn, Co, Fe and Mn; copper-laden zeolites, preferably of the MFI, BEA, FER, MOR, FAU, CHA, AFI structure type;
silver catalysts; especially in supported form, preferably supported on Al₂O₃, TiO₂ or SiO₂.

24. (canceled)

25. The apparatus as claimed in claim 1, wherein the internal combustion engine comprises a reciprocating piston engine; preferably a reciprocating piston engine with compression ignition.

26.-27. (canceled)

28. The apparatus as claimed in claim 1, wherein the internal combustion engine is an ammonia dual-fuel engine.

29. (canceled)

30. The apparatus as claimed in claim 1, wherein the internal combustion engine is configured for combustion of NH₃ in mixture with a further combustible gas; preferably wherein the further combustible gas is selected from:
(i) H₂;
(ii) fossil fuels; preferably hydrocarbons and hydrocarbon mixtures, more preferably methane, ethane, propane, butane, natural gas, gasoline and/or diesel;
(iii) alcohols, preferably methanol and/or ethanol;
and mixtures thereof.

31. The apparatus as claimed in claim 1, wherein the internal combustion engine is configured for combustion of NH₃ in a mixture with H₂ and/or natural gas; preferably NH₃ in a mixture with H₂.

32.-34. (canceled)

35. The apparatus as claimed in claim 30, which comprises a cracking apparatus for thermal and/or catalytic cracking of NH₃.

36.-40. (canceled)

41. The apparatus as claimed in claim 1, wherein the internal combustion engine is configured such that the air ratio λ on combustion is in the range from 0.9 to 1.7, preferably 1.05 to 1.7, more preferably 1.0 to 1.6, even more preferably 1.1 to 1.5, most preferably 1.2 to 1.4.

42.-58. (canceled)

59. The apparatus as claimed in claim 1, wherein the apparatus is configured such that the offgas on entry into the offgas treatment system has a degree of oxidation of NO_{X} of at least 10%, more preferably at least 20%, even more preferably at least 30%, most preferably at least 40%, and in particular at least 50%.

60.-105. (canceled)
